(19) United States
(12) Patent Application Publication
(10) Pub. No.: US 2010/0159082 A1
(43) Pub. Date: Jun. 24, 2010

(54) NON-FRIED APPLE FOOD PRODUCTS AND PROCESSES FOR THEIR PREPARATION

(75) Inventors: Handunkutti P.V. Rupasinghe, Truro (CA); Ajit Pal Kaur Joshi, Truro (CA); Nancy L. Pitts, Brookfield (CA)

Correspondence Address: BERESKIN AND PARR LLP/S.E.N.C.R.L., s.r.l., 40 KING STREET WEST, BOX 401, TORONTO, ON, M5H 3Y2, CA

(73) Assignee: Her Majesty the Queen in Right of the Province of Nova Scotia, as represented by the Nova Scotia, Truro, NS (unknown)

(21) Appl. No.: 12/580,715

(22) Filed: Oct. 16, 2009

Related U.S. Application Data
(60) Provisional application No. 61/106,008, filed on Oct. 16, 2008.

(51) Int. Cl. A23B 7/022

(52) U.S. Cl. 426/102; 426/615; 426/281; 426/270; 426/267

(57) ABSTRACT

The present disclosure relates to value-added non-fried, crispy apple food products and a consumer-friendly process for manufacturing these products that does not use deep-frying in oil.

This application claims the benefit of Provisional Application No. 61/106,008 filed Oct. 16, 2008, the contents of which are incorporated herein by reference.

### FIELD OF THE DISCLOSURE

The present disclosure relates in general to value-added snacks from apples that are not fried, but yet retain a texture that is similar to conventionally fried snack products such as potato chips. The disclosure also relates to processes for making the non-fried apple food products.

### BACKGROUND OF THE DISCLOSURE

Apples (Malus×domestica Borkh.) are a rich source of bioactives such as phenolic acids, flavonoids, ascorbic acid and dietary fiber (Lewis and Ruud, 2004; Wu et al., 2007). These components play an important role in the prevention of certain chronic diseases such as cardiovascular disease, diabetes and cancer (Boyer and Liu, 2004; Lewis and Ruud, 2004), and hence add to the nutraceutical value of apples. In Nova Scotia, apple production has increased from 43,400 tonnes in 2005 to 45,250 tonnes in 2007 (Statistics Canada, 2006; Statistics Canada, 2008). However, the market for fresh apples in Nova Scotia has suffered decline in recent years mainly because of the surplus production and a drastic increase of imported apples. These constraints have become a major concern for fruit growers and the processing industry (Macintosh et al., 2006) and this emphasizes the need to establish alternative market strategies such as apple-based snack foods.

Snack foods make up an important part of a consumer's diet in Canada. About 80% of people consume snack foods, of which 65% are more concerned with the nutritional value of these products (Food Processing, 2004). There is an increasing demand for health promoting foods having high nutritional and nutraceutical value (Bagchi, 2006). It is estimated that by 2010, the global market for functional foods and nutraceuticals will reach US$ 500 billion (Drouin, 2002).

The bioactives present in apples such as ascorbic acid, phenolics and other natural antioxidants are highly sensitive to factors such as heat, light, air, and moisture; exposure to such conditions can result in significant loss of these compounds (Nicoli et al., 1999). In addition, the post-cut enzymatic browning in apples caused by polyphenoloxidase (PPO) activity leads to quantitative losses of antioxidants in addition to adverse changes in color and taste of fresh apple (Nicoli et al., 2000). To minimize fruit processing losses, the application of suitable anti-browning methods and drying methods such as vacuum drying, freeze drying, microwave drying, and osmotic dehydration have been investigated (Bazyma et al., 2006; Lewicki, 2006; Sham et al., 2001). Also, new genotypes of apples are being developed that exhibit low potential for post-cut enzymatic browning (Martinez and Whitaker, 1995; Khanizadeh et al., 2007).

### SUMMARY OF THE DISCLOSURE

Considering the health benefits of apples and their suitability for snack production (Jack et al., 1997), the promotion of apple-based snack products such as non-fried apple snacks represents an alternative marketing option for the apple processing industry.

Consumer-friendly and efficient processes were investigated for the manufacturing of value-added non-fried apple snacks. To control post-cut enzymatic browning, various treatment methods to control post-cut enzymatic browning were studied, with dipping in a CaCl₂ solution being optimum. Selected drying processes were optimized and compared for their effects on quality attributes of apple snacks. The results of the drying process comparison showed that vacuum-drying was the most suitable method of drying apples slices to preserve color and textural attributes and phenolic compounds in the resulting apple snacks. Application of a vacuum impregnation (VI) process as a pretreatment for drying was found to improve the sensory attributes and nutritional quality of the apple snacks. To improve the textural attributes of the non-fried apple snacks further, the apple slices were treated with solutions containing different levels of maple syrup in VI process. It was observed that treatment with maple syrup during VI resulted in improved textural attributes, whiteness index (WI) and reduced moisture content and water activity in the dried apple slices. A consumer acceptability study was performed using an untrained consumer sensory panel in which non-fried apple snacks prepared by vacuum drying after giving VI treatment with maple syrup solution were compared with commercially available fried apple and potato snacks. Non-fried apple snacks received a significantly higher score for appearance and were found to be acceptable for taste and texture.

The present disclosure therefore includes a non-fried apple food product comprising the following characteristics:

(a) oil free;

(b) nutrient enriched; and

(c) crispy texture.

The present disclosure also includes a process for preparing a non-fried apple food product comprising:

(a) obtaining apple portions of a suitable size and shape;

(b) treating the apple portions under vacuum impregnation (VI) conditions in the presence of one or more sensory-attribute-improving substances; and

(c) vacuum drying the apple portions from (b).

In an embodiment of the disclosure, the process further comprises treating the apple portions, prior to VI, under conditions to reduce post-cut enzymatic browning.

The overall process comprising vacuum impregnation of the apple portions in a suitable solution followed by vacuum dehydration can be used for manufacturing of apple chips or snacks: (i) without oil (commercial chips can contain up to 30% of oil); (ii) with better appearance than deep-fried or conventional dried products; (iii) with suitable daily recommended intake of vitamins and minerals; (iv) with preserved antioxidant and other biologically active compounds present in the apple; (v) with suitable natural or artificial flavoring and color agents; and (vi) with suitable antioxidants and biologically active compounds

The present disclosure also includes a non-fried apple food product prepared using the method of the present disclosure.

Other features and advantages of the present disclosure will become apparent from the following detailed description. It should be understood, however, that the detailed description and the specific examples while indicating preferred embodiments of the disclosure are given by way of illustration only, since various changes and modifications within the spirit and scope of the disclosure will become apparent to those skilled in the art from this

### BRIEF DESCRIPTION OF THE DRAWINGS

The disclosure will now be described in relation to the drawings in which:

FIG. 1 shows contour plots for WI of apple slices for the process optimization of three different anti-browning treatments.

FIG. 2 shows WI of apple slices treated with selected anti-browning methods over the post-treated time.

FIG. 3 shows the steps followed for performing Canonical analysis using RSM.

FIG. 4 shows contour plots of ‘a’ values at given vacuum pressure (in. of Hg), application time (min) and relaxation time (min).

FIG. 5 shows contour plots of t-resveratrol at given vacuum pressure (in. of Hg), application time (min) and relaxation time (min).

FIG. 6 shows contour plots of MC (%) at given vacuum pressure (in. of Hg), application time (min) and relaxation time (min).

FIG. 7 shows contour plots of a_{w} at given vacuum pressure (in. of Hg), application time (min) and relaxation time (min).

FIG. 8 shows contour plots of maximum force at given vacuum pressure (in. of Hg), application time (min) and relaxation time (min).

FIG. 9 shows contour plots of gradient at given vacuum pressure (in. of Hg), application time (min) and relaxation time (min).

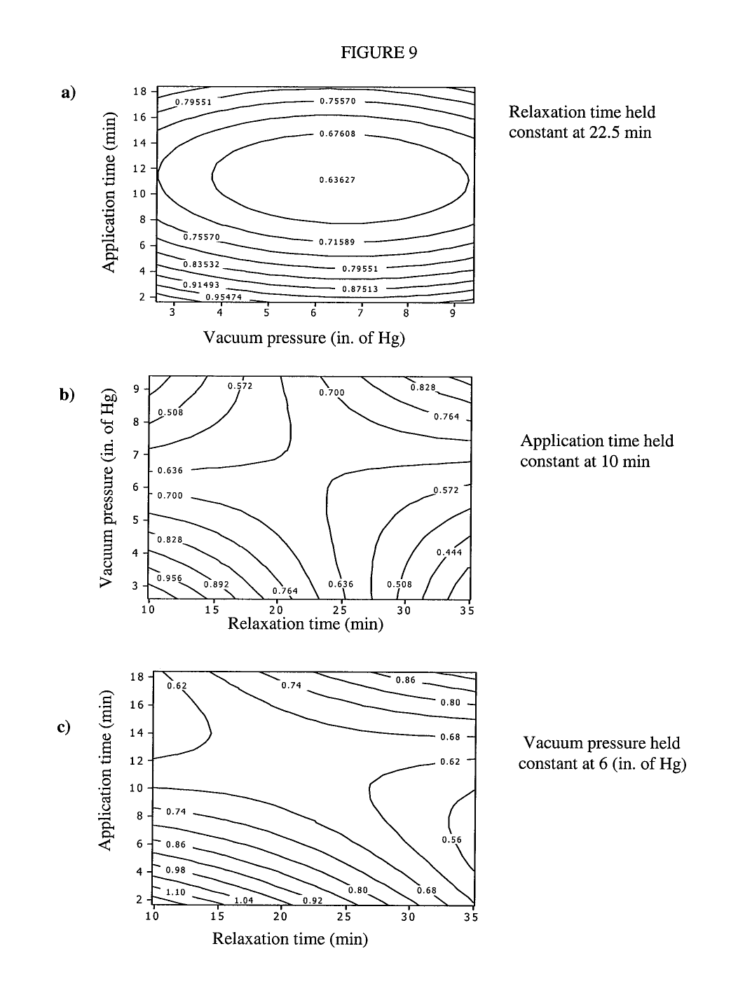

FIG. 10 shows contour plots of linear distance at given vacuum pressure (in. of Hg), application time (min) and relaxation time (min).

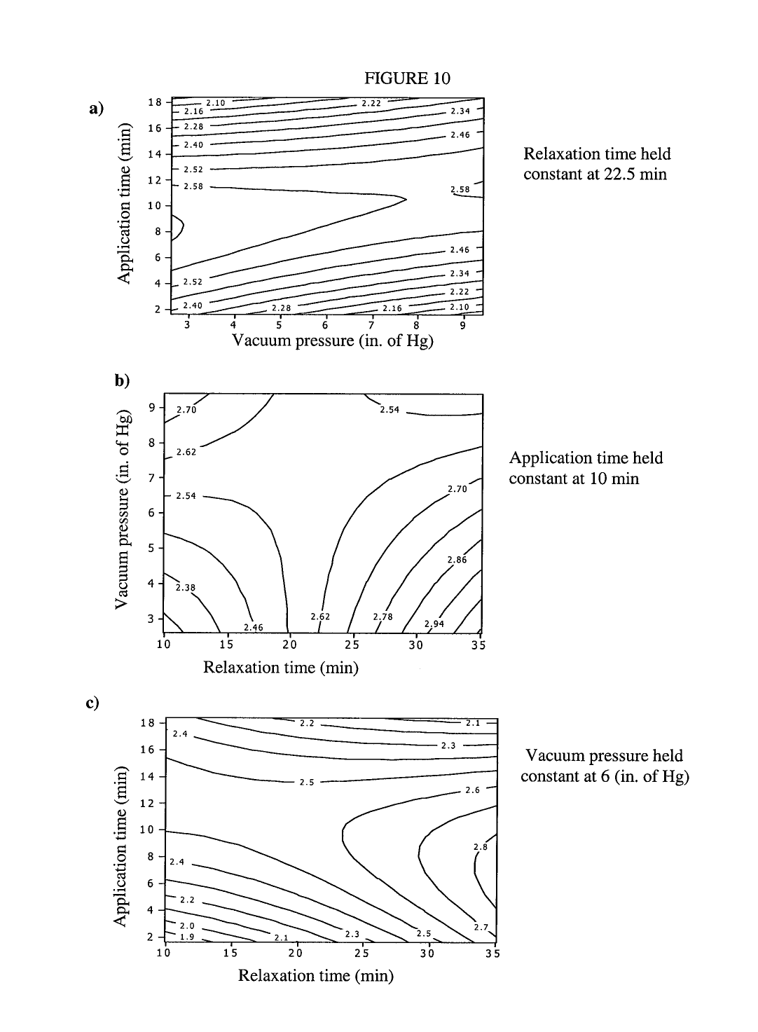

### DETAILED DESCRIPTION OF THE DISCLOSURE

### (I) Abbreviations

The following abbreviations are used throughout the disclosure and are understood to have the following meanings:

FRAP: ferric reducing antioxidant power;
GAE: Gallic acid equivalents;
ORAC: the oxygen radical absorbance capacity;
PPO: polyphenoloxidase;
TE: Trolox equivalents;

### WI: Whiteness Index

GRAS: generally recognized as safe;
HTST: high temperature short time;
LTLT: low temperature long time;

### FC: Folin-Ciocalteu;

AT: application time;
MC, moisture content;
RG: t-resveratrol glucoside;

### RSM: Response Surface Methodology;

RT: relaxation time;
VI: vacuum impregnation;
VP: vacuum pressure

### (II) Apple Food Products

The present disclosure includes a novel, value-added apple food product that is oil-free yet has the texture (crispiness) of a fruit or vegetable product prepared by traditional frying techniques. Accordingly, the apple food product of the disclosure is ideally suited as a wholesome, nutritionally-enriched, ready-to-eat, snack food.

The present disclosure therefore includes a non-fried apple food product comprising the following characteristics:

(a) oil free;

(b) nutrient enriched; and

(c) crispy texture.

The term “apple food product” refers to a product made from an apple, suitably including the apple peel and apple meat, that is suitable for consumption by humans and/or animals.

The term “oil free” as used herein means that the product is free of any added oil or fat. The product may contain oils or fats that occur naturally in the apple or in other substances added to the apple product during its preparation.

The term “nutrient enriched” means enriched in the nutrients naturally occurring in the apple as well as nutrients, including vitamins and minerals, that are added to the apple product during its preparation.

The term “crispy texture” means that the apple product possesses a crunchy but light texture as measured using the Texture Analyzer model TA.XT Plus™, Texture Technologies Corp., New York, US. That is having a texture like that a fruit or vegetable product prepared by oil frying techniques (for example, potato chips).

In another embodiment of the disclosure the apple is a genotype with low post-cut enzymatic browning characteristics.

In yet another embodiment the apple product is in the form of a slice or a wedge with or without skin. In a further embodiment, the slice or wedge is about 1 mm to about 3 mm, suitably about 2 mm, thick.

In another embodiment, the apple product possesses low moisture content (about 1% to about 5%, suitably about 3%) and water activity (about 0.1 to about 0.2, suitably about 0.18) and better hygroscopic properties than conventionally dehydrated apple slices.

In another embodiment, the apple product is nutritionally enriched with dietary fiber, vitamins C (about 20 mg/100 g to about 100 mg/100 g, suitably about 66 mg/100 g) and E (about 100 mg/100 g to about 200 mg/100 g, suitably about 181 mg/100 g) and minerals, for example calcium (about 500 mg/100 g to about 1000 mg/100 g, suitably about 780 mg/100 g).

In another embodiment the apple snack is rich in biologically active compounds, for example phenolic acids (chlorogenic acid: about 100 mg/100 g to about 200 mg/100 g, suitably about 153 mg/100 g) and flavonoids (catechins: about 1 mg/100 g to about 10 mg/100 g, suitably about 5 mg/100 g; cyaniding-3-galactoside: about 1 mg/100 g to about 10 mg/100 g, suitably about 3.9 mg/100 g; and quercetin glycosides: about 10 mg/100 g to about 100 mg/100 g, suitably about 40 mg/100 g).

In another embodiment, the total antioxidant capacity (measured by FRAP assay) of the apple product is greater than that of deep-fried apple chips and about 20-fold higher than potato chips.

In another embodiment, the apple product comprises a low amount of total fat (about 0.5% to about 5%, suitably about 1%). This compares favorably to the total fat content of deep-fried snack products (up to 30 to 40%).

### (III) Methods of the Disclosure

Snack foods make up an important part of a consumer's diet in Canada. Considering the health benefits of apples and their suitability for snack production, the promotion of apple-based snack products such as non-fried apple snacks represents an alternative marketing option for the apple processing industry. Described herein is a consumer-friendly and efficient protocol for the production of value-added non-fried apple snacks.

The present disclosure includes a process for preparing a non-fried apple food product comprising:

(a) obtaining apple portions of a suitable size and shape;

(b) treating the apple portions under vacuum impregnation (VI) conditions in the presence of one or more sensory attribute-improving substances; and

(c) vacuum drying the apple portions from (b).

The suitable size and shape of the apple portions will vary depending on the product and may include, for example slices and wedges. In a further embodiment, the slices or wedges are about 1 mm to about 3 mm, suitably about 2 mm, thick. The shape may be any suitable or desired shape, for example one that is appealing to consumers.

The term “sensory attribute-improving substance” is any substance that results in an improvement in one or more sensory attributes of the apple food product, including, for example, color, appearance, flavor, and texture. In an embodiment of the disclosure, the one or more sensory attribute-improving substances are selected from one or more of color enhancers, health-promoting bioactives, taste enhancers, texture enhancers and any other suitable value-added substances.

In an embodiment of the disclosure, at least one of the sensory attribute-improving substances is a color enhancer. In a further embodiment the color enhancer is an inhibitor of post-enzymatic browning or a natural colorant such as fruit or vegetable juice or beverages. In a still further embodiment the inhibitor of post-enzymatic browning is CaCl₂ or a commercial anti-browning agent, for example, FreshXtend™, in particular CaCl₂. In an embodiment, the CaCl₂ is used as a solution comprising about 1% (w/v) to about 2% (w/v), suitably about 1.6% (w/v) of CaCl₂.

In a further embodiment the one or more sensory attribute-improving substances include health-promoting bioactives selected from one or more of minerals, vitamins, trans-resveratrol or its glucoside (anti-aging), and any other bioactive substance present in fruit or vegetable juice or beverages.

In a further embodiment, the one or more sensory attribute-improving substances include taste and/or texture improving substances selected from one or more of fruit juices, salt, sugars and syrups, in particular maple syrup. In an embodiment of the disclosure, the maple syrup is used in an amount ranging from about 1% (v/v) to about 40% (v/v), suitably about 30% (v/v) to about 40% (v/v).

Other substances may be included during the VI step, for example substance that enhance the solubility of the one or more sensory attribute-improving substances, for example whey protein concentrate, or preservatives.

In an embodiment of the disclosure the VI conditions comprise a vacuum pressure of about 5.5 in. Hg to about 8.5 in. Hg, suitably about 6 in. Hg, an application time of about 1.7 min to about 15.8 min, suitably about 10 min, and a relaxation time of about 12.6 min to about 33.7 min, suitably about 22.5 min.

It is an embodiment of the disclosure that the apple portions are treated prior to vacuum impregnation under conditions to reduce post-cut enzymatic browning. In an embodiment, these conditions comprise LTLT (Low Temperature Long Time) blanching treatment, HTST (High Temperature Short Time) blanching treatment, CaCl₂ dipping, the application of a commercial anti-browning agent (e.g. FreshXtend™) and/or fruit and/or vegetable juice or beverage. In a further embodiment the LTLT blanching conditions comprise immersion in water, suitably distilled water, at a temperature of about 75° C. to about 80° C., suitably about 78° C., for about 20 min to about 30 min, suitably about 26 min. In another embodiment the HTST blanching conditions comprise immersion in water, suitably distilled water, at a temperature of about 85° C. to about 95° C., suitably about 90° C., for about 10 sec to about 30 sec, suitably about 20 sec. In yet another embodiment, the CaCl₂ dipping conditions comprise immersion in solution comprising about 1% (w/v) to about 2% (w/v), suitably about 1.6% (w/v) CaCl₂ in water, suitably distilled water for about 8 to about 10 minutes, suitably about 9 minutes.

In an embodiment of the disclosure, the apple portions are vacuum dried at a temperature of about 25° C. to about 40° C., suitably about 30° C., under a vacuum of about 10⁻³ Torr for about 12 hours to about 24 hours, suitably about 15 hours.

In another embodiment of the disclosure the apple is a genotype with low post-cut enzymatic browning characteristics.

The present disclosure also includes non-fried apple food products prepared using a method of the present disclosure.

The following non-limiting examples are illustrative of the present disclosure:

### EXAMPLES

### Example 1

### Biochemical Characterization of Enzymatic Browning in Selected Apple Genotypes

### Materials and Methods

### (a) Plant Material and Chemical Reagents

The selected apple genotypes (‘SuperMac’, ‘SJCA16’ and ‘Eden™’) developed by the AAFC-HRDC, Quebec, were harvested at their commercial maturity (based on the starch index) and analyzed for post-cut enzymatic browning 5 months after standard controlled atmosphere storage (2.5% O₂+2.5% CO₂, 0° C., >95% RH) compared with two commercially grown cultivars ‘Empire’ and ‘Cortland’. All the apples were collected from the same orchard. Sixty apples per tree were harvested randomly from top to bottom inside and outside of the canopy from three trees (replicates) for each genotype. When a tree had fewer than 60 fruit, apples were combined from two adjacent trees of the same genotype. Glacial acetic acid, Triton X-100, polyvinylpyrrolidone, catechol and methanol were purchased from Fisher Scientific Ltd., ON. Iron (III) chloride hexahydrate, potassium phosphate, sodium phosphate, tyrosinase, sodium acetate trihydrate, sodium carbonate, 6-hydroxy-2,5,7,8-tetramethylchroman-2-carboxylic acid (Trolox), Folin-Ciocalteu's phenol reagent, 2,4,6-Tris (2-Pyridyl)-S-Triazine (TPTZ) and fluorescein were obtained from Sigma-Aldrich Ltd., Oakville, ON. The reagent 2,2′-Azobis (2-amidinopropane) dihydrochloride (AAPH) was purchased from Wako Chemicals Inc., Richmond, Va.

### (b) Browning Intensity

To analyze browning intensity, apples were washed, wiped with paper towel, cut into 2.0-mm-thick slices perpendicular to the core using an apple slicer (Waring PRO™, Model: FS 150C, Torrington, Conn.) and kept at ambient temperature (25±1° C., 40-50% RH, samples were not covered) for 2 h before the measurement of cut-surface browning. The 2 h post-cut period was selected based on the preliminary experiments. Six replicates of each genotype were tested where a replicate consisted of three randomly selected slices from one apple. The browning intensity was determined in terms of Whiteness Index (WI) values obtained using a Minolta CR-300 colorimeter (Konica Minolta Sensing, Inc., Ramsey, N.J.) by measuring values of ‘l’ (lightness), ‘a’ [(+)‘a’ corresponds to red chromaticity and (−) ‘a’ green chromaticity], and ‘b’ (yellow chromaticity) as described by Rupasinghe et al. (2006). A higher value for WI corresponds to the lower browning intensity. WI was calculated using the formula described by Bolin and Huxsoll (1991): WI=100 [(100−L)²+a²+b²]^{1/2}.

### (c) PPO Activity

The PPO activity was assessed using the procedure of Rocha and Morais (2001). For the enzyme assay, protein was extracted three times independently (triplicate) for each genotype. A replicate represented two randomly selected apples from the harvest of each tree of that particular genotype. Approximately 10 g of apple flesh tissues, including skin and excluding seeds, was cut in to 0.25- to 0.5-cm² pieces, and homogenized for 2 min using homogenizer (Polytron homogenizer, Model: PT 10/35, Brinkmann Instrument Canada Ltd., Westbury, N.Y.) with 17 mL of cold (4±2° C.) extraction solution containing Triton X-100 (0.25% v/v) and polyvinylpyrrolidone (2% w/v) in a sodium phosphate buffer (pH 6.5). The extract was centrifuged immediately at 4° C. for 30 min at 16,500×g (Model: L8-80M, Beckman Instrument Canada Ltd., Mississauga, ON). The supernatant was filtered through six layers of cheesecloth and the final volume of the filtrate was determined. The PPO assay was performed using catechol (4 mM) as a substrate. A standard curve was prepared using tyrosinase. Absorbance was measured at 420 nm using a spectrophotometer (Beckman, Model: DU series 70, Beckman Coulter Canada Inc., Mississauga, ON). The straight-line section of the activity curve as a function of time was used to determine the enzyme activity. One unit of PPO activity was defined as increase in absorbance over the span of 1 min (ΔOD min⁻¹ g⁻¹ fresh weight).

### (d) Sample Preparation and Extraction of Bioactive Compounds and Elements

For the estimation of total phenolic content, total antioxidant capacity (FRAP and ORAC), phenolic profiles, vitamin C, and elements; freeze-dried and ground apple tissue was prepared in triplicate for each genotype. Six apples randomly selected from the harvest of each tree of that particular genotype were used to prepare the samples as described above. Approximately 10 g of apple flesh tissues, including skin, was cut into 0.25- to 0.5-cm² pieces; apple tissues were prepared in liquid nitrogen, freeze-dried and ground into powder using a grinder (Cuisinart, Model: DCG-12BCC, Cuisinart Canada, Woodbridge, ON). Methanol (15 mL) was added to 0.5 g of powder and the mixtures were subjected to approximately 20 kHz energy of sonication (Model: 750D, ETL Testing Laboratories Inc., Cortland, N.Y.) for 15 min (three times, with 10-min intervals). The crude extract was centrifuged (Model: Durafuge 300, Precision, Winchester, Va.) at 4000 rpm for 15 min. Extracts of each sample were prepared in triplicate and stored in amber vials at −70° C.

### (e) Total Phenolic Content

Total phenolic content was determined using the Folin-Ciocalteu reagent, using the method described by Singleton et al., (1999). Total phenolic content was expressed as mmolGAE/100 g of dry matter.

### (f) Phenolic Profiles

Analyses of all individual phenolic compounds were performed with a Waters Alliance 2695 separations module (Waters, Milford, Mass.) coupled with a Micromass Quattro micro API MS/MS system and controlled with Masslynx V4.0 data analysis system (Micromass, Cary, N.C.). The column used was a Phenomenex Luna C18 (150 mm×2.1 mm, 5 μm) with a Waters X-Terra Miss. C18 guard column. A previously reported method (Sanchez-Rabaneda et al., 2004) was modified and used for the separation of the flavonol, flavan-3-ol, phenolic acid and dihydrochalcone compounds. A gradient elution was carried out with 0.1% formic acid in water (solvent A) and 0.1% formic acid in acetonitrile (solvent B) at a flow rate of 0.35 mL/min. A linear gradient profile was used with the following proportions of solvent A applied at time t (min); (t, A %): (0, 94%), (9, 83.5%), (11.5, 83%), (14, 82.5%), (16, 82.5%), (18, 81.5%), (21, 80%), (29, 0%), (31, 94%), (40, 94%).

The separation of the anthocyanin compounds was carried out using the same HPLC system with different mobile phases (Vrhovsek et al., 2004). The mobile phases used were 5% formic acid in water (solvent A) and 5% formic acid in methanol (solvent B) at a flow rate of 0.35 mL/min. The linear gradient profile used was as follows: (t, A %): (0, 90%), (10, 70%), (17, 60%), (21, 49%), (26, 36%), (30, 10%), (31, 90%), (37, 90%). Electrospray ionization in negative ion mode (ESI−) was used for the analysis of the flavonol, flavan-3-ol, phenolic acid and dihydrochalcone compounds. The following conditions were used: capillary voltage 3000 V, nebulizer gas (N₂) at temperature 375° C. and a flow rate of 0.35 mL/min. For the analysis of the anthocyanin compounds, electrospray ionization in positive ion mode (ESI+) was used. The settings for the positive ion experiments were as follows: capillary voltage 3500 V, nebulizer gas (N₂) at temperature 375° C. and a flow rate of 0.35 mL/min. The cone voltage (25 to 50 V) was optimized for each individual compound. Multiple Reaction Monitoring (MRM) mode using specific precursor/product ion transitions was employed for quantification in comparison with standards: m/z 463→301 for quercetin-3-O-glucosides and quercetin-3-O-galactoside, m/z 448→301 for quercetin-3-O-rhamnoside, m/z 435-273 for phloridzin, m/z 353→191 for chlorogenic acid, m/z 449→287 for cyanidin-3-O-galactoside, m/z 289→109 for catechin, and m/z 290→109 for epicatechin.

### (e) The Ferric Reducing Antioxidant Power Assay (FRAP)

The FRAP assay was performed according to Benzie and Strain (1996) with some modifications. The reaction reagent (FRAP solution) was made immediately before the assay by mixing 300 mmol/L acetate buffer (pH 3.6), 10 mmol/L TPTZ solution, and 20 mmol/L ferric chloride solution in the ratio of 10:1:1. The TPTZ solution was prepared the same day as the analysis. The Trolox standard solution was prepared by dissolving 0.025 g of Trolox in 100 mL extraction solvent (methanol) to make 1 mmol/L Trolox, and this stock solution was stored in small aliquots in a freezer (−70° C.) until needed. For the development of the calibration curve, the Trolox stock solution was diluted appropriately with methanol to make 800, 400, 200, 100, 50 and 25 μM Trolox concentrations. The FRAP analysis was performed by reacting 20 μL of blank, standard or sample with 180 μL FRAP solution in COSTAR 96-well clear polystyrene plates (Thermo Fisher Scientific Inc., Waltham, Mass.). The FLUOstar OPTIMA plate reader with an incubator and injection pump (BMG Labtech, Durham, N.C.) was programmed using the BMG Labtech software to take an absorbance reading at 595 nm, 6 min after the injection of the FRAP solution and a shaking time of 3 s. Both the FRAP solution and the samples in the microplate were warmed to 37° C. prior to assay. FRAP values were expressed as mmoITE/100 g of sample dry matter.

### (f) The Oxygen Radical Absorbance Capacity Assay (ORAC)

The ORAC assay was performed as described by Cao et al. (1993) with some modifications. Solutions required for the assay included: 75 mM phosphate buffer (K₂HPO₄/NaH₂PO₄) with a pH of 7; a fluorescein solution at 5.98 μM with a working solution made daily at 0.957 μM; the Trolox standard solution; and 150 mM AAPH, which was also prepared daily, immediately before the assay. Both the flourescein and AAPH solutions were diluted with the phosphate buffer (75 mM, pH 7). The Trolox standard solution was made using the phosphate buffer and diluted the day of analysis for creation of the calibration curve consisting of 75, 50, 25, 10, and 5 μM Trolox. The measurements were carried out on a FLUOstar OPTIMA plate reader (BMG Labtech, Durham, N.C.). The temperature of the incubator was set to 37° C. and the fluorescence filters were set to an excitation of 490 nm and emission of 510 nm. The buffer, standard, or sample (30 μL) and 0.957 fluorescein (120 μL) solutions as well as extra buffer (30 μL) were placed in the 96-well plates (COSTAR 3915). The mixture was preincubated at 37° C. for 10 min using the plate reader. The fluorescence was recorded every 42 s up to 598 s, then every 120 s up to 2878 s after injection of 35 μL pre-warmed (37° C.) AAPH to each well. The microplate was shaken for 3 s after injection of AAPH and prior to each reading. All measurements were expressed relative to the initial reading. Final results were calculated using the differences of areas under the fluorescence decay curves between the blank and each sample and were expressed as mmoITE/100 g of sample dry matter.

### (g) Vitamin C Concentration

Vitamin C concentration was determined using methods of AOAC

(Method 984.26) (2000).

(h) Multi-element Analysis

Elemental composition was determined by an Inductive Coupled Plasma Atomic Emission Spectrometry (ICP-AES) using a previously reported method (Anderson, 1996).

### (i) Experimental Design and Statistical Analysis

A completely randomized design (CRD) was used for all the experiments. The assumptions of normality of residuals were tested using the Anderson-Darling test. Assumptions of constant variance were tested by plotting residual versus fits scatter diagram (Montgomery, 2005). The data were analyzed using the general linear model (GLM) procedure of the SAS Institute, Inc. (2003). Significant differences among means were determined by the Tukey's Studentized Range test at α=0.05. Each analysis was performed in triplicate. Three independent extractions (replications) for phenolics and crude proteins of apple tissue and three independent preparations of dehydrated powder for vitamin C and elemental composition were performed. Pearson correlation coefficient (r) was used to indicate the relationships between parameters.

### Results and Discussion

### (a) Whiteness Index (WI)

The commercial apple cultivar ‘Cortland’ had the highest WI, while ‘Eden™’ and ‘Empire’ apples showed slightly lower but similar WI immediately after slicing (Table 1). The new genotype, ‘SJCA16’, resulted in lower WI due to the characteristic yellow color of the flesh. However, 2 h after slicing and storage at ambient temperature, the WI was significantly higher for ‘Eden™’ than all other genotypes tested. A similar response was observed for ‘Eden™’ after vacuum drying (50° C. for 24 h), while the WI of ‘Cortland’ and ‘SJCA16’ was greater than that of ‘Empire’ and ‘SuperMac’.

These results suggested that ‘Eden™’ offers a potential non-browning or minimal-browning characteristic, which may make it favorable for use in processing apples for either fresh-cut or dried snacks. The results indicate that ‘SJCA16’ and ‘Cortland’ apple slices also maintain acceptable white color after the drying process, and could be used for dried snack production. Similar results were obtained for ‘Eden™’ when compared with a range of apple cultivars including ‘Gala’, ‘Galarina’, ‘Spartan’, ‘Cortland’, and were cut and kept for 24 h at 20° C. (Khanizadeh et al., 2006).

### (b) Polyphenoloxidase (PPO) Activity

The PPO activity among the tested apple genotypes was variable. ‘Empire’ had the highest ranked PPO activity, whereas ‘Cortland’ exhibited the lowest ranked values for PPO activity (Table 2). While comparing WI of all five cultivars with their respective PPO activity, a relatively low negative correlation (r=−0.60; P=0.30) was obtained, which substantiated the role of factors other than PPO activity responsible for browning in apples.

### (c) Phenolic Compounds and Total Antioxidant Capacity

Besides playing a major role in enzymatic browning, the phenolic compounds present in apples act as a source of dietary antioxidants that may reduce the risk of many chronic disorders, including cancer (Boyer and Liu 2004). Therefore, there has been a growing interest in apples for use in value-added food products, such as functional beverages and healthy snack products.

(i) Total Phenolic Content

In the present study, it was observed visually that the cultivars having high total phenolic content tended to show more browning, resulting in lower WI. Pearson correlation coefficient (r) further confirmed a high negative correlation (r=−0.70; P=0.19) obtained between WI and total phenolic content of all the cultivars studied. Total phenolic content was observed to be high in ‘Empire’, ‘SuperMac’, and ‘Cortland’, whereas ‘Eden™’ and ‘SJCA16’ showed the lowest total phenolic content (Table 3).

The total phenolic content among various cultivars is highly variable (Lata et al., 2005; Lee et al., 2003; Scalzo et al., 2005) and differences in phenolic content are suggested as a cause of the differences in the browning intensity among cultivars (Russell et al., 2002).

(ii) Total Antioxidant Capacity

Total antioxidant capacity was measured in all apple cultivars tested (Table 3). The antioxidant capacity estimated using both FRAP and ORAC assays indicated that ‘Eden™’ has the lowest total antioxidant capacity. ‘SJCA16’ also exhibited low FRAP values but ORAC values were comparable with ‘Empire’. Total phenolic content showed strong positive correlation with total antioxidant capacity measured using FRAP (r=0.91; P=0.03) and ORAC (r=0.90; P=0.04) assays. Also, both FRAP and ORAC showed strong positive correlation (r=0.92; P=0.03).

The antioxidant capacity of apples has shown a positive correlation with the phenolic content (Chinnici et al., 2004; Lee et al., 2003; Tsao et al., 2005). Chinnici et al., (2004) observed that the free radical scavenging activity of apple extracts not only depends upon the phenolic content but also on the individual phenolic profiles for both apple peel and pulp. Hence, the variation in post-cut enzymatic browning among cultivars can also be attributed to the individual phenolic profile (Lata 2007; Lee et al., 2003). Among the different phenolic compounds, quercetin, epicatechin, and procyanidin were found to have higher antioxidant capacity than vitamin C, phloretin, and chlorogenic acid, which suggested that most of the total antioxidant capacity was attributable to phenolic compounds rather than vitamin C (Eberhardt et al., 2000; Lee et al., 2003).

(iii) Phenolic Profiles

All the five apple cultivars exhibited different phenolic profiles (Table 4). Interestingly, catechin was not detectable in ‘Eden™’ and, also, the content of epicatechin was significantly lower than that of the four other apple genotypes studied. ‘Empire’, which exhibited the lowest WI value, had the highest concentration of chlorogenic acid. In the present study, epicatechin (r=−0.471, P=0.424) and chlorogenic acid (r=−0.773, P=0.125) showed a negative correlation with WI.

Among phenolic compounds, catechin and chlorogenic acid are the substrates with greater affinity to PPO activity (Janovitz-Klapp et al., 1990; Oszmianski and Lee 1990). Based on the degree of browning of 11 apple cultivars subjected to bruising, Amiot et al. (1992) also found that chlorogenic acid and catechins were degraded as a result of PPO activity or enzymatic browning. The absence of catechin or lower concentration of epicatechins can thus be expected to significantly contribute towards resistance to browning properties of ‘Eden™’. On the other hand, ‘Eden™’ had the highest concentration of total quercetin glycosides as compared to other cultivars (Table 4). A positive correlation between quercetin glycosides and WI (r=0.54; P=0.35) was also observed. Quercetin is not a preferred substrate for PPO but acts as a competitive inhibitor of PPO (Xie et al., 2003). Quercetin glycosides are mainly concentrated in the skin as compared with the flesh of apples, but the concentration-dependent effect of quercetin on PPO activity needs to be investigated.

### (d) Vitamin C Concentration

Vitamin C concentration was high in ‘Cortland’, ‘Eden™’, and ‘SJCA16’ (Table 4) with values of 49.23, 40.92, 37.71 (mg/100 g DM), respectively. In this study, a strong positive correlation was observed between WI and vitamin C concentration (r=0.90; P=0.04). The correlation coefficient between vitamin C and PPO activity was −0.67 (P=0.21). In the present study, the lowest ascorbic acid content in ‘Empire’ could be the reason that this genotype exhibited the greatest propensity for enzymatic browning. In addition to the PPO substrates, vitamin C concentration of apple genotypes seems to be another major factor that could contribute to retaining the post-cut flesh color. Ascorbic acid is a highly effective inhibitor of enzymatic browning primarily because of its ability to reduce the enzymatically formed quinones to their precursor diphenols (Baruah and Swain 1953; Rouet-Mayer et al., 1990). In addition, the inhibitory action of vitamin C has been also reported due to its ability to inactivate the enzyme by lowering the pH and chelating the metal ions (Sapers 1993; Vamos-Vigyazo, 1981). Treatment of fresh, sliced, and pureed samples of apple with 1.0% ascorbic acid was found to increase the lightness (1) and decrease the redness (‘a’) and yellowness (‘b’) color values (Rababah et al., 2005).

### (e) Elemental Composition

The relationship between WI and elemental composition suggested that except for zinc and potassium, which showed a moderately negative relationship with the WI, element concentration has no clear impact on the post-cut enzymatic browning (Table 6). Interestingly, a very strong correlation for both copper (r=0.85; P=0.07) and iron (r=0.68; P=0.21) content of fruit with PPO activity was obtained. According to Aydemir (2004), Cu⁺⁺ and Fe⁺⁺⁺ ions at 1 mM caused the activation of PPO, but at 10 mM concentration, both Cu⁺⁺ and Fe⁺⁺⁺ ions acted as poor inhibitors of PPO, whereas, Colak et al. (2007) and Kolcuoglu et al. (2007) have recently found that Cu⁺⁺ at 1 mM concentration was sufficient to inhibit PPO activity. As well, the reported literature on the effects of different metal ions on the PPO activity is conflicting.

### Summary

Among the five apple genotypes studied, ‘Eden™’ showed the highest WI and thus lowest post-cut enzymatic browning. Despite its high PPO activity, ‘Eden™’ exhibited resistance to enzymatic browning, which can be attributed to the low content of phenolic substrates for PPO, catechin, epicatechin, and chlorogenic acid as well as relatively high content of ascorbic acid, which is known to reverse the initial step of orthoquinone production. While no wishing to be limited by theory, it can be concluded that the primary biochemical factor causing the enzymatic browning in the studied apple genotypes depends not only on the presence of active PPO but also on concentration of preferable phenolic substrates, phenolics that inhibit PPO activity, and antioxidants such as ascorbic acid. For the development of apple-based value-added food products (e.g. fresh-cut slices, juices, purees, and dried snacks), ‘Eden™’ can be used as a suitable raw material due to its low post-cut enzymatic browning. Also, ‘Eden™’ possesses relatively high concentrations of vitamin C, quercetin-3-O-rhamnoside and cyanidin-3-O-galactoside, but has lower total antioxidant capacity (FRAP and ORAC values). ‘SJCA16’ possesses a characteristic yellow flesh color. The new breeding lines, ‘SJCA16’, and ‘SuperMac’ possess higher WI than commercial cultivars such as ‘Empire’, and thus can be considered as raw material for apple processing with limited use of anti-browning dipping chemicals.

### Example 2

### Evaluation of Different Methods to Control Post-Cut Enzymatic Browning in Apples

### Materials and Methods

### (a) Plant Material and Chemical Reagents

‘Empire’ cultivar was selected for this study due to its high susceptibility to post-cut enzymatic browning. Apples were obtained from a local fruit market (Sterling Fruit Market, Truro, NS). Food grade CaCl₂ was purchased from ACP Chemicals Inc., St. Leonard, QC. FreshXtend™ was obtained from FreshXtend Technologies Corp., Vancouver, BC.

### (b) Sample Preparation

Apples were washed, wiped with paper towel, cut into 2.0-mm-thick slices perpendicular to the core using an apple slicer (Waring PRO™, Model: FS 150C, Torrington, Conn.). For the application of chemical anti-browning treatment, the slices were immersed in treatment solutions using a fruit to solution ratio of 1:10 (w/v). Three replicates were used for each treatment where a replicate consisted of three randomly selected slices from three apples. All the experiments were conducted independently.

### (c) Browning Intensity

The browning intensity was determined in terms of Whiteness Index (WI) values obtained using a Minolta CR-300 colorimeter (Konica Minolta Sensing, Inc., Ramsey, N.J.) by measuring values of ‘L’ (lightness), ‘a’ (green chromaticity), and ‘b’ (yellow chromaticity) as described by Rupasinghe et al. (2006). The instrument was calibrated using the standard white reflector plate. A decrease in ‘L’ value indicates a loss of whiteness (lightness), and a more positive ‘a’ value indicates that browning has occurred, whereas a more positive ‘b’ value indicates yellowing. Therefore a higher value for WI value corresponds to lesser post-cut enzymatic browning and product discoloration. A reading was taken from each side of all the apple slices, for a total of six readings per replicate. These readings were averaged and one mean value of ‘L’, ‘a’ and ‘b’ was obtained and WI was calculated using the formula described by Bolin and Huxsoll (1991): WI=100−[(100−L)²+a²+b²]^{1/2}.

### (d) Experimental Conditions

For the present study, optimization of three selected anti-browning treatments and the comparison of these optimized anti-browning treatments were done to study their effect on the control of post-cut enzymatic browning in apple slices.

### (e) Optimization of LTLT, HTST, and CaCl₂ Dipping Methods

The following were the conditions used for LTLT, HTST and CaCl₂ dipping methods:
1) LTLT: The fresh-cut apple slices were dipped in distilled water at three different levels of temperature (65, 70 and 75° C.) for three different levels of dipping time (5, 10 and 15 min).
2) HTST: The fresh-cut apple slices were dipped in distilled water at three different levels of temperature (80, 85 and 90° C.) for three different levels of dipping time (10, 20 and 30 s).
3) CaCl₂ dipping: Three levels of CaCl₂ concentration (0.0, 1.0 and 2.0%) was obtained by dissolving it in distilled water (w/v), and apple slices were dipped in these solutions using three levels of dipping time (1, 5 and 10 min).

After the application of a specific anti-browning treatment, the apple slices were immediately dipped in cold water for 10 s and placed on stainless steel wire mesh at an ambient temperature (21±2° C., 40-50% RH, samples were not covered) for 2 h before measuring WI.

### (f) Comparison of LTLT, HTST, CaCl₂ Dipping and Commercial Anti-browning Agents

The following four anti-browning treatments, optimized in the first part of this study were used in the comparative portion of the study:
Control: Control consisted of fresh-cut apple slices without any treatment and kept in open conditions (21±2° C., 40-50% RH, samples were not covered).
LTLT: The fresh-cut apple slices dipped in distilled water at a temperature of 78±2° C. for a period of 26 min.
HTST: The fresh-cut apple slices were dipped in distilled water at a temperature of 90±2° C. for a period of 20 s.
Commercial anti-browning agent: FreshXtend™ at the concentration of 7.5% (w/v) was dissolved in distilled water at room temperature and fresh-cut apple slices were dipped in this solution for the manufacturer's recommended period of 6 min.
CaCl₂ dipping: CaCl₂ at concentration of 1.6% (w/v) was dissolved in distilled water at room temperature and fresh-cut apple slices were dipped in this solution for 9 min.

After the application of a specific anti-browning treatment, the apple slices were treated in the same manner as described as described above for the optimization of the dipping methods. WI of the treated apple slices was measured immediately after anti-browning treatment, after 2, and 4 h periods.

### (g) Experimental Design and Statistical Analysis

A completely randomized design (CRD) was used for all the experiments. The assumptions of normality of residuals were tested using the Anderson-Darling test. Assumptions of constant variance were tested by plotting residual versus fits scatter diagram (Montgomery, 2005). The data were analyzed using ANOVA methods to compare the factor levels in terms of the mean response, using the general linear model (GLM) procedure of the SAS Institute, Inc. (2003). Differences among means were tested by the Tukey's Studentized Range test at α=0.05. This identifies the best response in terms of high WI value, from the tested levels for each factor.

To determine the optimal level for the given factors, Response Surface Methodology (RSM) was used (Montgomery, 2005). Under this methodology, the obtained data were subjected to Canonical analysis using RSREG procedure of SAS Institute, Inc. (2003) and contour plots were drawn using MINITAB 15. The objective of RSM is to determine the optimum operating conditions for the system (stationary point is a point of maximum or minimum response) or to determine a region of the factor space in which operating requirements are satisfied [stationary point is a point of saddle (minimax)] (Montgomery, 2005). When the results showed a saddle point in response surfaces, the ridge analysis of SAS RSREG procedure was used to compute the estimated ridge of the optimum response. The examination of contour plots further enables to study the relative sensitivity of the response to the factors. Graphs were prepared using Sigma Plot 8.0 (Richmond, Calif., USA).

### Results and Discussion

### (a) Optimization of LTLT, HTST, and CaCl₂ Dipping Methods

The pretreatment of fruits and vegetables is done to prevent post-cut enzymatic browning and the consequent deterioration in quality of the processed products. In the present study, the conditions for LTLT, HTST, and CaCl₂ dipping methods were optimized for controlling post-cut enzymatic browning in ‘Empire’ apple.

### (i) LTLT

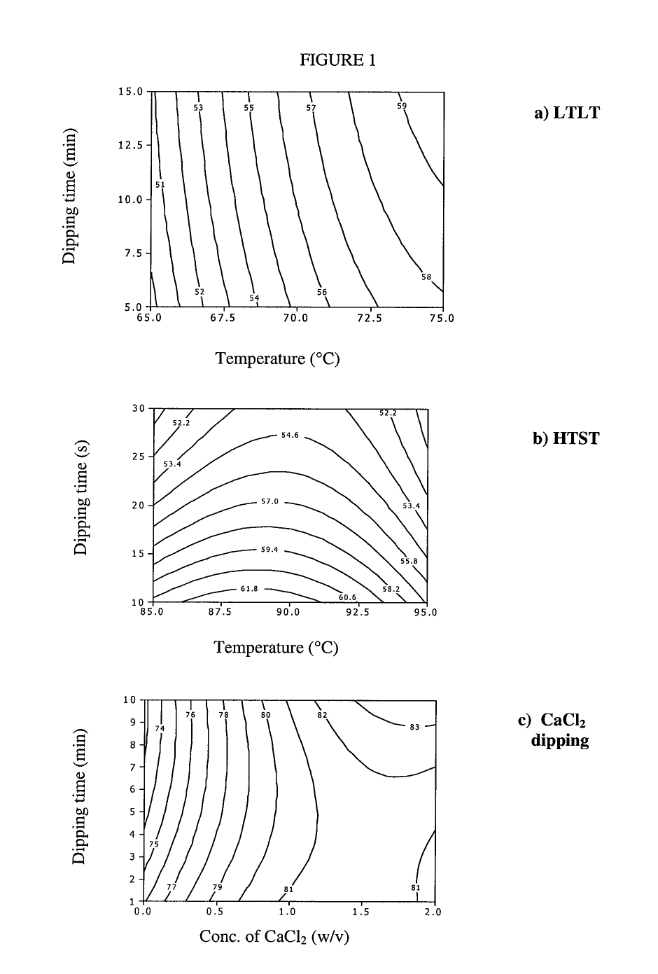

The results of LTLT blanching treatment are shown in Table 7. The statistical analysis showed no significant interaction effect of temperature and dipping time (P<0.05). The apple slices given blanching treatment at 70° C. and 75° C. resulted in the best WI when compared to other temperature levels. There was no influence of dipping time intervals on the WI of the apple slices given blanching treatment at 70° C. and 75° C. However, at lower temperature level (65° C.) there was no improvement in the WI even after 15 min treatment. Contour plots confirmed that under the given process conditions, WI was influenced more by the changes in the temperature levels as compared to changes in the dipping time (FIG. 1a). A continuous increase in the WI with the increase in dipping temperature suggested that the optimum point was toward the higher temperature. It could also be noted from the contour plot that the region of particular WI value was smaller at lower temperature application (65° C.) and this region widened at higher temperature application (75° C.). The Canonical analysis of the data showed the stationary point to be a point of maximum response in terms of WI value (60.82) and the critical values for the temperature and dipping time were 78° C. for 26 min.

Similar results have been reported when LTLT blanching of slices of ‘Granny Smith’ apple cultivar was done using four different conditions (40° C. for 60 min, 40° C. for 30 min, 55° C. for 15 min, and 65° C. for 15 min) (del Valle et al., 1998a). The percent total PPO activity was observed to be minimum (13%) in apple slices given blanching treatment at 65° C. for 15 min and blanching treatment at low temperature (40° C.) for longer time (60 min). Blanching at lower temperature (40° C.) for shorter time (30 min) resulted in poor inactivation of PPO (73-107% PPO activity remaining). In another study of thermal inactivation of PPO of ‘Golden Delicious’ apple cultivar, the authors observed that PPO became more heat sensitive above 72.5° C. (Weemaes et al., 1998). From the literature it seems that the apple PPO contained a latent form which is activated by heat treatment and thus temperatures in the range of 70-105° C. or higher are required for complete destruction of enzymatic activity of PPO (Vamos-Vigyazo, 1981). The heat inactivation kinetics of PPO obtained from six different apple cultivars (‘Golden Delicious’, ‘Starking Delicious’, ‘Granny Smith’, ‘Gloster’, ‘Starcrimson’ and ‘Amasya’) was observed by applying three different temperatures (68, 73 and 78° C.) for 7 and 15 min (Yemenicioglu at al., 1997). The apple PPO was observed to be extremely heat stable between 68 and 78° C. Hence, by applying blanching temperature of 78° C. for duration of 26 min (based on the Canonical analysis in the current study), it can be depicted that complete destruction of PPO activity in ‘Empire’ apple cultivar could be achieved.

### (ii) HTST

HTST blanching was carried out for a relatively shorter time periods (10, 20 and 30 s) at three levels of temperature (80, 85 and 90° C.). A significant interaction effect of factors (temperature and dipping time) was observed (Table 8). Although a 10 s blanching treatment was the best for preventing discoloration under all three temperature regimes, other time-temperature combinations showed significantly lower WI except those blanched at 90° C. for 20 s. HTST blanching conducted at 85° C. for 30 s was least favorable in terms of the resultant visual quality of the slices. The contour plots (FIG. 1b) showed that in the temperature range between 85° C. and 90° C. the WI was higher as compared to the other temperature conditions used. However, as the dipping time was increased WI of apple slices decreased. The stationary point was depicted to be a saddle point; therefore the ridge analysis for maximum response was done. Based on these results HTST treatment at 90° C. for 20 s was selected for conducting further experiments.

HTST treatment of apple pieces by directly immersing in boiling water for 30 and 60 s showed inactivation of 89% of total PPO activity (del Valle et al., 1998a). It has been reported that apple PPO is inactivated slowly at 75° C. and rapidly at 90° C. as apple PPO becomes more heat sensitive at higher temperature (Weemaes et al., 1998). Similar observations were noted for PPO in potato which was inactivated more quickly at high temperature (100° C.) and required longer time at lower temperature (80° C.) (Svensson, 1977). Thus, the application of high temperature at 90° C. for a short time of 20 s can be considered to minimize the thermal losses (loss of nutrients and other product quality losses such as flavor, color, taste and texture) which could otherwise occur during the longer time blanching treatments (Biekman et al., 1996; Lee and Kader, 2000; Negi and Roy, 2000; Nicoli et al., 1999; Song et al., 2003).

(iii) CaCl₂ Dipping

The results of the apple slices subjected to CaCl₂ dipping treatment are shown in Table 9. The dipping solution containing CaCl₂ at all the three dipping times resulted in significantly higher WI than the control solution containing no CaCl₂. WI for apple slices treated with 1.0 and 2.0% CaCl₂ for 1, 5, and 10 min was comparable to each other. The contour plot showed stationary point as saddle point which was further confirmed by Canonical analysis (FIG. 1c). The contour plot and the ridge analysis for maximum WI indicated that solution dipping containing concentration of 1.6% (w/v) of CaCl₂ and applying dipping time of 9 min would result in obtaining optimum WI under the given conditions.

Son et al. (2001) compared the effect of individual anti-browning agents at 1.0% (w/v) of sodium chloride, calcium chloride and ascorbic acid for controlling browning in apple tissue by applying dipping time of 3 min, and observed no difference in change of L values when treated samples were kept out for 3 h. In another study, the initial color of fresh-cut ‘Golden Delicious’ apple cubes was well preserved by dipping in solutions containing 1.0% and 5.0% (w/v) CaCl₂ (Soliva-Fortuny et al., 2005). Calcium chloride in combination with zinc chloride, ascorbic acid and citric acid was observed to be effective against PPO activity (Bolin and Huxsoll, 1989). In yet another study, CaCl₂ at 1.0% was used along with ascorbic acid (2.0%) to successfully control browning (Gorny et al. 1998).

### (iv) Comparison of LTLT, HTST, CaCl₂ Dipping and Commercial Anti-Browning Agents

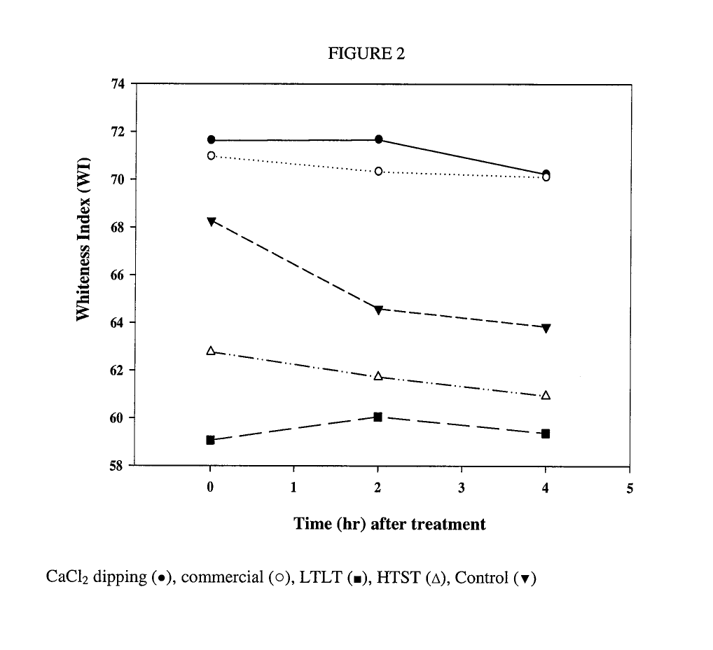

Comparison of optimized methods for LTLT, HTST, CaCl₂ dipping and commercial anti-browning agent FreshXtend™ was done to study the impact on post-cut enzymatic browning in fresh-cut apple slices. There was a significant effect of the given treatments on the WI, measured at all of the three different time intervals (Table 10). The graph showing the changing trend of WI of treated apple slices measured immediately after anti-browning treatment, after 2, and 4 h periods is given in FIG. 2. WI measured immediately after giving the anti-browning treatment was found to be highest in the apple slices treated with CaCl₂ and commercial anti-browning agents. Immediately after the treatment, both thermal treatments (LTLT and HTST) resulted in lower WI as compared to control and other anti-browning treatments. The advantage of HTST in producing an apple slice with low discoloration was lost when the treated apple slices were exposed to air for 2 h. However, over a period of time (4 h), WI in apple slices given thermal treatment showed WI comparable to control. The possible reason is that WI in untreated apple slices decreased over a period of time but it remained relatively the same in thermally treated apple slices following the treatment. The control apple slices continued to become darker with time (up to a period of 4 h examined in this study). Both CaCl₂ dipping and commercial anti-browning treatment helped to retain whiteness even after 2 and 4 hr of exposure time.

The initial browning which occurred during the application of LTLT and HTST methods can be attributed to the non-enzymatic browning reactions (Maillard reaction) which can occur at high temperature application (Taiwo et al., 2001). In thermally treated fruits, it has been observed that ascorbic acid and polyphenols take part in non-enzymatic browning reactions (Djilas and Milic, 1994). Taiwo et al. (2001) found that concentration of ascorbic acid was decreased in blanched apple slices as compared to untreated apple slices. The other quality attributes which could be affected by blanching are loss of texture and leaching of solids from apple tissue due to the damaging effect of keeping the apple slices in boiling water (Nieto et al., 1998).

CaCl₂ dipping method and commercial anti-browning agent (FreshXtend™) were able to retain the maximum whiteness in fresh-cut apple slices over 4 h of the atmospheric conditions. The retention of whiteness in apples slices given CaCl₂ dipping treatment can be attributed to the inhibitory action of CaCl₂ on PPO (Janovitz-Klapp et al., 1990; Pitotti et al., 1990).

### Summary

Post-cut enzymatic browning has direct influence on the color, flavor and texture of the fresh as well as processed fruit products. Four different anti-browning treatments were selected to control the post-cut enzymatic browning in fresh-cut apple slices. The conditions were first optimized for LTLT, HTST and CaCl₂ dipping treatment. In LTLT blanching, the optimum level of temperature of dipping solution was 78° C. and dipping time was 26 min. For HTST blanching, a ridge of maximum WI was obtained from which dipping temperature of 90° C. and dipping time of 20 s was selected. Addition of CaCl₂ [1.0 or 2.0% (w/v)] to the dipping solution resulted in higher WI as compared to solution with no CaCl₂. Based on the Canonical analysis, the concentration of 1.6% (w/v) of CaCl₂ and dipping time of 9 min was selected for conducting further experiments.

The comparison of these selected anti-browning methods showed that CaCl₂ anti-browning treatment was more efficient in control of enzymatic browning as compared to LTLT and HTST methods. There was no difference in browning inhibition when CaCl₂ anti-browning treatment was compared to commercially available anti-browning agent FreshXtend™. The thermal anti-browning treatments such as LTLT and HTST showed lower WI as compared to other anti-browning treatments and control. The browning of apple slices which occurred during thermal treatments can be due to the thermally induced non-enzymatic browning reactions. Hence, the use of GRAS chemicals becomes necessary as an alternative method of controlling browning. CaCl₂ dipping method holds a great potential as a pretreatment for inhibiting enzymatic browning during further processing such as drying of apple slices which can meet the requirements of low cost, value-addition, efficient and environment friendly anti-browning agents. The additional benefits of CaCl₂ includes improved texture during processing conditions and also a dietary source of calcium and chloride in the apple-based food products such as apple snacks.

### Example 3

### Comparison of Drying Processes for Producing Non-Fried Apple Snacks

### Materials and Methods

### (a) Plant Material and Chemical Reagents

Apples of the ‘Empire’ cultivar were selected for this study and apples were obtained from a local fruit market (Sterling Fruit Market, Truro, NS). Vacuum drying was done in a freeze dryer with the cooler unit off (SuperModulo freeze dryer, Thermo Electron Corporation, N.Y., US). Oven drying was done using gravity convection oven (Thelco, Model: 28, GCA/Precision Scientific, LabX, ON). Air drying was done using a tray dryer (Armfield, Model: UOP 8, Armfield Ltd., England).

### (b) Sample Preparation

For drying, apples were washed, wiped with paper towel, cut into 2.0-mm-thick slices perpendicular to the core using an apple slicer (Waring PRO™, Model: FS 150C, Torrington, Conn.). The apple slices were immediately put on the stainless steel wire mesh and transferred to the dryer. For the drying of apple slices the conditions selected for air-, oven-, and vacuum-drying were based on preliminary trails conducted using ANOVA and RSREG procedure of SAS Institute, Inc. (2003) (Appendix II).

Following parameters were applied for the selected drying methods:

1) Air drying at 60±2° C. at 0.8±0.1 m/s for 7 h

2) Oven drying at 70±2° C. for 8 h

3) Vacuum drying at 30±2° C. for 15 h at vacuum pressure 10⁻³ torr.

After the completion of drying process the dried apple slices were immediately transferred to air tight plastic containers.

### (c) Color (WI)

Color of the dried apple slices was determined in terms of Whiteness Index (WI) as described in Example 2.

### (d) Textural Characteristics

Puncture test method was performed on the dried apple slices using a texture analyzer (Model: TA.XT Plus texture analyzer, Texture Technologies Corp., New York, USA), in which a blade probe was passed through a given distance (15 mm) at the test speed of 1.00 mm/s (Katz and Labuza, 1981). The data were obtained for area (kg.s), maximum force (kg), gradient (kg/s) and linear distance (kg.s). The maximum force is the force required to break the sample. The gradient recorded in the form of deformation curve was calculated from the baseline to the peak height. The linear distance was calculated as the distance traveled by the probe after touching the sample surface and before actually breaking the dried apple slice.

(e) Moisture Content (MC) and Water Activity (a_{w})

The moisture content (MC) of fresh and dried apple slices was determined using methods of AOAC (Method 934.06) (2000). The water activity (a_{w}) in dried apple slices was measured using a water activity meter (Novasina, Model: ms1 Set aw, Geneq Inc. Quebec, Calif.).

### (f) Estimation of Bioactive Compounds

The dried apple slices were analyzed for total phenolic (Folin-Ciocalteu) content, phenolic profiles and vitamin C concentration as described in Example 1.

### (g) Estimation of Total Antioxidant Capacity

The dehydrated apple slices were analyzed for total antioxidant capacity using FRAP (Ferric Reducing Ability of Plasma) and ORAC (Oxygen Radical Absorption Capacity) assays as described in Example 1.

### (h) Experimental Design and Statistical Analysis

A completely randomized design (CRD) was selected using three replicates for each treatment where a replicate consisted of ten randomly selected slices from three apples, thus obtaining a total of thirty slices for each replicate. The assumptions of normality of residuals were tested using the Anderson-Darling test. Assumptions of constant variance were tested by plotting residual versus fits scatter diagram (Montgomery, 2005). The data were analyzed using one way ANOVA methods, using the general linear model (GLM) procedure of the SAS Institute, Inc. (2003). Differences among means were tested by the Tukey's Studentized Range test at α=0.05. Pearson correlation coefficient (r) was used to indicate the relationships between parameters.

### Results and Discussion

### (a) Color

Drying processes applied showed considerable effect on the browning of apple slices. Lack of browning and retention of the natural apple color was reflected by high WI. These values were higher in vacuum- and air-dried slices of ‘Empire’ apple when compared to that of oven-dried apple slices (Table 11). Oven-dried apple slices resulted in lower WI possibly due to the non-enzymatic browning which has been also noted by previous researchers. Drying of ‘Amasya’ and ‘Golden Delicious’ apple cultivars using a cabinet dehydrator (at 60, 70 and 80° C. for 5, 5, 4 h) along with hot air current showed maximum browning during the second hour of drying at 60 and 70° C., and substantial browning during the first hour of drying at 80° C. The formation of hydroxymethylfurfural (HMF) in apple slices was reported at the 4th hour of drying process carried out at 80° C. (Akyildiz and Ocal, 2006). Resnik and Chirife (1979) also reported an accumulation of HMF during the heat induced browning of ‘Granny Smith’ apple at all the moisture contents (2, 4, 6, 8, 10, 20, 40, 60, and 80%) and temperatures (55, 63.4, 74, and 83° C.). Thus, it seems reasonable to speculate that the browning of oven-dried apple slices observed in the present study may have been due to hydroxymethylfurfural (HMF) which is one of the products of the non-enzymatic browning reactions (Maillard reaction) produced under high temperature conditions. The γ-aminobutyric acid (GABA, NH₂—(CH₂)₃—COOH) present in apple and other fruits could also participate in the Maillard reaction (Lamberts et al., 2008). The occurrence of browning in fruits can also be caused by the oxidation of the phenolic compounds in the presence of oxygen and high temperature, which can further undergo subsequent condensation reactions leading to brown pigment formation (Singleton, 1987). Thus to preserve the color of the apple slices in the drying process, low temperature were most desirable.

### (b) Textural Characteristics

In the present study, the texture of the dried apple slices was determined by measuring area, maximum force, gradient and linear distances (Table 11). The values for area and maximum force were higher for air-dried slices, whereas vacuum- and oven-dried slices yielded comparable area and maximum force values for texture. The distance traveled before breaking was observed to be longer for air-dried slices, whereas it was observed to be smallest for the oven-dried apple slices followed by vacuum-dried apple slices. In air-dried apple slices, the collapse of the natural cellular structure results in shrinkage and loss of crispiness (Bialobrzewski, 2007; Ratti, 1994). The greater amount of work required to break in case of air-dried slices can also be ascribed to the case hardening i.e. the formation of impervious layers during the air drying (del Valle et al., 1998b; Wang and Brennan, 1995).

The textural measurements of snacks are greatly influenced by the moisture content and water activity of snack foods. In the present experiment positive relationships of the moisture content and water activity with area and maximum force were obtained. It was noted that air-dried apple slices showed highest water activity (0.14) and moisture content (4.18%), requiring a greater amount of work and force for breaking, and were less crispy as compared to other dried apple slices. Similar observations were obtained for dried apple slices with water activity 0.12 or below which demonstrated excellent crispiness and were highly acceptable as snack product; however, as the water activity increased, a significant decrease of crispiness and an increase of the energy were required to break the chips (Konopacka et al., 2002).

### (c) Phenolic Compounds

The bioactive compounds (phenolic acids, anthocyanins, flavonols, flavan-3-ols, and flavanonols) present in apple are associated with the color, taste, and nutritional quality including their antioxidant capacity (Macheix et al., 1991; Ho, 1992). The impact of different drying methods on the phenolic compounds in apple tissue was found to be compound dependent (Table 122). Phloridzin and quercitin-3-O-rhamnoside were well retained under all of the drying conditions studied. However, the concentration of catechin and epicatechin was significantly reduced in oven-dried apple slices. The concentration of chlorogenic acid was reduced in the apple slices exposed to all of the drying processes when compared to fresh apple slices. Oven- and air-drying of apple slices resulted in significant loss of cyanidin-3-O-galactoside. However, the concentration of quercetins (with the exception of quercetin-3-O-rhamnoside) was well retained during all the processes examined and was observed to be significantly higher in vacuum-dried apple slices as compared to fresh, oven- and air-dried apple slices. The concentration of phloretin was observed to be significantly higher in air- and oven-dried apple slices as compared to fresh and vacuum dried apple slices.

### (d) Vitamin C Concentration

Similarly drying processes showed varying effects on the vitamin C concentration (Table 3). The vitamin C concentration was observed to be higher in the fresh as compared to the vacuum-dried and oven-dried slices. The vitamin C concentration in air-dried apple slices was comparable to vacuum-dried apple slices.

### (e) The Total Phenolic Content and Total Antioxidant Capacity

The total phenolic (Folin-Ciocalteu) content in dried apple slices (Table 14) was not affected by any of the drying methods. Also, there was no effect of drying on the total antioxidant capacity, measured using both FRAP and ORAC assays, in fresh and dried apple slices.

The changes that phenolic compounds undergo during the drying process could increase the content of free phenolic compounds which could in turn act as antioxidants or as new substrates for further oxidation (Fu, 2004; Manzocco, 2000). Thus, even after exposure to high temperature and atmospheric conditions during oven- and air-drying, the dried apple slices did not show any difference in total phenolic content and total antioxidant capacity as compared to fresh apple slices.

### Summary

Drying is a potential alternative method for producing non-fried apple snacks which could help in retaining the quality attributes including color and heat sensitive bioactive compounds. The present research work was carried out to study the impact of different drying processes on these bioactive compounds and the associated total antioxidant capacity and physical characteristics of the dried slices. Oven drying resulted in improved textural attributes in the dried apple slices; however, due to the browning in oven-dried apple slices, and also due to the loss of certain important phenolic compounds such as catechin, epicatechin, and cyanidin-3-O-galactoside, oven drying method is not recommended for drying of apple slices. Air drying resulted in better retention of color and phenolic compounds than oven drying but air dried apple slices showed poor textural attributes.

Vacuum-dried apple slices were observed to have desirable WI and textural attributes. Also the phenolic profiles were well retained during the vacuum drying. From this study it can be concluded that the development of non-fried apple snacks using vacuum drying methods could provide several benefits to the consumers such as enhanced nutritional value, convenience and aesthetic characteristics.

### Example 4

### Optimization of the Pretreatment Processes for the Development of Non-Fried Apple Snacks

### Materials And Methods

(a) Plant Material and Chemical Reagents

Empire' cultivar was selected for this study as it is mainly produced in Nova Scotia. Apples were obtained from a local fruit market (Sterling Fruit Market, Truro, NS). Solution containing Welch's grape cocktail frozen concentrate diluted to a concentration of 15±2° Brix was used for dipping the apple slices into solution. Food grade CaCl₂ (calcium chloride) was purchased from ACP Chemicals Inc., St. Leonard, QC. Great Value table salt [NaCl (sodium chloride)] was obtained from a local market. t-Resveratrol glucoside standards were obtained from ChromaDex Inc., Irvine, Calif. Acetone, acetonitrile, formic acid and methanol were purchased from Fisher Scientific Ltd., ON.

### (b) Sample Preparation

In preparation for the VI treatment, apples were washed, wiped with paper towel, cut into 2.0-mm-thick slices perpendicular to the core using an apple slicer (Waring PRO™, Model: FS 150C, Torrington, Conn.). The apple slices were then immediately dipped in diluted grape fruit juice (15±2° Brix) with a fruit to solution ratio of 1:10 (w/v) and given VI treatment. Three replicates were used for each treatment where a replicate consisted of six randomly selected slices prepared from two apples. After the VI treatment, the slices were immediately put on the food grade plastic mesh and transferred to the vacuum dryer. Drying was carried out in two stages: 1) first at low temperature (30±2° C. for 10 h) and 2) then at high temperature (40±2° C. for 10 h). Immediately after drying, the vacuum impregnated dried apple slices were transferred to air tight plastic containers and kept at room temperature.

### (c) Selection of the Parameters of VI Process

For preparing VI-treated dried apple slices, a vacuum pressure in the range of 2-6 in. of Hg and an application time of 10-30 min was assayed. Table 15 summarizes the processing parameters of VI processing of fruits, which have been commonly used and referred by most of the researchers.

For the present study, the values for uncoded levels (actual values) in the central composite design were: application time 5 (−1) to 15 (+1) min, relaxation time 15 (−1) to 30 (+1) min, as shown in Table 16. For vacuum pressure a range of 4(−1) to 8 (+1) in. of Hg was selected. Grape juice was selected as the immersion solution to act as an indicator of the incorporation of the grape juice by providing red color to the apple slices and also act as a source for the incorporation of the important phenolic compounds, i.e. t-resveratrol glucoside (Gurbuz et al., 2007) which is not present in the apples and hence can be used as a marker to assess the effect of VI process conditions.

### (d) Optimization of VI Process Using Response Surface Methodology

To determine the optimal level for the given factors, response surface methodology (RSM) was used (Montgomery, 2005). RSM enables the evaluation of the effects of several process variables and their interactions on response variables. The experimental design employed was a 3-variable, with 6 levels of each variable, central composite design. This design with the actual and coded levels of variables is shown in Table 16. In addition to other desirable statistical properties, relatively few experimental combinations of the variables are required to estimate the responses with this design. The three independent variables for the vacuum impregnation process were vacuum pressure, application time and relaxation time. The responses including fortification of apple slices with grape juice [(t-resveratrol glucoside concentration and color (positive ‘a’ value)], drying process efficiency (moisture content and water activity), and textural attributes (maximum force, gradient and linear distance) of the dried VI-treated apple slices were estimated. RSREG procedure of SAS Institute, Inc. (2003) was used to obtain predictive models.

Optimization of the independent variables was conducted by employing Canonical analysis (Montgomery, 2005). The steps followed in conducting Canonical analysis using RSM are given in FIG. 2. The assumptions of normality of residuals were tested using the Anderson-Darling test. Assumptions of constant variance were tested by plotting residual versus fits scatter diagram (Montgomery, 2005). The objective of Canonical analysis in RSM is to determine the optimum operating conditions for the system (stationary point is a point of maximum or minimum response) or to determine a region of the factor space in which operating requirements are satisfied [stationary point is a point of saddle (minimax)] (Montgomery, 2005). The nature of the responses was determined from the stationary points and the signs and magnitudes of the eigen values. If the eigen values are all positive, the stationary point is a point of minimum response; if eigen values are all negative, the stationary point is a point of maximum response; and if eigen values have different signs, the stationary point is a saddle point. When the results showed a saddle point in response surfaces, the ridge analysis of SAS RSREG procedure was used to compute the estimated ridge of the optimum response at points of increasing radii from the center of the design. The examination of contour plots further enables one to study the relative sensitivity of the response to the factors. Contour plots were generated as a function of two factors when the third factor was held constant from the models using MINITAB15.

### (f) Analytical Methods

(i) Color (‘a’ value)

The color of dried apple slices was determined in terms positive ‘a’ values (red chromatocity). The larger positive ‘a’ values reflected greater incorporation of grape juice in the VI-treated apple slices. The method of taking color readings is the same as described in Example 2.

(ii) t-Resveratrol Glucoside Concentration

For the estimation of t-resveratrol glucoside concentration, the VI-treated and dried apple slices were ground into powder using a grinder (Cuisinart, Model: DCG-12BCC, Cuisinart Canada, Woodbridge, ON). Extraction buffer (15 mL) consisting of 40% methanol, 40% acetone, 20% water and 0.1% formic acid was added to 0.5 g of powder and the mixtures were subjected to approximately 20 kHz energy of sonication (Model: 750D, ETL Testing Laboratories Inc., Cortland, N.Y.) for 15 min (three times, with 10-min intervals). The crude extract was centrifuged (Model: Durafuge 300, Precision, Winchester, Va.) at 4000 rpm for 15 min. The extracted samples were concentrated to 10 fold by removal of methanol using vacuum concentrator (Universal vacuum system, Model: UVS400-115, Thermo Electron Corporation, Milford, Mass., US) for 2 h in intervals of 30 min with 5 min break and dissolving the suspension in 300 μL of methanol. Extracts of each sample were prepared in triplicate and stored in amber vials at −70° C. Analyses of t-resveratrol glucoside was performed with a Waters Alliance 2695 separations module (Waters, Milford, Mass.) coupled with a Micromass Quattro micro API MS/MS system and controlled with Masslynx V4.0 data analysis system (Micromass, Cary, N.C.). The column used was a Phenomenex Luna C18 (150 mm×2.1 mm, 5 μm) with a Waters X-Terra Miss. C18 guard column. A previously reported method (Buiarelli et al., 2006) was modified and used for the separation of the t-resveratrol glucoside. A gradient elution was carried out with 0.1% formic acid in water (solvent A) and 0.1% formic acid in acetonitrile (solvent B) at a flow rate of 0.35 mL/min. A linear gradient profile was used with the following proportions of solvent A applied at time t (min); (t, A %): (0, 94%), (9, 83.5%), (11.5, 83%), (14, 82.5%), (16, 82.5%), (18, 81.5%), (21, 80%), (29, 0%), (31, 94%), (40, 94%). Electrospray ionization in negative ion mode (ESI) was used for the analysis of t-resveratrol glucoside. The following conditions were used: capillary voltage 3000 V, nebulizer gas (N₂) at temperature 375° C. and a flow rate of 0.35 mL/min. Multiple Reaction Monitoring (MRM) mode using specific precursor/product ion transitions was employed for quantification in comparison with standards: m/z 389→227 for t-resveratrol glucoside.

(iii) Moisture Content (MC) and Water Activity (a_{w})

The moisture contents of dried apple slices were determined as described in Example 3. The water activity (a_{w}) was measured using a water activity meter (Novasina, Model: ms1 Set aw, Geneq Inc. Quebec, Calif.).

(iv) Textural Characteristics

Texture analysis of apple slices was done using the puncture test method as described in Example 3. The responses measured were maximum force, gradient, and linear distance.

### Result and Discussion

The response values of color (‘a’ value), t-resveratrol, moisture content, a_{w} and textural attributes (maximum force and gradient) obtained by running the central composite design using RSM are given in Table 17. On the basis of coded data, Canonical analysis for all the responses except for water activity resulted in both positive and negative eigen values and, demonstrated the stationary point as a saddle point for all the responses examined in VI-treated apple slices (Table 18). Therefore, ridge analysis was performed to determine the levels of the design variables that would produce the maximum response under the given conditions. Further examination of contour plots illustrated the relationship between experimental factors and response in two-dimensional representation generated for all the responses.

### (a) Fortification of Apple Slices

The present study was carried out to obtain the optimum VI conditions for the fortification of apple slices which was done by giving VI treatment with colored grape juice and determining the color (‘a’ values) and t-resveratrol concentration in the VI-treated apple slices after drying.

(i) Color (‘a’ Value)

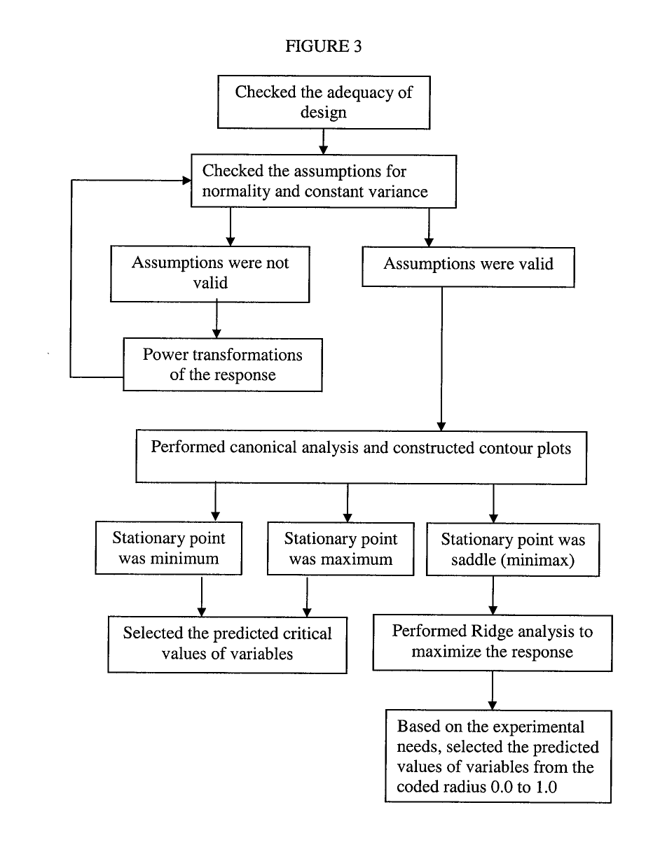

The stationary point for response color (‘a’ value) was depicted to be a saddle point (Table 18), therefore, the ridge analysis was done. The maximum incorporation of grape juice at a distance of coded radius 1.0 in terms of color (‘a’ value: 30.94) would be estimated at vacuum pressure (7.63 in. of Hg), application time 15.74 (min) and relaxation time 29.44 (min) (Table 19). The contour plots were generated as a function of two variables while keeping the third variable constant at the middle value (coded value 0). FIG. 3a shows variation in the ‘a’ values with respect to application and vacuum pressure, keeping relaxation time constant (22.5 min). It can be depicted that with the application of higher vacuum pressure and longer application time, ‘a’ values would increase. When application time is held constant at the middle level (10 min), ‘a’ values would be influenced more by the relaxation time (up to 25 min) as compared to the changes in vacuum pressure (FIG. 3b). Under constant vacuum pressure (6 in. of Hg), when application time is shorter, ‘a’ values would increase with the increasing relaxation time up to 20 min. However, more increase in ‘a’ values is expected by keeping application time and relaxation time longer (FIG. 3c). Here also the ‘a’ values were influenced more by the relaxation time as compared to the application time while keeping the third variable, vacuum pressure constant at the middle level. All of the three contour plots suggested that moving in the direction of high vacuum pressure, application time, and relaxation time would result in higher ‘a’ values, i.e. greater incorporation of fruit juice.

(ii) Resveratrol Glucoside Concentration

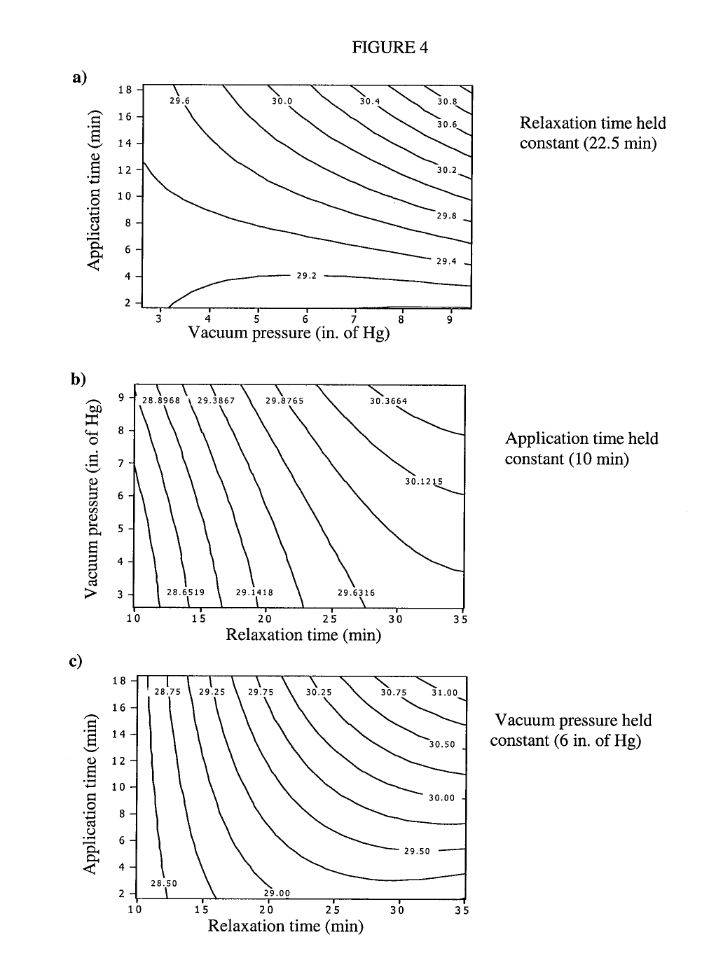

The results of the Canonical analysis for t-resveratrol glucoside concentration depicted the stationary point to be a saddle point (Table 18). The ridge analysis showed that maximum incorporation of grape juice in terms of concentration of t-resveratrol glucoside (28.50 mg/100 g DM) (at a distance of coded radius 1.0) in dried apple slices were estimated at vacuum pressure (8.45 in. of Hg), application time 14.45 (min) and relaxation time 28.11 (min) (Table 19). Under constant relaxation time (FIG. 4a) and application time (FIG. 4b) the saddle point can be clearly seen. Further examination of the contour plots (FIG. 4a) revealed that when relaxation time is held constant at the middle level (22.5 min), the response values would be more at lower levels of application and relaxation time and increasing the levels would result in decreased concentration of t-resveratrol glucoside. However, if the vacuum pressure is increased above 5 in. of Hg and application time above 10 min then the response values would start to increase. Taking into consideration of changes in the vacuum pressure and relaxation time (FIG. 4b), the response value is depicted to increase by selecting higher levels of these VI parameters. Similar results for higher t-resveratrol glucoside concentration can be obtained by keeping vacuum pressure below 5 in. of Hg and relaxation time below 25 min. When vacuum pressure is held constant (6 in. of Hg), increasing the level of application time and relaxation time would result in increased t-resveratrol glucoside concentration (FIG. 4c).

(b) Moisture Content (MC) and Water Activity (a_{w}) in VI-Treated Apple Slices

The amount of moisture content and water activity in the dried product not only affects the texture (as described in Example 3) but also the shelf life of the dried snack foods (Draudt and Huang, 1966; Rahman and Labuza, 1999). The impact of VI process and its optimization for obtaining minimum moisture content and water activity in the dried apple slices was studied.

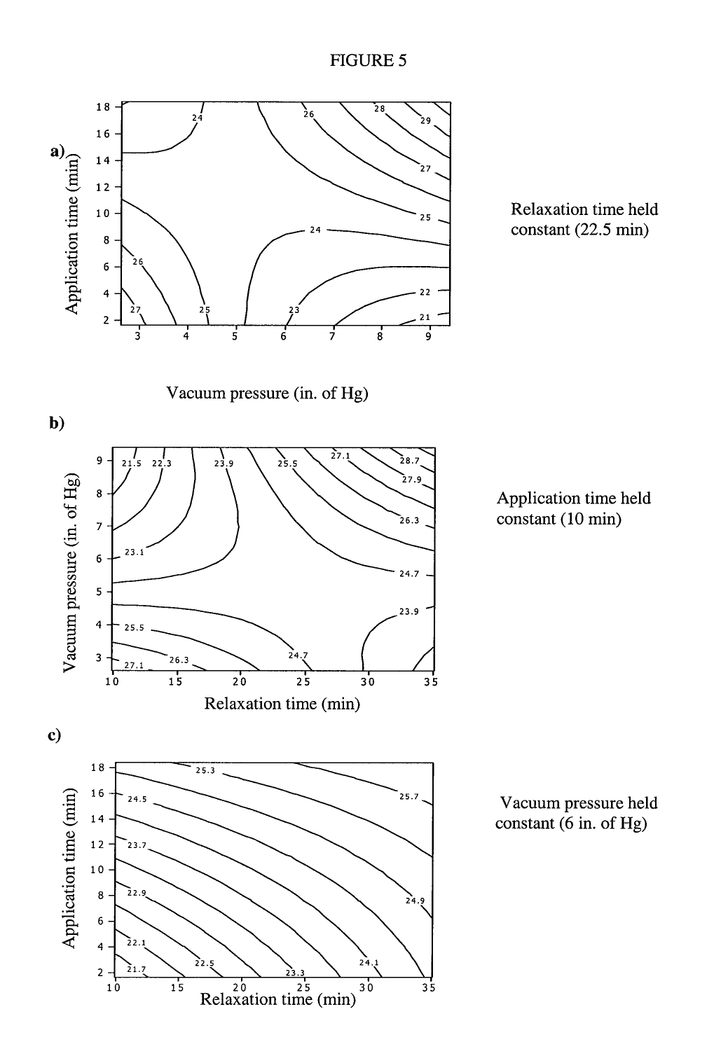

The Canonical analysis depicted the stationary point for % MC to be a saddle point (Table 18) which was also observed in the contour plots (FIG. 5). The ridge analysis showed that apple snacks with minimum amount of MC (2.32%) at a distance of coded radius 1.0 would be estimated at vacuum pressure (8.03 in. of Hg), application time 3.29 (min) and relaxation time 23.30 (min) (Table 19). When relaxation time was held constant at 22.5 min, the MC would be estimated to be low either at higher application time and lower vacuum pressure or at lower application time and higher vacuum pressure (FIG. 5a). Similar predictions can be made when application time (FIG. 5b) and vacuum pressure (FIG. 5c) is held constant at the middle level. Hence, depending upon the requirements of the processing conditions and the results desired, the optimum VI process parameters can be selected.

The Canonical analysis for response a_{w} in the dried apple slices revealed the stationary point to be a point of minimum (Table 18). The predicted stationary point for apple snacks with minimum amount of a_{w} (0.09) would be estimated at vacuum pressure (5.95 in. of Hg), application time 8.09 (min) and relaxation time 29.29 (min) (Table 19). Under all the three conditions, the contour plots also showed stationary point as a point of minimum. When relaxation time was held constant, the desired response values (lowest a_{w}) would be estimated at the vacuum pressure between 5 to 7 in. of Hg and application time between 6 to 12 min (FIG. 5a). When application time was held constant, the application of lower vacuum pressure (5 to 7 in. of Hg) and relaxation time between 20 to 35 min would result in apple snacks with minimum a_{w} (FIG. 5b). Under constant vacuum pressure (FIG. 5c), it can be observed that towards the lower design point of the application time (application time 4 to 12 min) and longer relaxation time (20 to 35 min) would result in minimum a_{w} in apple snacks.

Application of VI process has been reported to facilitate the removal of the moisture from the fruit matrix (Fito et al., 1996). Thus, the incorporation of solutes in the matrix of the fruit during VI process would result in lesser water activity (Nieto et al., 1998). Hence, altering the VI process parameters, the moisture content and water activity suitable for the dried apple snacks can be obtained.

(c) Textural Characteristics of VI-Treated Apple Slices

VI treatment of apple slices can result in a more compact cell matrix during drying due to internal cell gas loss and hence influence the textural attributes of the final dried products (Contreras et al., 2005). Crispiness is one of the most important textural attributes of snacks which can be explained in terms of maximum force, gradient and linear distance (Lefort et al., 2003; Sham et al. 2001). In instrumental texture analysis of the VI-treated apple slices, greater values for gradient and linear distance and lesser value for maximum force corresponds to higher crispiness. The results of the instrumental texture analysis for these responses are given in Table 18 and 19.

(i) Maximum Force

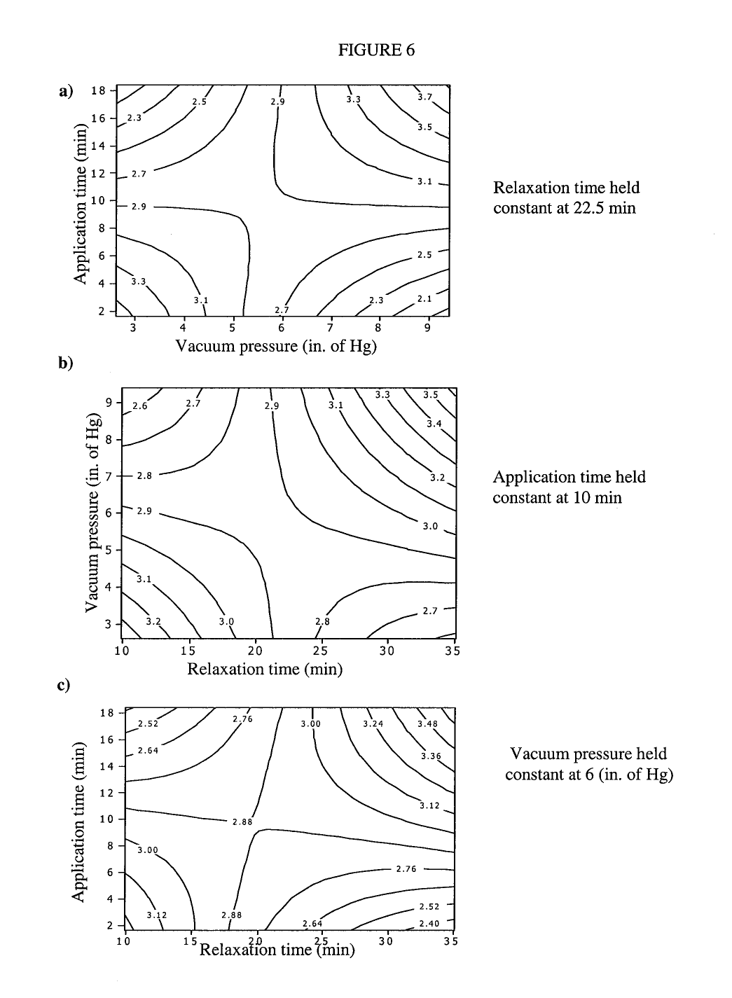

The lower values for maximum force required to break the VI-treated apple slices corresponded to higher crispiness. The stationary point for maximum force was a saddle point in the Canonical analysis (Table 18) which can also be seen in the contour plots (FIG. 20). The ridge analysis showed that apple snacks with minimum values for force (1.02) would be estimated at vacuum pressure (8.09 in. of Hg), application time 10.77 (min) and relaxation time 12.63 (min) at a distance of coded radius 1.0 (Table 19). The examination of the contour plots revealed that when relaxation time was held constant (22.5 min), the values for maximum force would be influenced more by changes in application time as compared to changes in vacuum pressure (FIG. 6a). Under constant application time at the 10 min (FIG. 6b), the response values seemed to be influenced by both the vacuum pressure and relaxation time. It can be depicted that the values for maximum force in treated apple slices would be smaller when vacuum pressure is at higher level (9 in. of Hg) and relaxation time is at shorter (10 min). Similarly, the values for maximum force would be smaller if relaxation time is longer (25 min) and vacuum pressure is low (3 in. of Hg). When vacuum pressure is held constant, the contour plot depicted more variation in the response value with changes in the application time interval (FIG. 6c).

(ii) Gradient

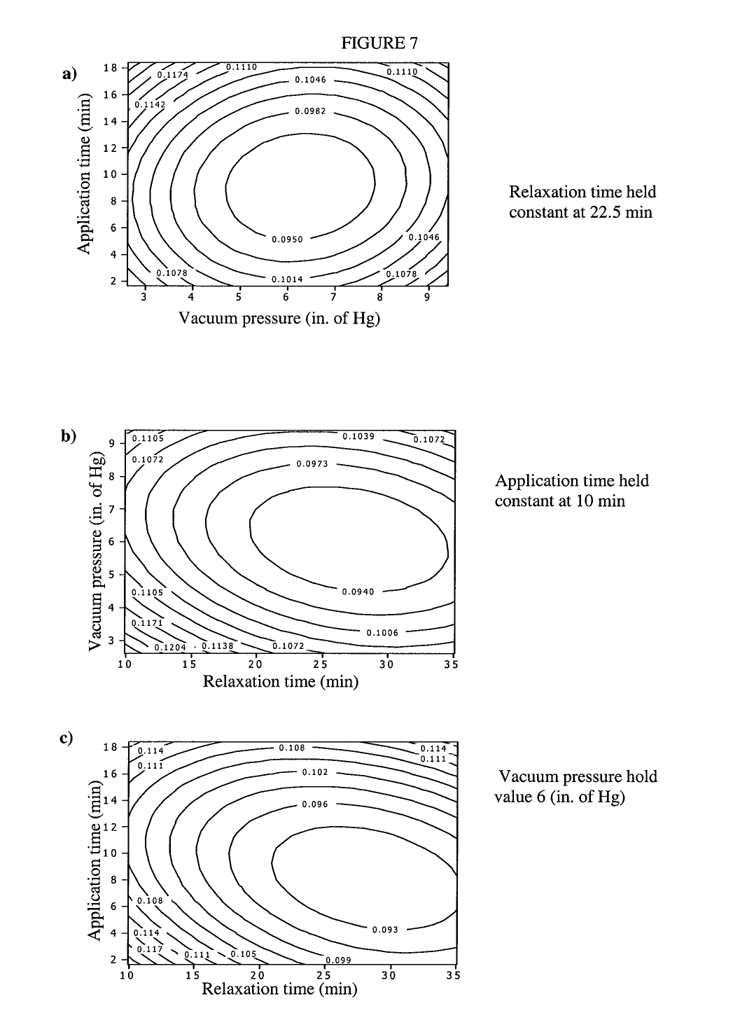

A greater value for gradient corresponded to higher crispiness of the snacks. Here also the stationary point in the Canonical analysis was observed to be a saddle point (Table 18), therefore, the ridge analysis was done which showed that apple slices with maximum values for gradient (0.55) at a distance of coded radius 1.0 would be estimated at vacuum pressure (4.04 in. of Hg), application time 8.93 (min) and relaxation time 32.68 (min) (Table 19). The examination of contour plots showed that when relaxation time was held constant, the response values would be influenced more by application time as compared to vacuum pressure (FIG. 7a). The gradient value would be least (0.64 kg/s) when application time is in the range of 10 to 12 min and vacuum pressure is in the range of 4 to 9 in. of Hg. When the application time is held constant (10 min) the gradient value would be affected by both vacuum pressure and relaxation time (FIG. 7b). Similarly under constant vacuum pressure (FIG. 7c) gradient values seemed to be influenced by both application time and relaxation time.

(iii) Linear Distance

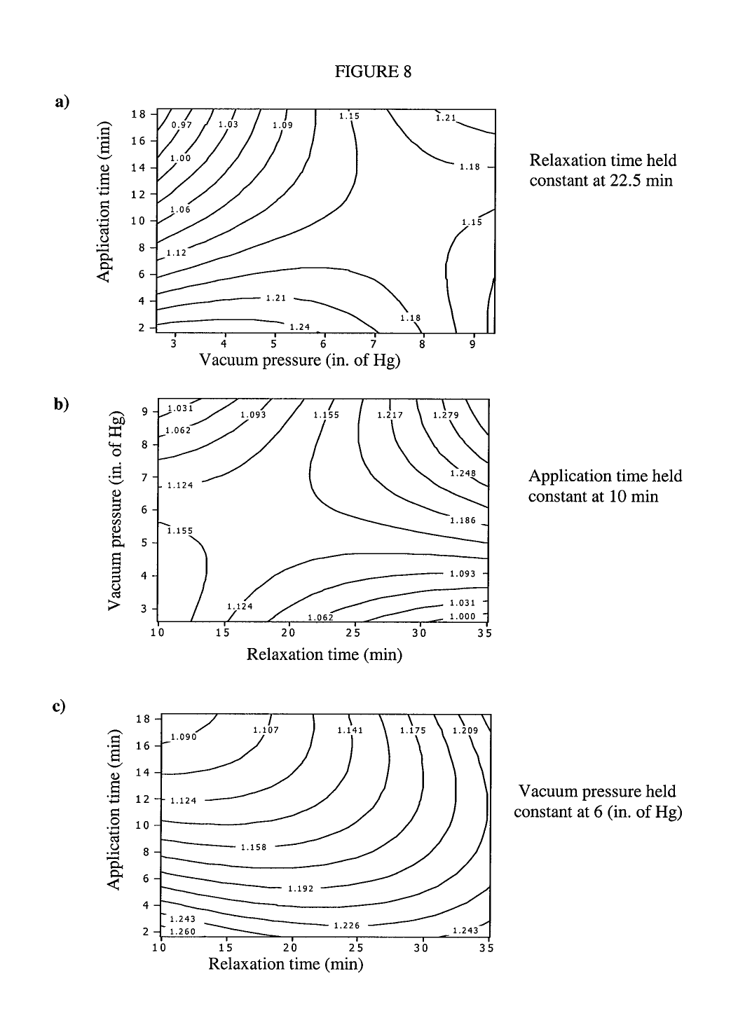

A higher value for linear distance corresponds to lesser crispiness in the snacks (Lefort et al., 2003). The stationary point in the Canonical analysis was observed to be a saddle point which can also be seen in the contour plots (Table 18; FIG. 8). The ridge analysis was done which showed that apple snacks with minimum values for linear distance (2.09) (at a coded radius 1.0) in Canonical analysis would be estimated at vacuum pressure vacuum pressure 6.24 in. of Hg, application time 2.19 min and relaxation time 17.95 min (Table 19). When relaxation time was held constant, the response values for linear distance would increase with the increasing level of application time and after reaching 12 min of relaxation time it would start decreasing again (FIG. 8a). In the given range of vacuum pressure, the linear distance value would decrease at the higher vacuum pressure level. When application time was held constant, linear distance values would decrease at the lower level of relaxation time and vacuum pressure under the given conditions (FIG. 8b). Similarly, under constant vacuum pressure (FIG. 8c) the linear distance values would be low at the lower level of relaxation time, but would increase with application time up to certain level and then decrease after 15 min of application time.

### Summary

The final optimal experimental parameters were obtained using the Canonical analysis, which allowed the compromise among various responses and searched for a combination of factor levels that jointly optimized a set of responses by satisfying the requirements for each response in the set. Under the given process conditions for vacuum pressure, application time, and relaxation time, it can be concluded from the Canonical analysis for the predicted values that the maximum response value at the coded radius 1.0 can be obtained when the variables are in the range: vacuum pressure 5.53-8.45 in. of Hg, application time: 1.78-15.74 min, and relaxation time: 12.63-33.68 min. In Canonical analysis, the average values of each variable were very close to the optimum levels of the three key variables selected in the present experimental set up (vacuum pressure: 6 in. of Hg, application time: 10 min, and relaxation time: 22.5 min). Also under these selected optimized conditions the experimental response values agreed with the values predicted by ridge analysis under same conditions (Table 20).

The examination of the contour plots helps in depicting the relationship among the different variables and in knowing the effect on the response value when changing the levels of the variables while keeping other one or two variable same. This approach is also helpful for designing further experiments and predicting the results by changing only two parameters while keeping the third parameter at a constant level. The advantage of obtaining saddle point is that it provides more flexibility and thus, all responses and other non-statistical parameters for future experiments can be centered around the saddle point. In addition, the same value for particular response can be obtained from different combination levels of parameters, thus overcoming any limitation of given processes.

### Example 5

### Sensory Evaluation of the Apple Snacks Prepared by Vacuum Impregnation Process

### Materials and Methods

### (a) Plant Material and Chemical Reagents

‘Empire’ cultivar was selected for this study as it is mainly produced in Nova Scotia. Apples were obtained from Sterling Fruit Market (the local fruit market in Truro, NS). Food grade calcium chloride (CaCl₂) was purchased from ACP Chemicals Inc., St. Leonard, QC. Table salt [sodium chloride (NaCl)] (Great Value) was obtained from a local market. Solution containing Welch's grape cocktail frozen concentrate diluted to concentration of 15±2° Brix was used for dipping the apple slices into solution. Vitamin E was obtained from Trophic Canada Ltd. ON, Canada. Whey protein (milk proteins) concentrate (Bulk Barn) were obtained from the local food market.

### (b) Sample Preparation

Apples were washed, wiped with paper towel, cut into 2.0-mm-thick slices perpendicular to the core using an apple slicer (Waring PRO™, Model: FS 150C, Torrington, Conn.). Three replicates were used for each treatment where a replicate consisted of six randomly selected slices from two apples. The apple snacks were prepared by three different processes:

(i) Control apple slices without any pretreatment: The apple slices after cutting were immediately put on the food grade plastic mesh and transferred to the vacuum dryer.

(ii) Apple slices given anti-browning treatment: The apple slices were given anti-browning treatment by dipping in a solution containing 1.6% CaCl₂ at room temperature for 9 min. The apple slices were dipped in solution with a fruit to solution ratio of 1:10 (w/v).

(iii) Apple slices given VI treatment: The apple slices were dipped in solution [with a fruit to solution ratio of 1:10 (w/v)] containing minerals [CaCl₂: 1.6% (v/v) and NaCl (table salt): 0.05% (v/v)], vitamin E (0.1% (v/v) of the solution used for each replicate) using fruit juice (Welch's grape cocktail frozen concentrate) as a base for dissolving minerals and vitamins. Whey protein concentrate (0.05% w/v of the solution used for each replicate) was used as an emulsifier for dissolving vitamin E into the fruit juice. The apple slices along with the solution were then immediately exposed to VI treatment. VI treatment was given at vacuum pressure: 6 in. of Hg, application time: 10 min (under vacuum pressure), and relaxation time: 22.30 min (under atmospheric pressure).

After giving the above treatments, drying was carried out in two stages: 1) first at low temperature (30° C. for 10 h) and 2) then at high temperature

(40° C. for 10 h). Immediately after drying, the vacuum impregnated dried apple slices were transferred to air tight plastic containers.

### (c) Assessment of Nutritional Quality of Apple Snacks

Prepared apple snacks were subjected to proximate analysis using methods of the AOAC (2000): moisture (Method 925.09), crude fat (Method 969.24), protein (Method 950.48), and ash (Method 923.03). Vitamin E analysis was done using methods of the AOAC (2000) (Method 971.30). Elemental composition was determined by an Inductive Coupled Plasma Atomic Emission Spectrometry (ICP-AES) using a previously reported method (Anderson, 1996).

### (d) Screening and Training of the Sensory Panel

Approval of the Research Ethics Board of NSAC was obtained before conducting the sensory evaluation study. Descriptive sensory testing methodology was used in which trained panelists described the textural, flavor, color and appearance attributes of the apple snacks. Under the descriptive test, an unstructured scaling method was used. The unstructured scale (Poste et al., 1991) consisted of a horizontal line 15 cm long with anchor points 1.5 cm from each end and a mid point. The subjects recorded each product score by making a vertical line across the horizontal line at the point that best reflected their perception of the magnitude of those characteristics. A screening session was conducted during which the potential panelists' ability to sense and measure textural and flavor characteristics was tested. Training on specific attributes (to be examined) was provided to the panelists in a focus group-like setting immediately before the sensory evaluation.

### (e) Descriptive Analysis of Apple Slices by a Trained Panel

The sealed containers of the prepared apple snacks were opened 2-5 min prior to the sensory evaluation in the Product Quality Evaluation Laboratory. The order of presentation was balanced so that each sample appeared in a given position an equal number of times. Also the presentation was random, which was done by using a compilation of random numbers (Meilgaard et al., 1991). This was done to avoid positional and expectation bias. The sensory panel was conducted in the Product Quality Evaluation Laboratory during the Spring Semester, 2008. Each panelist was asked to evaluate/describe dried snacks prepared with anti-browning treatment and after incorporation of minerals (CaCl₂ and NaCl), and vitamin E (VI treatment) and an untreated control. Panelists were provided with water and crackers at room temperature to cleanse the palate between samples if desired. To eliminate bias of visual observation with the evaluation of texture (crispiness, crunchiness) and flavor (sweetness, saltiness, and sourness), the first Questionnaire and one set of samples were given to the subjects under red light conditions. After panelists had completed the Questionnaire Number 1, they were provided with Questionnaire Number 2 and white light was used to evaluate color and appearance. The relative placement of the scores on the 15 cm line was measured with a ruler and recorded.

### (f) Experimental Design and Statistical Analysis

The design for the sensory responses was randomized blocks design (RBD) with panelist as the blocking factor and snacks as the factor of interest. The assumptions of normality of residuals were tested using the Anderson-Darling test. Assumptions of constant variance were tested by plotting residual versus fits scatter diagram (Montgomery, 2005). The data were analyzed using ANOVA methods, using the general linear model (GLM) procedure of the SAS Institute, Inc. (2003). Differences among means were tested by the Tukey's Studentized Range test at α=0.05. Pearson correlation coefficient (r) was used to indicate the relationships between parameters.

### Results and Discussion

### (a) Sensory Evaluation of Apple Snacks

The sensory evaluation was done for comparing the appearance, color, textural attributes in term of crispiness and crunchiness, flavor attributes in term of sweetness, saltiness and sourness, and overall acceptability of the apple snacks (Table 21). In addition to the panelist score, the ANOVA P-values are given to see the impact of the panelists on the sensory scores. All the three snack products were given similar scores for the appearance, color, saltiness, sourness attributes. While evaluating the textural attributes, panelists observed VI-treated snacks to have more crispiness (8.26) as compared to the apple snacks given anti-browning treatment (4.85). Similarly, crunchiness was higher in VI-treated apple snacks (6.43) when compared to apple snacks given anti-browning treatment (3.15). Both crispiness and crunchiness in the untreated apple snacks were comparable to VI-treated apple snacks and apple snacks with anti-browning treatment. The crispiness and crunchiness were observed to be highly and positively correlated with each other; the product higher in crispiness were also statistically higher in crunchiness (r=1.0, P=0.07). VI-treated apple slices and untreated apple slices were sweeter than apple slices given anti-browning treatment. Although bitterness was not one of the taste attributes that was examined purposely, some of the panelists reported that the apple slices given anti-browning treatment were bitter in taste. The overall acceptability scores were comparable for all the three type of snack products. The ANOVA P-values showed that the sensory panel scores for the different sensory attributes were not influenced by the panelists.

Although, calcium chloride added to both VI-treated apple slices and apple slices given anti-browning treatment, bitter taste in VI-treated apple slices was not voluntarily mentioned by panelists. The possible reason could be that concentration of free calcium ions would be less in VI-treated apple slices due to its binding with the other constituents of VI solution (whey protein concentrate).

While not wishing to be limited by theory, increased crispiness and crunchiness in the VI-treated apple slices may be related to the effect of the added ingredients (grape juice, CaCl₂, NaCl, vitamin E, and whey proteins) as well as the changes taking place in the tissue matrix during the process.

### (b) Nutritional Quality of Apple Snacks

The calcium concentration in VI-treated apple slices was 0.78% both for the VI-treated apple slices as well as apple slices given anti-browning treatment; added calcium chloride uptake occurred during both of these pretreatment processes (Table 22). Hence, this increase in calcium content in 100 g of apple snacks obtained from anti-browning and VI treatment was 780 mg of calcium which can help meeting 70% of the daily required calcium in the diet (RDI: 1100 mg) (Food and Drugs Act and Regulations, 2008). The concentration of vitamin E in the VI-treated apple snacks was 1.81 mg/g, thus 5 g of apple snacks would be sufficient to meet the daily requirements of vitamin E (10 mg) (Food and Drugs Act and Regulations, 2008). Increase in protein content in VI treated apple slices was 65% when compared to that of protein content of untreated apple slices which can be attributed to the addition of whey proteins.

These results indicated that VI process can be used as a successful tool for increasing the nutritional value of the food products. In a study by Xie and Zhao (2003), fortification of 200 g of fresh-cut apples using VI methods increased calcium and zinc concentrations equivalent to 15-20% and 40% of daily reference intake, respectively, as compared to fresh apple which provided about 0.84% and 2.30% of daily reference intake of calcium and zinc, respectively. In another study, fortification of fresh-cut apples with vitamin E, calcium, and zinc using VI, resulted in an increased vitamin E content (about 100-fold increase), calcium and zinc contents (about 20-fold increase) as compared to the unfortified apples (Park et al., 2005). Hence, these fortified apple snacks can be introduced as an alternative for delivering the required amount of dietary vitamins, minerals and other nutritionally significant compounds.

### Summary

Vacuum impregnation is an important tool of preparing nutritionally fortified apple slices. The sensory attributes in terms of the color, appearance, flavor and texture such as crispiness and crunchiness were improved by VI treatment. In the present study the VI-treated apple slices were scored significantly higher for crispiness and crunchiness as compared to the apple slices given just anti-browning treatment. There was no difference observed between the untreated apple slices and VI-treated apple slices for crunchiness and crispiness. The uptake of calcium and vitamin E in the fruit matrix that occurred during the VI application may help to prepare fortified foods to meet the daily requirement for calcium and vitamin E in the consumer' diet. Hence, the VI process can be utilized as a mode of introducing anti-browning agents such as calcium chloride, and improving the sensory attributes of the dried apple snacks and also to facilitate nutritional fortification of the apple slices with essential amino acids, minerals, vitamins and health promoting phenolic compounds, which would help meeting the daily dietary requirements of the consumers.

### Example 6

### Comparison of the Commercially Available Fried Snacks with the Developed Non-Fried Apple Snacks

### Materials and Methods

### (a) Plant Material and Chemical Reagents

‘Empire’ cultivar was selected for this study as it is mainly produced in Nova Scotia. Apples were obtained from Sterling Fruit Market (the local fruit market in Truro, NS). Food grade calcium chloride (CaCl₂) was purchased from ACP Chemicals Inc., St. Leonard, QC. Table salt [sodium chloride (NaCl)] (Great Value) was obtained from a local market. For dipping the apple slices into solution, commercially available maple syrup (Acadian Maple Syrup, Upper Tantallon, NS, CA) was used.

### (b) Effect of the Maple Syrup Concentration as a Formulation Ingredient of VI Solution

Apples were washed, wiped with paper towel, cut into 2.0-mm-thick slices perpendicular to the core using an apple slicer (Waring PRO™, Model: FS 150C, Torrington, Conn.). Three replicates were used for each treatment where a replicate consisted of six randomly selected slices from two apples. The apple slices were dipped in solution [with a fruit to solution ratio 1:10 (w/v)] containing minerals (CaCl₂ and NaCl (table salt)), using four different concentration of maple syrup: 0%, 20, 30, 40 and 50% (v/v). Additional experiment was also carried out using higher concentrations of maple syrup [60 and 100% (v/v)]. The apple slices along with the solution were then immediately exposed to VI treatment. The conditions of VI treatment were: vacuum pressure −6 in. of Hg, application time −10 min (under vacuum pressure), and relaxation time 22.30 min (under atmospheric pressure).

After giving the above treatments, drying was carried out in two stages: 1) first at low temperature (30° C. for 10 h) and 2) then at high temperature (40° C. for 10 h). Immediately after drying, the vacuum impregnated dried apple slices were transferred to air tight plastic containers.

(i) Textural Characteristics

Texture analysis of apple slices prepared using different concentration of maple syrup was done using the punch method in which the apple slices were halved and placed across the bridge of metal support. The ball probe was set to move vertically on the horizontal and flat surface of the chip and result in the breaking of the chip into two pieces (Shyu and Hwang, 2001).

(ii) Color (WI)

WI of dried apple slices were determined as described in Example 2.

(iii) Moisture Content, Water Activity and Hygroscopic Characteristics

The moisture contents of the snacks were determined as described in Example 2. The water activity was measured using a water activity meter (Novasina, Model: ms1 Set aw, Geneq Inc. Quebec, Calif.).

To investigate the hygroscopic characteristics, the apple snacks were kept in the room under open atmospheric conditions at room temperature for a period of 3 h. Moisture content and water activity readings were determined in the apple slices taken immediately out of the dryer and the apple slices kept at room temperature for 3 h and gain in % moisture content and water activity was obtained.

### (c) Evaluating the Consumer Acceptability of Snack Products

Consumer acceptability testing was done to measure the subjective attitudes towards snacks based on its sensory characteristics. These affective tests help to know the market potential of the newly developed product. Recruitment of 77 panelists was done from the NSAC campus. Before conducting the sensory evaluation by panelists, guidelines and instructions for performing the sensory evaluation were provided to the panelists in the Consent form. The untrained panelists were asked to examine nutritionally fortified apple snacks and commercially available apple snacks and potato snacks. The level of consumer acceptance was assessed by asking the consumers to rate how much they like a product for its sensory characteristics (appearance, flavor, texture and overall acceptability) using a nine-point hedonic scale and give a score to the product on a scale of 1 (dislike extremely) to 9 (like extremely). The attributes evaluated were appearance, flavor, texture and overall acceptability. For each one of these attributes, the average panelist response was determined.

### (d) Assessment of Nutritional Quality of Snacks

All of the three different types of the snacks including non-fried apple snacks, and commercially available fried apple and potato snacks were subjected to proximate analysis using methods as described in Example 5.

### (e) Estimation of Total Phenolic Content and Antioxidant Capacity

The three different types of the snack samples were analyzed for total phenolic (Folin-Ciocalteu) content and antioxidant capacity using FRAP

(Ferric Reducing Ability of Plasma) assay as described in Example 1.

### (f) Experimental Design and Statistical Analysis

The design for the sensory responses was randomized blocks design (RBD) with panelist as the blocking factor and snacks as the factor of interest. For all other responses, a completely randomized design (CRD) was selected. For all responses, the assumptions of normality of residuals were tested using the Anderson-Darling test. Assumptions of constant variance were tested by plotting residual versus fits scatter diagram (Montgomery, 2005). The data were analyzed using ANOVA methods, using the general linear model (GLM) procedure of the SAS Institute, Inc. (2003). Differences among means were tested by the Tukey's Studentized Range test at α=0.05. Pearson correlation coefficient (r) was used to indicate the relationships between parameters.

### Results and Discussion

(a) Effect of Incorporation of Maple Syrup in VI Solution on the Quality Attributes of Dehydrated Apple Snacks

Two separate experiments were performed to study the influence of maple syrup concentration on the quality (the textural and color) of the VI-treated dried apple slices (Table 23 and 24).

(i) Textural Characteristics

All the textural attributes measured by instrumental texture analyzer including area, force, gradient and distance were influenced by the addition of the maple syrup (Table 23 and 24). Maximum force required to break the dried apple slices was observed to be significantly higher for apple slices given VI treatment with solution containing 30 to 50% of maple syrup solution. There was no difference in the values for maximum force for untreated apple slices and apple slices treated with 20% of the maple syrup solution. Texture, as measured by deformation curve area, showed an optimum corresponding to approximately 40% maple syrup. This means that greater amount of work was required to break the untreated apple slices and apple slices treated with 50% concentration of maple syrup. The apple slices with 50% maple syrup were observed to be hard and elastic. The linear distance was smaller for apple slices containing maple syrup; however there was no effect on the linear distance for the different concentrations of maple syrup. The value of gradient increased with increasing concentration of the maple syrup up to 40% and after that the gradient value started to decrease.

These results were further confirmed by the second experiment which was done at higher concentration of maple syrup. It can be seen that apple slices given VI treatment with 30% maple syrup concentration in solution resulted in better texture (significantly higher value for gradient; and lower value for area and distance) as compared to apple slices dipped in 60 and 100% level of maple syrup. The apple slices dipped in 60 and 100% of maple syrup solution resulted in greater amount of work and force, also these apple slices were observed to be very hard, leathery and elastic.

Hence, the use of VI solution with 30 to 40% level of maple syrup was considered to obtain the best textural attributes in the dried apple slices.

(iii) Color (WI)

WI was greatly influenced by the addition of the maple syrup (Table 23 and 24). As the color of the maple syrup was dark brown which imparted brown color to the apple slices. WI was observed to be highest for the untreated apple slices and it showed a decreasing trend with the increasing concentration of the maple syrup (50%). Similar results were obtained for WI of the apple slices using higher concentration of maple syrup (30 to 100%), however, the apples slice with 60 and 100% maple syrup showed no difference in WI.

(iii) Moisture Content (MC), Water Activity (a_{w}) and Hygroscopic Characteristics

The percent moisture content and water activity of the apple slices treated with different levels of the maple syrup are given in Table 23 and 24. The percent moisture content was observed to be least in the apple slices prepared with 20, 30 and 40% of the maple syrup and further increasing the maple syrup concentration (50%) resulted in increased moisture content in the apple slices (Table 23). These results were further confirmed by the second experiment done at higher maple syrup concentration (30 to 100%) (Table 24). Apple slices with 60 and 100% maple syrup had higher percent moisture content than apple slices containing 30% maple syrup. Water activity was also found to be influenced by the maple syrup but only at higher concentration of syrup (60 and 100%) in the VI solution.

Further studies were carried to see the impact on the hygroscopic characteristics of the treated apples slices from the gain in percent moisture and water activity (Table 25). It can be clearly seen that with the increasing concentration of the maple syrup the moisture gain was less in the apple slices. Apple slices with 30-50% maple syrup resulted in significantly lesser moisture gain as compared to untreated and apple slices with 20% maple syrup.

The amount of the moisture content and water activity greatly influences the quality attributes and shelf life of the dried food products. The addition of the maple syrup at the lower concentration (up to 40%) resulted in decreasing the percent moisture content. By manipulating the concentration of the maple syrup, the drying process and hygroscopic characteristics of dried apple slices can be manipulated.

(b) 9.4.2 Comparison of Non-fried Apple Snacks with Commercially Available Fried Snacks

Sensory evaluation studies were carried out to compare the consumer acceptance of newly developed apple snacks with similar products available in the market. For this purpose an affective sensory test method was done by recruiting a large number of untrained panelists (n=77) (Meilgaard et al., 1991). These snack products were also evaluated for nutritional quality, bioactive compounds and antioxidant capacity.

(i) Consumer Acceptability of Snack Products

The panelists rated the three different types of snacks on the coded form including: newly developed non-fried apple snacks; commercially available fried apple snacks; and potato snacks. The panelists evaluated these samples using a nine-point hedonic scale for appearance, flavor, texture and overall acceptability (Table 26). All the three products received acceptable scores for appearance, flavor, texture, and overall acceptability. Non-fried apple snacks received significantly higher score for appearance as compared to fried potato and apple snacks (Table 27). The mean score for flavor were observed to be significantly higher for commercial fried apple snacks and potato snacks as compared to non-fried apple snacks. Similarly, mean panelists scores for texture were observed to be significantly higher for the commercial snack products when compared to the non-fried apple snacks. However, instrumental analysis did not show any difference in the crispiness of the snacks which were measured in terms of major number of peaks and linear distance using the bulk compression method. The overall panelist acceptability was higher for the commercially fried snacks as compared to the non-fried apple snacks. Both the commercial fried potato and apple snacks received similar scores for overall acceptability. It can be observed that the sensory evaluation scores for flavor and overall acceptability were influenced by the panelists (the ANOVA P-values given in Table 26).

The terms that consumers associated with the appearance were that non-fried snack seemed to be fresh, healthy, natural and fried apple snacks were brown and oily. Thus, commercially fried apple snacks were observed to be less appealing as compared to that of non-fried apple snacks and fried potato snacks. However, the flavor scores were high for fried snacks. The possible reasons for the higher flavor ratings of the commercial snacks could be the production of low molecular weight compounds such as aldehydes, lactones and pyrazins during frying in oil (Perkins, 1992). In addition, the absorbed oil from frying also contributes to the overall flavor profile of the fried snacks (Agriculture and Agri-food Canada, 2007). The lower rating of non-fried apple snacks for flavor could be due to the bitter taste of calcium chloride (as described in Example 4). The addition of maple syrup would help to overcome this bitter taste but some of the panelists were able to feel the bitter taste of calcium chloride. This could due to the variations among individuals perception of the taste (Neyraud and Dransfield, 2004). High texture scores for fried snacks can be attributed to the textural changes which occurred during frying of the apple and potato snacks. Shyu and Hwang (2001), observed that during vacuum frying of apple slices, the moisture content and breaking force of apple fried apple slices decreased with increasing frying temperature and time while the oil content of fried apple slices increased. Thus desired crispiness was achieved at vacuum frying temperature of 100-110° C. and vacuum frying time of 20-25 min. Shyu et al. (2005) observed that when frying of apple slices was done at a very high temperature, immediate removal of water and filling that space with oil took place and the snacks with higher oil content (22.5%) were observed to have lower amount of final moisture content (0.4%) and these were crispier than other snacks which were high in moisture content and where frying has been done at lower temperature (Shyu et al., 2005). This is further confirmed from the moisture content, water activity and oil content of the non-fried apple snacks and commercial snack products of these snack products as shown in Table 28.

The overall acceptability observed to be greatly influenced by the flavor and texture attributes of the snacks then compared to the appearance. This can be seen from the strong positive correlation obtained between the flavor and overall acceptability (r=0.796, p=0.00) and the correlation coefficient for texture and overall acceptability (r=0.73, p=0.00). Similar results were noted by Meullenet et al. (2003) in a study of modeling preference of commercial toasted white corn tortilla chips, where overall acceptability of the tortilla chips offered to the consumers were influenced by the flavor of these products.

(ii) Nutritional Quality and Bioactive Compounds in Snack Products

The calcium concentration in non-fried apple snacks was 0.56% as compared to 0.04% in fried apple snacks (Table 28). This increase in calcium content can be attributed to the added calcium chloride uptake which occurred during the VI pretreatment. The differences in the other compositional attributes crude protein and ash content can be attributed to the difference in the source and cultivar used for preparing fried and non-fried apple snacks (Table 28). However, the amount of oil content was observed to be significantly higher in both commercial fried snacks products as compared to non-fried apple snacks and fried potato snacks contained more oil than fried apple snacks. Generally, apple contains traces of lipid content (Health Canada, 2008) and ‘Empire’ apple cultivar as such reported to have 0.9% of lipid content (as reported in Chapter 7.2). Similarly, a raw peeled potato naturally contains only traces of lipid content (Health Canada, 2008). Thus, the higher oil content in the fried apple and potato snacks is the amount of oil gained during the frying process, as both apple and potato without any processing contain very low amount of oil. In addition to the higher amount of oil content in fried snacks, the antioxidant capacity measured in terms of FRAP was observed to be significantly lower in fried apple and potato snacks (Table 29). Non-fried apple snacks showed approximately 20 times higher antioxidant capacity as compared to fried potato snacks. The total phenolic content were also significantly lower for fried potato snacks, however, there was no difference in the total phenolic content when non-fried apple snacks were compared with fried apple snacks. Thus, the application of thermal treatments like frying can significantly impact the bioactive compounds and the associated health beneficial properties (antioxidant capacity) of the snacks.

### Summary

The present study was carried out to enhance the quality attributes, including nutritional and sensory characteristics, of the non-fried apple snacks to make these comparable to the fried apple and potato snack products currently available in the market. VI solution containing 30 to 40% level of maple syrup resulted in the best textural attributes, WI and reduced moisture content and water activity in the dried apple slices. In conclusion, there is a potential and acceptability of the non-fried apple snacks in the market. Since the present study was carried out without disclosing the panelists the method of processing (non-fried vs fried), revealing to the consumer about the nature and healthiness of the snacks is expected to influence the choice of selecting the non-fried snack over the fried snack. Therefore, increasing demand and the market potential of the non-fried and healthy apple snacks can be expected.

While the present disclosure has been described with reference to what are presently considered to be the preferred examples, it is to be understood that the disclosure is not limited to the disclosed examples. To the contrary, the disclosure is intended to cover various modifications and equivalent arrangements included within the spirit and scope of the appended claims.

TABLE 1
Whiteness Index (WI)^{z} of five apple genotypes

| | | 2 h after slicing | Immediately after |
|---|---|---|---|
| | Immediately | at ambient | vacuum drying |
| Cultivar | after slicing | temperature | at 50° C. for 24 h |
| ‘Empire’ | 75.05 ± 1.36b | 62.05 ± 1.23d | 62.4 ± 1.49d |
| ‘Cortland’ | 78.81 ± 1.14a | 72.17 ± 1.73b | 74.3 ± 1.65b |
| ‘SuperMac’ | 71.63 ± 0.92c | 68.27 ± 1.44c | 68.0 ± 0.95c |
| ‘SJCA16’ | 73.12 ± 0.72c | 67.54 ± 1.86c | 72.5 ± 1.61b |
| ‘Eden ™’ | 76.69 ± 1.23b | 75.26 ± 1.59a | 77.1 ± 2.31a |

WI was calculated using the values of ‘L’ (lightness), ‘a’ (green chromaticity), and ‘b’ (yellow chromaticity); WI = 100 − [(100 − L)² + a² + b²]^{1/2}
^{z}Means ± standard deviation (n = 6).
a-d Means followed by the same letter within each column are not significantly different [Tukey's Studentized Range test, (P < 0.05)].

TABLE 2
Polyphenoloxidase (PPO) activity of five apple genotypes

| Cultivar | Enzyme activity (unit/g FW)^{z} |
|---|---|
| ‘Empire’ | 15.94 ± 4.18a |
| ‘Cortland’ | 3.74 ± 0.92c |
| ‘SuperMac’ | 8.24 ± 1.89bc |
| ‘SJCA16’ | 6.03 ± 1.69bc |
| ‘Eden ™’ | 11.21 ± 2.31ab |

^{z}Means ± standard deviation (n = 3).
a-cMeans followed by the same letter are not significantly different [Tukey's Studentized Range test, (P < 0.05)].

TABLE 3
Total phenolic content and antioxidant capacity of five apple
genotypes^{z}

| | Total phenolic | | |
|---|---|---|---|
| | content | FRAP^{x} | ORAC^{w} |
| | (mmol GAE^{y}/100 g | (mmol TE^{u}/100 g | (mmol TE/100 g |
| Cultivar | DM) | DM) | DM) |
| ‘Empire’ | 0.035 ± 0.003a | 1.59 ± 0.29b | 18.89 ± 3.07ab |
| ‘Cortland’ | 0.034 ± 0.004a | 2.38 ± 0.36a | 22.24 ± 2.73a |
| ‘SuperMac’ | 0.034 ± 0.004a | 1.87 ± 0.15ab | 23.89 ± 2.10a |
| ‘SJCA16’ | 0.020 ± 0.001b | 0.59 ± 0.25c | 14.35 ± 2.33bc |
| ‘Eden ™’ | 0.016 ± 0.001b | 0.53 ± 0.11c | 7.85 ± 1.54c |

^{z}Means ± standard deviation (n = 3).
^{y}GAE = Gallic acid equivalents
^{x}Ferric reducing antioxidant power
^{w}Oxygen radical absorbance capacity
^{u}TE = Trolox equivalents
a-cMeans followed by the same letter within each column are not significantly different [Tukey's Studentized Range test (P < 0.05)].

TABLE 4
Concentration of the major phenolic compounds in five apple genotypes^{z}

| Phenolic | | | | | |
|---|---|---|---|---|---|
| compounds | | | | | |
| (mg/100 g | Apple genotypes | | | | |
| DM) | ‘Empire’ | ‘Cortland’ | ‘SuperMac’ | ‘SJCA16’ | ‘Eden ™’ |
| Catechin^{y} | 6.3 ± 2.3a | 7.9 ± 0.6a | 5.1 ± 0.6a | 2.5 ± 0.1b | <0.001 |
| Epicatechin | 23.0 ± 7.1b | 32.2 ± 1.8ab | 23.2 ± 2.0b | 35.0 ± 3.1a | 3.1 ± 2.8c |
| Chlorogenic | 101.2 ± 10.8a | 62.7 ± 12.3b | 41.0 ± 11.6b | 70.8 ± 19.3ab | 43.8 ± 7.9b |
| acid | | | | | |
| Cyanidin-3- | 18.1 ± 8.5a | 18.9 ± 12.8a | 3.9 ± 2.2b | 0.2 ± 0.2c | 19.4 ± 0.1a |
| O- | | | | | |
| galactoside^{x} | | | | | |
| Phloridzin^{w} | 36.5 ± 16.6 | 14.8 ± 11.6 | 23.8 ± 10.5 | 25.6 ± 19.2 | 31.3 ± 11.9 |
| Quercitin-3- | 7.9 ± 5.3 | 7.4 ± 5.1 | 7.8 ± 6.6 | 7.6 ± 5.4 | 13.0 ± 0.7 |
| O- | | | | | |
| galactoside | | | | | |
| Quercitin-3- | 2.8 ± 1.6 | 5.7 ± 1.6 | 4.6 ± 3.4 | 1.6 ± 0.5 | 6.2 ± 0.3 |
| O-glucoside | | | | | |
| Quercitin-3- | 1.8 ± 0.5c | 2.5 ± 0.3bc | 5.1 ± 1.5ab | 3.2 ± 0.9abc | 5.6 ± 0.9a |
| O- | | | | | |
| rhamnoside | | | | | |

^{z}Means ± standard deviation (n = 3).
^{y}Catechin content was transformed (inverse square) before analysis. Untransformed values are shown.
^{x}Cyanidin-3-O-galactoside content was transformed (inverse square root) before analysis. Untransformed values are shown.
^{w}Phloridzin content was transformed (log) before analysis. Untransformed values are shown.
a-c Means followed by the same letter within each row are not significantly different [Tukey's Studentized Range test (P < 0.05)].

TABLE 5
Vitamin C concentration in five apple genotypes

| Cultivar | Vitamin C (mg/100 g DM)^{z} |
|---|---|
| ‘Empire’ | 15.62 ± 1.10b |
| ‘Cortland’ | 49.23 ± 7.29a |
| ‘SuperMac’ | 20.68 ± 4.22b |
| ‘SJCA16’ | 37.71 ± 9.52a |
| ‘Eden ™’ | 40.92 ± 2.44a |

^{z}Means ± standard deviation (n = 3).
a-cMeans followed by the same letter are not significantly different [Tukey's Studentized Range test (P < 0.05)].

TABLE 6
Elemental concentration in five apple genotypes and their relationship with WI and PPO activity

| | | | | | | Correlation coefficient | |
|---|---|---|---|---|---|---|---|
| Element | Apple genotypes^{z} | | | | | (P value) | |
| (mg/100 g DM) | ‘Empire’ | ‘Cortland’ | ‘SuperMac’ | ‘SJCA16’ | ‘Eden ™’ | WI^{w} | PPO activity |
| Calcium | 38.6 ± 5.1b | 29.6 ± 7.4b | 42.1 ± 7.7b | 41.2 ± 3.1b | 57.3 ± 2.2a | 0.35 (0.56) | 0.45 (0.45) |
| Phosphorus | 56.7 ± 5.8 | 56.7 ± 5.8 | 73.3 ± 5.8 | 60.0 ± 17.3 | 60.0 ± 10.0 | −0.13 (0.83) | −0.08 (0.90) |
| Sodium | 5.3 ± 1.1ab | 6.4 ± 0.7a | 4.2 ± 0.2bc | 4.3 ± 0.9bc | 3.0 ± 0.2c | −0.30 (0.62) | −0.35 (0.57) |
| Potassium | 800.0 ± 72.1a | 623.0 ± 45.1b | 776.0 ± 45.1a | 793.0 ± 61.1a | 740.0 ± 37.6ab | −0.55 (0.34) | 0.66 (0.22) |
| Magnesium | 33.3 ± 0.3ab | 28.7 ± 2.7ab | 37.9 ± 2.2a | 33.7 ± 4.4ab | 32.6 ± 2.8ab | −0.43 (0.47) | 0.35 (0.57) |
| Manganese^{y} | 0.4 ± 0.1a | 0.4 ± 0.3a | 0.2 ± 0.0b | 0.4 ± 0.1a | 0.3 ± 0.0ab | 0.01 (0.99) | −0.18 (0.77) |
| Copper | 0.3 ± 0.1a | 0.2 ± 0.0b | 0.2 ± 0.0b | 0.2 ± 0.1ab | 0.3 ± 0.0a | −0.15 (0.82) | 0.85 (0.07) |
| Zinc | 1.1 ± 0.3 | 1.0 ± 0.2 | 1.3 ± 0.6 | 1.0 ± 0.6 | 0.3 ± 0.0 | −0.73 (0.17) | −0.12 (0.84) |
| Iron^{x} | 0.9 ± 0.1ab | 0.7 ± 0.1b | 1.2 ± 0.3a | 0.9 ± 0.0ab | 1.1 ± 0.0ab | −0.40 (0.51) | 0.68 (0.21) |

^{z}Means ± standard deviation (n = 3).
a-c Means followed by the same letter within each row are not significantly different [Tukey's Studentized Range test (P < 0.05)].
^{y}Manganese content was transformed (inverse square) before analysis. Untransformed values are shown in the Table.
^{x}Iron content was transformed (reciprocal) before analysis. Untransformed values are shown in the Table.
^{w}WI used for the correlation analysis were obtained from dried apple slices.

TABLE 7
Effect of different LTLT conditions on the WI^{z} of fresh-cut
‘Empire’ apples

| Temperature | Dipping time (min) | | |
|---|---|---|---|
| (° C.) | 5 | 10 | 15 |
| 65° C. | 51.10 ± 0.16cd | 48.35 ± 0.93d | 51.64 ± 1.77bcd |
| 70° C. | 54.17 ± 1.17abcd | 56.89 ± 0.77abc | 56.87 ± 1.85abc |
| 75° C. | 57.49 ± 1.68ab | 60.20 ± 0.80a | 58.67 ± 1.43a |

^{z}Means ± standard deviation (n = 3).
a-dMeans of all temperature X dipping time combinations followed by the same letter are not significantly different [Tukey's Studentized Range test (P < 0.05)].

TABLE 8
Effect of different HTST conditions on the WI^{z} of fresh-cut
‘Empire’ apples

| | Dipping time (s) | | |
|---|---|---|---|
| Temperature (° C.) | 10 | 20 | 30 |
| 85° C. | 61.30 ± 0.79a | 51.12 ± 0.50cd | 49.30 ± 2.58d |
| 90° C. | 60.61 ± 1.21ab | 57.68 ± 1.01ab | 55.25 ± 0.96bc |
| 95° C. | 58.34 ± 0.94ab | 51.18 ± 0.81cd | 50.30 ± 0.25cd |

^{z}Means ± standard deviation (n = 3).
a-dMeans of all temperature X dipping time combinations followed by the same letter are not significantly different [Tukey's Studentized Range test (P < 0.05)].

TABLE 9
Effect of CaCl₂ dipping conditions on the WI^{z} of fresh-cut
‘Empire’ apples

| Conc. of CaCl₂ | | | |
|---|---|---|---|
| solution | Dipping time (min) | | |
| (w/v) % | 1 | 5 | 10 |
| 0.0 | 76.51 ± 1.37bc | 73.42 ± 2.65c | 72.32 ± 2.77c |
| 1.0 | 80.10 ± 0.86ab | 80.49 ± 0.78ab | 82.15 ± 1.16a |
| 2.0 | 81.05 ± 0.45ab | 81.37 ± 1.78a | 83.12 ± 1.29a |

^{z}Means ± standard deviation (n = 3).
a-cMeans followed by the same letter are not significantly different [Tukey's Studentized Range test (P < 0.05)].

TABLE 10
WI^{z} of apple slices under selected anti-browning treatments

| Anti-browning | Immediately after | 2 h after | 4 h after |
|---|---|---|---|
| treatment | treatment | treatment | treatment |
| CaCl₂ dipping | 71.63 ± 0.90a | 71.66 ± 0.48a | 70.23 ± 0.63a |
| Control | 68.27 ± 0.47b | 64.58 ± 0.81b | 63.84 ± 0.08b |
| LTLT | 59.06 ± 0.79d | 60.05 ± 1.75c | 59.38 ± 2.86b |
| HTST | 62.76 ± 0.86c | 61.73 ± 2.21bc | 60.94 ± 2.86b |
| Commercial | 70.96 ± 1.45ab | 70.33 ± 1.89a | 70.10 ± 1.44a |

^{z}Means ± standard deviation (n = 3).
a-dMeans followed by the same letter within each column are not significantly different [Tukey's Studentized Range test (P < 0.05)].

TABLE 11
Comparison of WI and textural attributes of dried apple slices of ‘Empire’ cultivar

| | | | Maximum force | Linear distance | Gradient |
|---|---|---|---|---|---|
| Drying conditions^{z} | WI | Area (kg · s) | (kg) | (kg · s) | (kg/s) |
| Vacuum-dried (30 ± 2° C.; 15 h) | 71.64 ± 1.63a | 0.55 ± 0.06b | 0.59 ± 0.04b | 2.21 ± 0.17b | 0.30 ± 0.03b |
| Air-dried (60 ± 2° C.; 0.8 m/s; 7 h) | 69.45 ± 2.59a | 0.39 ± 0.05b | 0.79 ± 0.10b | 1.33 ± 0.02c | 0.65 ± 0.09ab |
| Oven-dried (70 ± 2° C.; 8 h) | 64.38 ± 0.54b | 0.83 ± 0.09a | 1.11 ± 0.15a | 2.57 ± 0.13a | 0.70 ± 0.22a |

^{z}Means ± standard deviation (n = 3).
a-c Means followed by the same letter within each row are not significantly different [Tukey's Studentized Range test (P < 0.05)].

TABLE 12
Concentration of phenolic compounds in fresh and dried apple slices of ‘Empire’ cultivar

| Phenolic compounds | | Vacuum-dried | Oven-dried | Air-dried (60 ± 2° C.; |
|---|---|---|---|---|
| (mg/100 g DM)^{z} | Fresh | (30 ± 2° C.; 15 h) | (70 ± 2° C. 8 h) | 0.8 m/s; 7 h) |
| Catechin | 0.30 ± 0.02a | 0.27 ± 0.02ab | 0.26 ± 0.01b | 0.29 ± 0.01a |
| Epicatechin | 6.09 ± 6.09a | 4.71 ± 0.92ab | 3.11 ± 0.25b | 4.50 ± 1.84ab |
| Chlorogenic acid | 191.86 ± 6.95a | 153.04 ± 3.71b | 138.84 ± 7.25b | 136.81 ± 29.31b |
| Cyanidin-3-O-galactoside | 4.86 ± 0.79a | 3.86 ± 0.43ab | 2.97 ± 0.43b | 2.88 ± 1.18b |
| Phloridzin | 46.88 ± 5.57 | 47.23 ± 4.94 | 35.44 ± 3.86 | 43.02 ± 13.44 |
| Phloretin | 0.23 ± 0.00b | 0.24 ± 0.01b | 0.32 ± 0.01a | 0.32 ± 0.02a |
| Quercetin-3-O-rutinoside | 1.37 ± 1.39b | 4.55 ± 2.28a | 1.71 ± 0.19b | 1.84 ± 0.51b |
| Quercitin-3-O-galactoside | 10.88 ± 3.64b | 23.82 ± 6.23a | 10.49 ± 1.68b | 9.58 ± 2.95b |
| Quercitin-3-O-glucoside | 5.56 ± 2.61b | 11.57 ± 3.28a | 5.93 ± 0.22b | 5.44 ± 1.40b |
| Quercitin-3-O-rhamnoside | 8.41 ± 2.21 | 11.66 ± 1.60 | 9.21 ± 0.45 | 8.25 ± 1.79 |

^{z} Means ± standard deviation (n = 3).
a-cMeans followed by the same letter within each row are not significantly different [Tukey's Studentized Range test (P < 0.05)].

TABLE 13
Vitamin C concentration in ‘Empire’ apple slices

| Drying method | (mg/100 g DM)^{z} |
|---|---|
| Fresh | 83.17 ± 9.43a |
| Vacuum-dried (30 ± 2° C.; 15 h) | 65.87 ± 1.05bc |
| Oven-dried (70 ± 2° C.; 8 h) | 57.40 ± 4.15c |
| Air-dried (60 ± 2° C.; 0.8 m/s; 7 h) | 77.39 ± 6.65ab |

^{z}Means ± standard deviation (n = 3).
a-cMeans followed by the same letter within each row are not significantly different [Tukey's Studentized Range test (P < 0.05)].

TABLE 14
Total phenolic content and total antioxidant capacity of
‘Empire’ apple slices^{z}

| | Total phenolic | | |
|---|---|---|---|
| | content | FRAP^{x} | ORAC^{w} |
| | (μmol GAE^{y}/ | (mmol TE^{u}/ | (mmol TE/ |
| Drying method | 100 g DM) | 100 g DM) | 100 g DM) |
| Fresh | 17.55 ± 1.13 | 0.99 ± 0.09 | 9.94 ± 0.37 |
| Vacuum-dried | 19.07 ± 0.33 | 1.00 ± 0.07 | 11.02 ± 0.72 |
| (30 ± 2° C.; 15 h) | | | |
| Oven-dried | 17.98 ± 1.22 | 1.00 ± 0.08 | 9.09 ± 1.64 |
| (70 ± 2° C.; 8 h) | | | |
| Air-dried | 17.96 ± 4.98 | 0.92 ± 0.39 | 6.91 ± 3.08 |
| (60 ± 2° C.; 0.8 m/s; 7 h) | | | |

^{z}Means ± standard deviation (n = 3).
^{y}GAE = Gallic acid equivalents
^{x}Ferric reducing antioxidant power
^{w}Oxygen radical absorbance capacity
^{u}TE = Trolox equivalents

TABLE 15
The VI process parameters commonly used for dipping of fruits

| Final product | Impregnating | | | | |
|---|---|---|---|---|---|
| type | solution | VP | AT | RT | Reference |
| Fresh-cut | Honey (10%) | 3 | 15 | 30 | Jeon and Zhao, |
| fruits | | | | | 2005 |
| Apple slices | Apple juice | 2 | 15 | 15 | Salvatori et al., |
| | | | | | 1998 |
| Apple slices | Sucrose solution | 5 | 5 | — | Barat et al., |
| | (0.25-0.65 w/w) | | | | 2001 |
| Eggplant and | Isotonic sucrose | 2 | 15 | 15 | Fito et al., |
| oranges | solution | | | | 2001b |
| Apple slices | Isotonic sucrose | 2 | 10 | 20 | Martinez- |
| | solution | | | | Monzo et al., |
| | | | | | 2000 |
| Nutritionally | High fructose | 2 | 15 | 30 | Mujica-Paz et |
| fortified fresh- | corn syrup (20 or | | | | al., 2003b |
| cut apple | 50% w/w) | | | | |

VP, vacuum pressure (in. of Hg);
AT, application time (min);
RT, relaxation time (min)

TABLE 16
The VI process variables and their levels in central composite design

| | Levels | | | | |
|---|---|---|---|---|---|
| Coded value | −1.68 | −1 | 0 | +1 | +1.68 |
| Uncoded | | | | | |
| variables | | | | | |
| VP | 2.6 | 4 | 6 | 8 | 9.4 |
| AT | 1.6 | 5 | 10 | 15 | 18.4 |
| RT | 9.9 | 15 | 22.5 | 30 | 35.1 |

VP, vacuum pressure (in. of Hg);
AT, application time (min);
RT, relaxation time (min)

TABLE 17
Response values for given levels of variables (vacuum pressure, application time and relaxation time)
in RSM

| | | | | | | | Response values | | | | | | |
|---|---|---|---|---|---|---|---|---|---|---|---|---|---|
| | | | | Uncoded | | | | | | | Max. | | Linear |
| | | | | variables | | | | | % | | force | Gradient^{z} | distance |
| Run | Coded variables | | | VP | AT | RT | RG | ‘a’ | MC | a_{w} | (kg) | (kg/s) | (kg · s) |
| 1 | 1.68 | 0 | 0 | 9.4 | 10.0 | 22.5 | 28.10 | 30.08 | 2.82 | 0.11 | 1.18 | 0.81 | 2.31 |
| 2 | 0 | −1.68 | 1 | 6.0 | 1.6 | 30.0 | 24.75 | 28.47 | 2.60 | 0.10 | 1.19 | 0.76 | 2.47 |
| 3 | −1 | 1 | 1 | 4.0 | 15.0 | 30.0 | 25.61 | 29.93 | 2.65 | 0.11 | 1.14 | 0.82 | 2.33 |
| 4 | −1.68 | −1.68 | 1 | 2.6 | 1.6 | 30.0 | 26.20 | m.v. | 3.03 | 0.11 | 1.23 | 0.64 | 2.83 |
| 5, 6, 7, | 0 | 0 | 0 | 6.0 | 10.0 | 22.5 | 24.16 | 29.63 | 2.89 | 0.10 | 1.16 | 0.64 | 2.66 |
| 8, 9, 10 | | | | | | | | | | | | | |
| 11 | 1 | 1 | −1 | 8.0 | 15.0 | 15.0 | 25.79 | 29.26 | 2.79 | 0.11 | 1.12 | 0.63 | 2.65 |
| 12 | −1 | −1 | −1 | 4.0 | 5.0 | 15.0 | 28.15 | 29.01 | 3.14 | 0.11 | 1.44 | 1.23 | 2.08 |
| 13 | −1 | 1 | −1 | 4.0 | 15.0 | 15.0 | 24.92 | m.v. | 2.32 | 0.11 | 1.20 | 0.80 | 2.46 |
| 14 | 0 | 0 | −1.68 | 6.0 | 10.0 | 9.9 | 22.56 | 28.09 | 3.29 | 0.12 | 1.05 | 0.59 | 2.46 |
| 15 | 0 | 1.68 | 0 | 6.0 | 18.4 | 22.5 | 25.19 | 30.53 | 2.93 | 0.11 | 1.28 | 0.74 | 2.39 |
| 16 | 1 | −1 | 1 | 8.0 | 5.0 | 30.0 | 24.00 | 29.80 | 2.57 | 0.10 | 1.22 | 0.77 | 2.01 |
| 17 | −1.68 | 0 | 0 | 2.6 | 10.0 | 22.5 | 22.97 | 29.02 | 3.18 | 0.11 | 1.15 | 0.54 | 2.43 |
| 18 | 0 | 0 | 1.68 | 6.0 | 10.0 | 35.1 | 25.45 | 30.48 | 2.83 | 0.09 | 1.21 | 0.58 | 2.78 |
| 16 | 0 | 0 | 0 | 6.0 | 10.0 | 22.5 | 23.58 | 30.20 | 2.70 | 0.10 | 1.20 | 0.67 | 2.45 |
| 19 | 1 | 1 | 1 | 8.0 | 15.0 | 30.0 | 26.24 | 30.61 | 4.02 | 0.10 | 1.25 | 0.70 | 2.79 |
| 20 | 1 | −1 | −1 | 8.0 | 5.0 | 15.0 | 18.25 | 29.02 | 2.51 | 0.10 | 1.11 | 0.64 | 2.80 |

m.v., Missing values of ‘a’
^{z}Gradient was transformed (X: (1/X)³) before analysis.
Untransformed values are shown in the Table.
VP, vacuum pressure (in. of Hg);
AT, application time (min);
RT, relaxation time (min);
RG, t-resveratrol glucoside (mg/100 g DM);
‘a’, red chromaticity

TABLE 18
Canonical analysis for optimization of VI process

| | | | | | | | |
|---|---|---|---|---|---|---|---|
| | | | | | | | Linear |
| | | | | | Max. force | Gradient | distance |
| Variable | Color (‘a’) | RG | % MC | a_{w} | (kg) | (kg/s) | (kg · s) |

Eigen values

| | | | | | | |
|---|---|---|---|---|---|---|
| 0.39 | 3.24 | 0.69 | 0.02 | 0.18 | 1.47 | 0.22 |
| −0.05 | 0.41 | −0.11 | 0.02 | 0.03 | −1.16 | −0.11 |
| −0.49 | −2.10 | −0.51 | 0.01 | −0.12 | −2.91 | −0.47 |

Critical values at the coded level of variables

| | | | | | | | |
|---|---|---|---|---|---|---|---|
| VP | −3.87 | −0.31 | −0.12 | −0.01 | −0.10 | −0.03 | 0.42 |
| AT | 1.23 | −0.06 | −0.03 | −0.23 | 0.11 | 0.08 | 0.06 |
| RT | 1.81 | 0.26 | −0.02 | 0.46 | 0.05 | −0.16 | −0.04 |

Critical values at the actual level of variables

| | | | | | | | |
|---|---|---|---|---|---|---|---|
| VP | −7.15 | 4.94 | 5.6 | 5.95 | 5.66 | 5.91 | 7.43 |
| AT | 20.32 | 9.54 | 9.70 | 8.09 | 10.89 | 10.67 | 10.53 |
| RT | 45.35 | 25.77 | 22.20 | 28.29 | 23.09 | 20.47 | 22.01 |

Predicted response value

| | | | | | | |
|---|---|---|---|---|---|---|
| 30.07 | 24.18 | 2.85 | 0.09 | 1.17 | 0.63 | 2.58 |

Stationary point

| | | | | | | |
|---|---|---|---|---|---|---|
| Saddle | Saddle | Saddle | Minimum | Saddle | Saddle | Saddle |

VP, vacuum pressure (in. of Hg);
AT, application time (min);
RT, relaxation time min);
RG, t-resveratrol glucoside (mg/100 g DM)

TABLE 19
Ridge analysis for maximizing the response value in VI process

| Estimated | | | | | | | |
|---|---|---|---|---|---|---|---|
| values at | | | | | | | |
| coded | | | | | Max. | | Linear |
| radius | Color | | | | force | Gradient | Distance |
| 1.0 | (‘a’) | RG | % MC | a_{w} | (kg) | (kg/s) | (kg · s) |
| Response | 30.94 | 28.49 | 2.32 | 0.09 | 1.02 | 0.55 | 2.09 |
| Param- | | | | | | | |
| eters | | | | | | | |
| of VI | | | | | | | |
| process | | | | | | | |
| VP | 7.63 | 8.45 | 8.03 | 5.53 | 8.09 | 6.43 | 6.24 |
| AT | 15.74 | 14.45 | 3.29 | 6.30 | 10.77 | 1.78 | 2.19 |
| RT | 29.44 | 28.11 | 23.30 | 33.68 | 12.63 | 20.44 | 17.95 |

VP, vacuum pressure (in. of Hg);
AT, application time (min);
RT, relaxation time (min);
RG, t-resveratrol glucoside (mg/100 g DM)

TABLE 20
Estimated and actual response values at vacuum pressure: 6 in.
of Hg, application time: 10 min, and relaxation time: 22.5 min

| | | t-Resveratrol | | | Max. | Gra- | Linear |
|---|---|---|---|---|---|---|---|
| Response | Color | glucoside | % | | Force | dient | distance |
| value | (‘a’) | (mg/100 g DM) | MC | a_{w} | (kg) | (kg/s) | (kg · s) |
| Estimated | 30.07 | 24.18 | 2.85 | 0.09 | 1.17 | 0.64 | 2.59 |
| Actual | 29.63 | 24.16 | 3.24 | 0.10 | 0.99 | 0.63 | 2.66 |

TABLE 21
Descriptive analysis of different apple snacks by the trained panelists^{z}

| | Pretreatment before drying | | | | |
|---|---|---|---|---|---|
| | | Anti- | Vacuum | | |
| | Control | browning | impregnation | P-value^{w} | |
| Sensory attributes^{y} | (Untreated) | treatment | treatment | Snacks | Panelists |
| Appearance | 9.80 ± 1.56 | 9.59 ± 2.17 | 9.92 ± 2.37 | 0.93 | 0.47 |
| Color | 9.31 ± 1.99 | 9.78 ± 1.96 | 9.49 ± 3.12 | 0.86 | 0.09 |
| Crispiness | 6.23 ± 2.28ab | 4.85 ± 2.83b | 8.26 ± 2.79a | 0.01 | 0.15 |
| Crunchiness | 4.18 ± 2.09ab | 3.15 ± 1.90b | 6.43 ± 2.85a | 0.01 | 0.51 |
| Sweetness | 7.61 ± 2.18a | 3.73 ± 2.18b | 8.16 ± 3.03a | 0.00 | 0.06 |
| Saltiness | 3.25 ± 2.19 | 3.23 ± 2.30 | 3.71 ± 2.34 | 0.84 | 0.41 |
| Sourness | 4.40 ± 2.50 | 5.97 ± 3.79 | 7.05 ± 2.83 | 0.13 | 0.48 |
| Overall | 9.11 ± 2.92 | 6.85 ± 4.07 | 9.97 ± 3.05 | 0.14 | 0.96 |
| acceptability | | | | | |

^{z}Means (n = 15)
a-b Means followed by the same letter within each row are not significantly different
[Tukey's Studentized Range test (P < 0.05)].
^{y}Scores ranged from 1 to 15, where larger numerical values represented a greater intensity of the identified attribute.
^{w}Anova P-values showing the effect of the panelist and pretreatment.

TABLE 22
Compositional analysis of different apple snacks

| | Pretreatment before drying | | |
|---|---|---|---|
| | | | Vacuum |
| | | Anti-browning | impregnation |
| Proximate analysis | Untreated | treatment | treatment |
| DM (%) | 95.97 | 91.36 | 93.42 |
| Crude protein (%) | 1.59 | 1.97 | 2.63 |
| Crude fat (%) | 0.9 | 1.71 | 1.39 |
| Ash (%) | 1.54 | 2.18 | 2.5 |
| Minerals | | | |
| Calcium (%) | <0.05 | 0.78 | 0.78 |
| Phosphorus (%) | 0.07 | 0.05 | 0.07 |
| Sodium (%) | 0.05 | 0.05 | 0.05 |
| Potassium (%) | 0.68 | 0.48 | 0.62 |
| Iron (ppm) | — | 7.14 | 11.53 |
| Manganese (ppm) | 2.63 | 2.62 | 2.57 |
| Copper (ppm) | 3.02 | 3.28 | 3.1 |
| Zinc (ppm) | 2.54 | 1.62 | 2.16 |

All results are expressed on dry matter basis. Analysis performed by external laboratory on single replicate.

TABLE 23
Effect of maple syrup concentration (20 to 50%) of the VI solution on the dried apple snacks^{z}

| Maple | | | Linear | | | | |
|---|---|---|---|---|---|---|---|
| syrup | Maximum | | distance | Gradient | | | |
| % (v/v) | force (kg) | Area (kg · s) | (kg · s) | (kg/s) | WI | % MC^{y} | a_{w} |
| 0 | 0.11 ± 0.03b | 0.23 ± 0.02ab | 3.76 ± 0.88a | 0.03 ± 0.02b | 74.50 ± 0.59a | 5.03 ± 0.74a | 0.25 ± 0.03 |
| 20 | 0.22 ± 0.02ab | 0.16 ± 0.02b | 1.24 ± 0.20b | 0.18 ± 0.05ab | 71.64 ± 0.20b | 3.46 ± 0.82c | 0.21 ± 0.00 |
| 30 | 0.27 ± 0.01a | 0.20 ± 0.04b | 1.23 ± 0.26b | 0.24 ± 0.03a | 70.44 ± 0.55c | 3.48 ± 0.58c | 0.21 ± 0.01 |
| 40 | 0.27 ± 0.03a | 0.18 ± 0.03b | 1.11 ± 0.23b | 0.26 ± 0.08a | 69.33 ± 0.22d | 3.79 ± 0.55bc | 0.21 ± 0.01 |
| 50 | 0.29 ± 0.07a | 0.33 ± 0.07a | 2.04 ± 0.95b | 0.18 ± 0.11ab | 67.41 ± 0.21e | 4.68 ± 0.48ab | 0.24 ± 0.04 |

^{z}Means ± standard deviation (n = 3).
a-e For each variable (except % MC), means followed by the same letter within each column are not significantly different [Tukey's Studentized Range test (P < 0.05)].
^{y}a-c For % MC Least Significant Difference was done as Tukey's Studentized Range test did not show difference, however the P-value was 0.04.

TABLE 24
Effect of maple syrup concentration (30 to 100%) of the VI solution on the dried apple snacks^{z}

| Maple syrup | | | | | | | |
|---|---|---|---|---|---|---|---|
| % (v/v) | Maximum force (kg) | Area (kg · s) | Linear distance (kg · s) | Gradient (kg/s) | WI | % MC | a_{w} |
| 0 | 0.21 ± 0.03c | 0.22 ± 0.01b | 1.80 ± 0.14b | 0.12 ± 0.02bc | 74.60 ± 1.01a | 4.20 ± 0.68b | 0.19 ± 0.02c |
| 30 | 0.38 ± 0.03ab | 0.21 ± 0.04b | 0.96 ± 0.14c | 0.42 ± 0.09a | 70.69 ± 1.14b | 3.00 ± 0.37c | 0.18 ± 0.00c |
| 60 | 0.51 ± 0.10a | 0.71 ± 0.12a | 2.30 ± 0.29b | 0.25 ± 0.06b | 66.73 ± 0.68c | 4.22 ± 0.22b | 0.24 ± 0.00b |
| 100 | 0.26 ± 0.07bc | 0.58 ± 0.05a | 4.19 ± 1.04a | 0.08 ± 0.04c | 66.97 ± 0.15c | 5.45 ± 0.26a | 0.29 ± 0.02a |

^{z}Means ± standard deviation (n = 3).
a-c Means followed by the same letter within each column are not significantly different [Tukey's Studentized Range test (P < 0.05)].

TABLE 25
Effect of maple syrup concentration (20 to 50%) on
hygroscopic properties (% moisture and a_{w} gain) of dried apple

[symbol]

| Maple syrup % (v/v) | Gain in % MC over 3 h | Gain in a_{w} over 3 h |
|---|---|---|
| 0 | 17.22 ± 1.89a | 0.42 ± 0.04 |
| 20 | 16.04 ± 0.72a | [symbol] 0.01 |
| 30 | 15.15 ± 0.52ab | 0.44 ± 0.00 |
| 40 | 14.33 ± 1.40ab | 0.43 ± 0.01 |
| 50 | 12.43 ± 0.67b | 0.40 ± 0.02 |

^{z}Means ± standard deviation (n = 3).
a-bMeans within a column followed by the same letter are not significantly different [Tukey's Studentized Range test (P < 0.05)]. [symbol]
indicates data missing or illegible when filed

TABLE 26
Consumer acceptability of snack products conducted using a
nine-point hedonic scale^{z}

| | | Sensory attributes | | | |
|---|---|---|---|---|---|
| | | | | | Overall |
| Snack type | | Appearance | Flavor^{y} | Texture | acceptability |
| Developed | non-fried | 7.60 ± 1.02a | 6.46 ± 1.51b | 6.34 ± 1.69b | 6.47 ± 1.63b |
| apple snacks | | | | | |
| Commercial | fried | 6.37 ± 1.48c | 7.31 ± 1.33a | 7.20 ± 1.34a | 7.48 ± 1.18a |
| apple snacks | | | | | |
| Commercial | fried | 7.15 ± 1.19b | 7.60 ± 0.88a | 7.65 ± 1.05a | 7.57 ± 1.02a |
| potato snacks | | | | | |
| P-value | Snacks | <0.0001 | <0.0001 | <0.0001 | <0.0001 |
| | Panelists | 0.06 | 0.03 | 0.17 | 0.02 |

^{z}Means ± standard deviation (n = 77).
a-c Means within a row followed by the same letter are not significantly different [Tukey's Studentized Range test (P < 0.05)].
^{y}Flavor score was transformed (cube) before analysis. Untransformed values are shown in the Table.
^{w}Overall acceptability score was transformed (cube) before analysis. Untransformed values are shown in the Table.

TABLE 27
Average rating of the snack products by the consumers using a
nine-point hedonic scale^{z}

| | | | | Overall |
|---|---|---|---|---|
| Snack type | Appearance | Flavor | Texture | acceptability |
| Developed | like very much | like slightly | like slightly | like slightly |
| non-fried | | | | |
| apple snacks | | | | |
| Commercial | like slightly | like | like | like |
| fried apple | | moderately | moderately | moderately |
| snacks | | | | |
| Commercial | like | like very | like very | like very |
| fried potato | moderately | much | much | much |
| snacks | | | | |

n = 77
^{z}scale of 1 (dislike extremely) to 9 (like extremely) as shown in Appendix VI

TABLE 28
Compositional analysis^{z}, moisture content and
water activity of snack products^{y}

| | Developed | Commercial | Commercial |
|---|---|---|---|
| | Non-fried | fried apple | fried potato |
| | apple snacks | snacks | snacks |
| a_{w} | 0.24 ± 0.01a | 0.26 ± 0.02a | 0.19 ± 0.01b |
| MC (%) | 2.57 ± 0.70a | 1.33 ± 0.04b | 0.66 ± 0.03b |
| Crude protein | 1.04 ± 0.08b | 0.95 ± 0.23b | 5.26 ± 0.07a |
| (%) | | | |
| Oil (%) | 0.78 ± 0.10c | 31.20 ± 1.50b | 35.06 ± 0.35a |
| Ash (%) | 2.34 ± 0.14b | 0.88 ± 0.04c | 3.00 ± 0.02a |
| Elements | | | |
| Calcium (%) | 0.56 ± 0.05 | 0.04 ± 0.00 | 0.04 ± 0.00 |
| Phosphorus (%) | 0.04 ± 0.01b | 0.04 ± 0.00b | 0.13 ± 0.01a |
| Sodium (%) | 0.04 ± 0.00 | 0.04 ± 0.00 | 0.22 ± 0.02 |
| Potassium (%) | 0.62 ± 0.01b | 0.39 ± 0.01c | 1.19 ± 0.01a |
| Magnesium (%) | 0.02 ± 0.00 | 0.02 ± 0.00 | 0.05 ± 0.01 |
| Iron (ppm) | 16.47 ± 7.81b | 21.15 ± 15.32b | 233.30 ± 3.71a |
| Copper (ppm) | 3.22 ± 0.25 | 2.97 ± 0.00 | 2.95 ± 0.00 |
| Manganese | 19.23 ± 3.73a | 1.67 ± 0.97b | 5.57 ± 0.17b |
| (ppm) | | | |
| Zinc (ppm) | 25.71 ± 4.99a | 2.32 ± 1.97c | 11.48 ± 0.63b |

^{z}Results for compositional analysis are given on dry matter basis.
^{y}Means ± standard deviation (n = 3).
a-cMeans followed by the same letter within each column are not significantly different [Tukey's Studentized Range test (P < 0.05)].

TABLE 29
Total phenolic content and antioxidant capacity of snack
products^{z}

| | Total phenolic content | FRAP^{x} |
|---|---|---|
| | (μmol GAE^{y}/100 g DM) | (mmol TE^{w}/100 g DM) |
| Developed Non- | 23.52 ± 0.97a | 2.05 ± 0.03a |
| fried apple snacks | | |
| Commercial fried | 24.03 ± 1.7a | 1.60 ± 0.19b |
| apple snacks | | |
| Commercial fried | 5.31 ± 0.59b | 0.11 ± 0.08c |
| potato snacks | | |

^{z}Means ± standard deviation (n = 3).
^{y}GAE = Gallic acid equivalents
^{x}Ferric reducing antioxidant power
^{w}TE = Trolox equivalents

### FULL CITATIONS FOR DOCUMENTS REFERRED TO IN THE SPECIFICATION

Abou-Zaid, M. M. High-performance liquid chromatography characterization and identification of antioxidant polyphenols in maple syrup. Pharmaceutical Biology 2008, 46, 117-125.
Akyildiz, A.; Ocal, N Didem. Effects of dehydration temperatures on colour and polyphenoloxidase activity of Amasya and Golden Delicious apple cultivars. Journal of the Science of Food and Agriculture 2006, 86, 2363-2368.
Alzamora, S. M.; Salvatori, D.; Tapia, M. S.; Lopez-Malo, A.; Welti-Chanes, J.; Fito, P. Novel functional foods from vegetable matrices impregnated with biologically active compounds. Journal of Food Engineering 2005, 67, 205-214.
Amiot, M. J.; Tacchini, M.; Aubert, S.; Nicolas, J. Phenolic composition and browning susceptibility of various apple cultivars at maturity. Journal of Food Science 1992, 57, 958-962.
Anderson, K. A. Micro-digestion and ICP-AES analysis for the determination of macro and micro elements in plant tissues. Atomic Spectrom 1996, 17, 30-33.
Anino, S. V.; Salvatori, D. M.; Alzamora, S. M. Changes in calcium level and mechanical properties of apple tissue due to impregnation with calcium salts. Food Research International 2006, 39, 154-164.
Association of Official Analytical Chemist (AOAC). Official Methods of Analysis of AOAC International, 17^{th} ed.; Horwitz, W., Ed.; Gaithersburg, Md., USA 2000, 4-18.
Aydemir, T. Partial purification and characterization of polyphenol oxidase from artichoke (Cynara scolymus L.) heads. Food Chemistry 2004, 87, 59-67.
Bagchi, D. Nutraceuticals and functional foods regulations in the United States and around the world. Toxicology 2006, 221, 1-3.
Barat, J. M.; Fito, P.; Chiralt, A. Modeling of simultaneous mass transfer and structural changes in fruit tissues. Journal of Food Engineering 2001, 49, 77-85.
Baruah, P.; T. Swain. The effect of L-ascorbic acid on the in vitro activity of polyphenoloxidase from potato. Biochemistry Journal 1953, 55, 392-399.
Bazyma, L. A.; Guskov, V. P.; Basteev, A. V.; Lyashenko, A. M.; Lyakhno, V; Kutovoy, A. V. The investigation of low temperature vacuum drying processes of agricultural materials. Journal of Food Engineering 2006, 74, 410-415.
Benzie, I. F. F.; Strain, J. J. The ferric reducing ability of plasma (FRAP) as a measure of “antioxidant power”: The FRAP assay. Analytical Biochemistry 1996, 239, 70-76.
Betoret, N.; Puente, L.; Diaz, M. J.; Pagan, M. J.; Garcia, M. J.; Gras, M. L.; Marto, J.; Fito, P. Development of probiotic-enriched dried fruits by vacuum impregnation. Journal of Food Engineering 2003, 56, 273-277.
Beveridge, T.; Weintraub, S. E. Effect of blanching pretreatment on color and texture of apple slices at various water activities. Food Research International 1995, 28, 83-86.
Bialobrzewski, I. Determination of the mass transfer coefficient during hot-air-drying of celery root. Journal of Food Engineering 2007, 78, 1388-1396.
Biekman, E. S. A.; Kroese-Hoedeman, H. I.; Schijvens, E. P. H. M. Loss of solubles during blanching of mushroom (Agaricus bisporus) as a result of shrinkage and extraction. Journal of Food Engineering 1996, 28, 139-152.
Billaud, C.; Brun-MErimee, S.; Louarme, L.; Jacques Nicolas. Effect of glutathione and Maillard reaction products prepared from glucose or fructose with glutathione on polyphenoloxidase from apple-I: Enzymatic browning and enzyme activity inhibition. Food Chemistry 2004, 84, 223-233.
Block, G.; Patterson, B.; Subar, A. Fruit, vegetables and cancer prevention: A review of the epidemiological evidence. Nutrition and Cancer 1992, 18, 1-29.
Bolin, H. R.; Huxsoll, C. C. Control of minimally processed carrot (Daucus carotova) surface discoloration caused by abrasion peeling. Journal of Food Science 1991, 56, 416-421.
Boyer, J.; Liu, R. H. Apple phytochemicals and their health benefits. Nutrition Journal 2004, 3-5.
Bristow-Callahan, K. Take another look at agriculture and the census. Excerpts from Canadian agriculture at a glance 1999, Statistics Canada. 1999; (Available online: http://www.statcan.ca/english/kits/agric/census.htm) (accessed on Jul. 13, 2008).
Buiarelli, F.; Coccioli, F.; Jasionowska, R.; Merolle, M.; Terracciano, A. Chromatographic Analysis of Trans Resveratrol in Italian Wines: Comparisons between FL, UV and MS Detection. Chromatographia 2006, 64, 475-481.
Buta, J. G.; Moline, H. E.; Spaulding, D. W.; Wang, C. Y. Extending storage life of fresh-cut apple using natural products and their derivatives. Journal of Agricultural and Food Chemistry 1999, 47, 1-6.
Cannac; M.; Ferrat, L.; Barboni, T.; Pergent, G.; Pasqualini, V. The Influence of Tissue Handling on the Flavonoid Content of the Aquatic Plant Posidonia oceanica. Journal of Chemical Ecology 2007, 33, 1083-1088.
Cao, G.; Alessio, H. M.; Cutler, R. G. Oxygen-radical absorbance capacity assay for antioxidants. Free Radical Biology and Medicine 1993, 303-311.
Chinnici, F.; Bendini, A.; Gaiani, A.; Riponi, C. Radical scavenging activities of peels and pulps from cv. Golden delicious apples as related to their phenolic composition. Journal of Agricultural and Food Chemistry 2004, 52, 4684-4689.
Cocci, E.; Rocculi, P.; Romani, S.; Dalla Rosa, M. Changes in nutritional properties of minimally processed apples during storage. Postharvest Biology and Technology 2006, 39, 265-271.
Colak, A.; Sahin, E.; Yildirim, M.; Sesli, E. Polyphenol oxidase potentials of three wild mushroom species harvested from Liser High Plateau, Trabzon. Food Chemistry 2007, 103, 1426-1433.
Contreras, C.; Martin, M. E., Martinez-Navarrete, N.; Chiralt, A. Effect of vacuum impregnation and microwave application on structural changes which occurred during air-drying of apple. LWT-Food Science and Technology 2005, 38, 471-477.
Coseteng, M. Y.; Lee, C. Y. Changes in apple polyphenoloxidase and polyphenol concentrations in relation to degree of browning. Journal of Food Science 1987, 52, 985-989.
del Valle, J. M.; Aranguiz, V.; Leon, H. Effects of blanching and calcium infiltration on PPO activity, texture, microstructure and kinetics of osmotic dehydration of apple tissue. Food Research International 1998a, 31, 557-569.
del Valle, J. M.; Cuadros, T. R. M.; Aguilera, J. M. Glass transitions and shrinkage during drying and storage of osmosed apple pieces. Food Research International 1998b, 31, 191-204
Delaquis, P. J.; Fontaine, J.; Dussault, F.; Champagne, C. P. Maple syrup as carbohydrate source in dry sausage fermentation. Journal of Food Science 1993, 58, 981-982, 990.
deMan, John M. Enzymes. In Principles of Food Chemistry. 3^{rd} ed.; Aspen Publishers, Gaithersburg, Md. 1999, 389-428.
Deng, Y.; Zhao, Y. Effect of pulsed vacuum and ultrasound osmopretreatments on glass transition temperature, texture, microstructure and calcium penetration of dried apples (Fuji). LWT-Food Science and Technology 2008, 41, 1575-1585.
Dewanto, V.; Wu, X.; Adorn, K.K.; Liu, R. H. Thermal processing enhances the nutritional value of tomatoes by increasing total antioxidant activity. Journal of Agricultural and Food Chemistry 2002, 50, 3010-3014.
Djilas, S. M.; Milic, B. Lj. Naturally Occurring Phenolic Compounds as Inhibitors of Free Radical Formation in the Maillard Reaction. In Maillard Reactions in Chemistry, Food and Health. T. P., Labuza, Reineccius, G. A.; Monnier, V. M.; O'Brien, J.; Baynes, J. W. Ed.; The Royal Society of Chemistry, Cambridge 1994, 75-80.
Dornenburg, H.; Knorr, D. Evaluation of elicitor- and high-pressure-induced enzymatic browning utilizing potato (Solanum tuberosum) suspension cultures as a model system for plant tissues. Journal of Agricultural and Food chemistry 1997, 45, 4173-4177.
Draudt, H. N.; Huang, Yih. Effect of Moisture Content of Freeze-Dried Peaches and Bananas on Changes during Storage Related to Oxidative and Carbonyl-Amine Browning. Journal of Agricultural and Food chemistry 1966, 14, 170-176.
Drouin, A; Couturier, L.; Lasnier, Jean-Francois; Cote, I; Gosselin, A.; Hodgins, M. E. Economic impacts of CA $3.5 billion. In Canadian technological roadmap on functional foods and nutraceuticals. Presented to Canada Economic Development, National Research Council Canada 2002, 4-5.
Eberhardt, M. V.; Lee, C. Y.; Liu, R. H. Nutrition: Antioxidant activity of fresh apples. Nature 2000, 405, 903-904.
Erle, U.; Schubert, H. Combined osmotic and microwave-vacuum dehydration of apples and strawberries. Journal of Food Engineering 2001, 49, 193-199.
Fito, P.; Andres, A.; Chiralt, A.; Pardo, P. Coupling of hydrodynamic mechanism and deformation-relaxation phenomena during vacuum treatments in solid porous food-liquid systems. Journal of Food Engineering 1996, 27, 229-240.
Fito, P.; Chiralt, A.; Betoret, N.; Gras, M.; Chafer, M.; Martinez-Monzo, J.; Andres, A.; Vidal, D. Vacuum impregnation and osmotic dehydration in matrix engineering application in functional fresh food development. Journal of Food Engineering 2001b, 49, 175-183.
Fito, P.; Chiralt, A.; Barat, J. M.; Andres, A.; Martinez-Monzo, J.; Martinez-Navarrete, N. Vacuum impregnation for development of new dehydrated products. Journal of Food Engineering 2001a, 49, 297-302.
Food and Drugs Act. Prohibition of the addition of sulphite on fresh fruits and vegetables. The Canada Gazette part 1:5863. Department of National Health and Welfare 1986, 5863-5865.
Food and Drugs Act and Regulations. In Part D Vitamins, Minerals and Amino acids. 2008 (Available online: http://laws.iustice.gc.ca/en/showdoc/cr/C.R.C.-c.870/bo-qa:I D//en#anchorbo-qa:I D) (accessed on Mar. 14, 2008).
Food Processing. In The Canadian Snack Food Industry 2004; (Available online: http://www.aqr.qc.ca/misb/fb-ba/index e.php?s1=proc−trans&s2=prof&page=snack−grignot) (accessed on Feb. 6, 2007).
Food Quality. In The Health and Environment Handbook for Health Professionals. Health Canada, Ontario 1998, (Available online: http://dsp-psd.pwgsc.gc.ca/Collection/H46-2-98-211E-12.pdf) (accessed on Sep. 2, 2008).
Fu, H. Y. Free radical scavenging and leukemia cell growth inhibitory properties of onion powders treated by different heating processes. Journal of Food Science 2004, 69, 50-54.
Giangiacomo, R.; Torreggiani, D.; Abbo, E. Osmotic dehydration of food. Part I. Sugar exchange between fruit and extracting syrup. Journal of Food Processing and Preservation 1987, 11, 183-195.
Gorny, J. R.; Cifuentes, R. A.; Hess-Pierce, B.; Kader, A. A. Quality Changes in Fresh-cut Pear Slices as Affected by Cultivar, Ripeness Stage, Fruit Size, and Storage Regime. Journal of Food Science 2000, 65, 541-544.
Gurbuz, O.; Gocmen, D.; Dagdelen, F.; Gursoy, M.; Aydin, S.; Sahin, Buyukuysal, L.; Usta, M. Determination of flavan-3-ols and trans-resveratrol in grapes and wine using HPLC with fluorescence detection. Food Chemistry 2007, 100, 518-525.
Health Canada. Fruit and fruit juices. In nutrient value of some common foods. Published by authority of the Minister of Health 2008; (Available online: http://www.hc-sc.gc.cagn-an/nutrition/fiche-nutri-data/nutrient value-valeurs nutritives-table5-eng.php) (accessed on Sep. 2, 2008).
Health Canada. Appendix K—Proposed regulated list of vitamin compounds and mineral salts. In Food and Nutrition 2005; (Available online: http://www.hc-sc.gc.ca/fn-an/nutrition/vitamin/foritfication_final_doc_app-ann_k_e.html) (accessed on Mar. 17, 2008).
Ho, Chi-Tang; Chen, Q.; Shi, H.; Zhang, Ke-Qin; Rosen, Robert T. Antioxidative effect of polyphenol extract prepared from various Chinese teas. Preventive Medicine 1992, 21, 520-525.
Ignarro, L. J.; Balestrieri, M. L.; Napoli, C. Nutrition, physical activity and cardiovascular disease: an update. Cardiovascular Research 2007, 73, 326-340.
Inyang, U. E.; Ike, C. I. Effect of blanching, dehydration method temperature on the ascorbic acid, colour, sliminess and other constituents of okra fruit. International Journal of Food Sciences and Nutrition 1998, 49, 125-130.
Jack, F. R.; O'Neill, J.; Piacentini, M. G.; Schroder, M. J. A. Perception of fruit as a snack: A comparison with manufactured snack foods. Food Quality and Preference 1997, 8, 175-182.
Jahns, L.; Siega-Riz, A. M.; Popkin, M. B. The increasing prevalence of snacking among US children from 1977 to 1996. The Journal of Pediatrics 2001, 138, 493-498.
Janovitz-Klapp, A.H.; Richard, F. C.; Goupy, M.; Nicolas, J. J. Kinetic studies on apple polyphenol oxidase. Journal of Agricultural and Food Chemistry 1990, 38, 1437-1441.
Jeon, M.; Zhao, Y. Honey in combination with vacuum impregnation to prevent enzymatic browning of fresh-cut apples. International Journal of Food Sciences and Nutrition 2005, 56, 165-176.
Julkunen-Tiitto, R.; Sorsa, Sinikka. Testing the effects of drying methods on willow flavonoids, tannins, and salicylates. Journal of Chemical Ecology 2001, 27, 779-789.
Julkunen-Tiitto, R.; Tahvanainen, J. The effect of the sample preparation method of extractable phenolics of salicaceae species. Planta medica 1989, 55-58.
Katz, E. E.; Labuza, T. P. Effect of water activity on the sensory crispness and mechanical deformation of snack food products. Journal of Food Science 1981, 46, 403-409.
Kavey, Rae-Ellen W.; Daniels, S. R.; Lauer, R. M.; Atkins, D. L.; Hayman, L. L.; Taubert, K. American Heart Association guidelines for primary prevention of atherosclerotic cardiovascular disease beginning in childhood. Circulation 2003, 107, 1562-1566.
Khanizadeh, S.; Groleau, Y.; Levasseur, A.; Charles, M. T.; Tsao, R.; Yang, R.; DeEll, J.; Hampson, C.; Toivonen, P. ‘SJCA38R6A74’ (Eden™). HortScience 2006, 41, 1513-1515.
Khanizadeh, S.; R. Tsao; D. Rekika; R. Yang; J. DeEll. Phenolic composition and antioxidant activity of selected apple genotypes. International Journal of Food Agriculture and Environment 2007, 5, 61-66.
Kim, D. M.; Smith, N. L.; Lee, C. Y. Quality of minimally processed apple slices from selected cultivars. Journal of Food Science 1993, 58, 1115-1117.
King, V. An-Erl; Zall, Robert R.; Ludington, David C. Controlled low-temperature vacuum dehydration-a new approach for low-temperature and low-pressure food drying. Journal of Food Science 1989, 54, 1573-1579.
King-E, V. A.; Zall, R. R. A response surface methodology approach to the optimization of controlled low-temperature vacuum dehydration. Food Research International 1992, 25, 1-8.
Kolcuoglu, Y.; Colak, A.; Sesli, E.; Yildirim, M.; Saglam, N. Comparative characterization of monophenolase and diphenolase activities from a wild edible mushroom (Macrolepiota mastoidea). Food Chemistry 2007, 101, 778-785.
Konopacka, D; Plocharski, W.; Beveridge, T. Water sorption and crispness of fat-free apple chips. Journal of Food Science 2002, 67, 87-92.
Kubo, I.; Kinst-Hori, I. Flavonols from saffron flower: tyrosinase inhibitory activity and inhibition mechanism. Journal of Agricultural and Food Chemistry 1999, 47, 4121-4125.
Lamberts, L.; Rombouts, I.; Brijs, K.; Gebruers, K.; Delcour, Jan A. Impact of parboiling conditions on Maillard precursors and indicators in long-grain rice cultivars. Food Chemistry 2008, 110, 916-922.
Larrauri, J. A.; Ruperez, P.; Saura-Calixto, F. Effect of drying temperature on the stability of polyphenols and the antioxidant activity of red grape pomace peels. Journal of Agricultural and Food Chemistry 1997, 45, 1390-1393.
Lata, B. Relationship between apple peel and the whole fruit antioxidant content: year and cultivar variation. Journal of Agricultural and Food Chemistry 2007, 55, 663-671.
Lata, B.; Marzenna, P.; Binkowska, M. Great Difference in Antioxidant properties exist between 56 apple cultivars and vegetation seasons. Journal of Agricultural and Food Chemistry 2005, 53, 8970-8978.
Lee, K. W.; Kim, Y. J.; Kim, D.; Lee, H. J.; Lee, C. Y. Major phenolics in apple and their contribution to the total antioxidant capacity. Journal of Agricultural and Food Chemistry 2003, 51, 6516-6520.
Lee, Seung K.; Kader, Adel A. Preharvest and postharvest factors influencing vitamin C concentration of horticultural crops. Postharvest Biology and Technology 2000, 20, 207-220.
Lee, C. Y.; Smith, N. L.; Hawbecker, D. E. Enzyme activity and quality of frozen green beans as affected by blanching and storage. Journal of Food Quality 1988, 11, 279-287.
Lefort, J. F.; Durance, T. D.; Upadhyaya, M. K. Effects of tuber Storage and Cultivar on the Quality of Vacuum Microwave-dried Potato Chips. Journal of Food Science 2003, 68, 690-696.
Lenart, A.; Lewicki, P.P. Osmotic dehydration of apples at high temperature. In Drying 89, Mujumdar, A. S., Ed; Hemisphere Publishing Corporation, New York 1990, 7-14.
Lewicki, P. P. Design of hot air drying for better foods. Trends in Food Science and Technology 2006, 17, 153-163.
Lewicki, P. P.; Pawlak, G. Effect of drying on microstructure of plant tissue. Drying Technology 2003, 21, 657-683.
Lewis, N; Ruud, J. Apples in the American Diet. Nutrition in Clinical Care 2004, 7, 82-88.
Lin, M.; Durance, T. D.; Scaman, C. H. Characterization of vacuum microwave, air and freeze dried carrot slices. Food Research International 1998, 31, 111-117.
Lindley, M. G. The impact of food processing on antioxidants in vegetable oils, fruits and vegetables. Trends in Food Science and Technology 1998, 9, 336-340.
Lindroth, R. L.; Koss, P. A. Preservation of Salicaceae leaves for phytochemical analyses: further assessment. Journal of Chemical Ecology 1996, 22, 765-771.
Lule, S. U.; Xia, W. Food Phenolics, Pros and Cons: A Review. http://web.ebscohost.com/ehost/viewarticle?data=dGJvM PPp44rp2%2fd V0%2bnjisfk5le46bBPt6i3S7ek63nn5Kx95uXxjL6vrUm2pbBlrg6eTriptlKyrJ5oy5z yit%2fk8Xnh6ueH7N%2fiVaugr1G1prVMtKvkhN%2fk5VXj5KR84LPfiOac8nnls79 mpNfsVa%2butUmvqa9OpNztiuvX81Xk6%2qE8tv2jAAA&hid=7 Food Reviews International 2005, 21, 367-388.
Maache-Rezzoug, Z.; Rezzoug, S.; Allaf, K. Kinetics of drying and hydration of the scleroglucan polymer. A comparative study of two conventional drying methods with a new drying process: dehydration by successive pressure drops. Drying Technology 2001, 19, 1961-1974.
Macheix, J. J.; Sapis, J. C.; Fleuriet A. Phenolic compounds and polyphenoloxidase in relation to browning in grapes and wines. Critical Reviews of Food Science and Nutrition 1991, 30, 441-486.
Macintosh, R. I. W.; Rupasinghe, H. P. V.; Embree C.; Erith D. Apple-Based Bio-Products: Market and Industry Development Analysis. Phase I: Overview of Existing Markets for Traditional Apple Products 2006, 18-19.
Mandala, I. G.; Anagnostaras, E. F.; Oikonomou, C. K. Influence of osmotic dehydration conditions on apple air-drying kinetics and their quality characteristics. Journal of Food Engineering 2005, 69, 307-316.
Manzocco, L.; Calligaris, S.; Mastrocola, D.; Nicoli, M. C.; Lerici, C. R. Review of non-enzymatic browning and antioxidant capacity in processed foods. Trends in Food Science and Technology 2000, 11, 340-346.
Mariscal, M.; Bouchon, P. Comparison between atmospheric and vacuum frying of apple slices. Food Chemistry 2008, 107, 1561-1569.
Marshall, M. R.; Kim, J.; Wei, Cheng-I. Enzymatic browning in fruits, vegetables and seafoods. FAO 2000; Viale delle Terme di Caracalla, 00100 Rome, Italy; (Available online: http: //www.fao.org/ag/Ags/agsi/ENZYMEFINAL/Enzymatic%20Browning.html#NEW) (11 Jul. 2007)
Martin-Diana, A. B.; Rico, D.; Frias, J. M.; Barat, J. M.; Henehan, G. T. M.; Barry-Ryan, C. Calcium for extending the shelf-life of fresh whole and minimally processed fruits and vegetables: a review. Trends in Food Science and Technology 2007, 18, 210-218.
Martinez, M. V.; Whitaker, J. R. The biochemistry and control of enzymatic browning. Trends in Food Science and Technology 1995, 195-200.
Martinez-Monzo, J.; Barat, J. M.; Gonzalez-Martinez, C.; Chiralt, A.; Fito, P. Changes in thermal properties of apple due to vacuum impregnation. Journal of Food Engineering 2000, 43, 213-218.
Meilgaard, M; Civille, G. V. and Carr B. Sensory Evaluation Techniques. 2^{nd} ed.; Boca Raton, Fla., USA 1991.
Meullenet, J-F.; Xiong, R.; Hankins, J. A.; Dias, P.; Zivanovic, S.; Monsoor, M. A.; Bellman-Horner, T.; Liu, Z.; Fromm H. Modeling preference of commercial toasted white corn tortilla chips using proportional odds models. Food Quality and Preference 2003, 14, 603-614.
Moledina, K. H.; Kaydar, M.; Ooraikul, B.; Hadziyev, D. Pectin changes in the pre-cooking step of dehydrated mashed potato production. Journal of the Science of Food and Agriculture 1981, 32, 1091-1102.
Molnar-Perl, Ibolya; Friedman, Mendel. Inhibition of browning by sulfur amino acids. 3. Apples and potatoes. Journal of Agricultural and Food Chemistry 1990, 38, 1652-56.
Montgomery, D. C. Introduction to factorial designs. In Design and Analysis of Experiments. 5^{th} ed.; John Wily and Sons, Inc.; New York, US 2005, 160-197.
Mujica-Paz, H.; Valdez-Fragoso, A.; Lopez-Malo, A.; Palou, E.; Welti-Chanes, J. Impregnation properties of some fruits at vacuum pressure. Journal of Food Engineering 2003a, 56, 307-314.
Mujica-Paz, H.; Valdez-Fragoso, A.; Lopez-Malo, A.; Palou, E.; Welti-Chanes, J. Impregnation and osmotic dehydration on some fruits: effect of the vacuum pressure and syrup concentration. Journal of Food Engineering 2003b, 57, 305-314.
Negi, P. S.; Roy, S. K. Effect of Blanching and Drying Methods on β-Carotene, Ascorbic acid and Chlorophyll Retention of Leafy Vegetables. LWT-Food Science and Technology 2000, 33, 295-298.
Neyraud, E.; Dransfield, E. Relating ionisation of calcium chloride in saliva to bitterness perception. Physiology and Behavior 2004, 81, 505-510.
Nicholas, J. J.; Richard-Forget, F. C.; Goupy, P. M.; Amiot, M. J.; Aubert, S. Y. Enzymatic browning reactions in apple and apple products. Critical Reviews in Food Science and Nutrition 1994, 34, 109-157.
Nicoli, M. C.; Anese, M.; Parpinel, M. Influence of processing on the antioxidant properties of fruit and vegetables. Trends in Food Science Technology 1999, 10, 94-100.
Nicoli, M. C.; Calligaris, S.; Manzocco, L. Effect of enzymatic and chemical oxidation on the antioxidant capacity of catechin model systems and apple derivatives. Journal of Agricultural and Food Chemistry 2000, 48, 4576-4580.
Nieto, A.; Salvatori, D., Castro, M. A.; Alzamora, S. M. Air drying behaviour of apples as affected by blanching and glucose impregnation. Journal of Food Engineering 1998, 36, 63-79.
Orians, C. M. Preserving leaves for tannin and phenolic glycoside analyses: a comparison of methods using three willow taxa. Journal of Chemical Ecology 1995, 21, 1235-1243.
Oszmianski, J.; Lee, C. Y. Enzymatic oxidative reaction of catechin and chlorogenic acid in a model system. Journal of Agricultural and Food Chemistry 1990, 38, 1202-1204.
Ozdemir, M. Foods browning and its control. Okyanus Danismanlik 1997, 1-14; (Available online: http://wwvv.okyanusbilgiambari.com/Bilim/Okyanus-BrowinqInFoods.pdf) (accessed on Jul. 7, 2007).
Park, S. I.; Zhao, Y; Koddihalli, I. Nutritional, sensory, and physicochemical properties of vitamin E and mineral-fortified fresh-cut apples by use of vacuum impregnation. Journal of Food Science 2005, 70, 593-599.
Perkins, E. G. Effect of lipid oxidation on oil and food quality in deep frying. In Lipid Oxidation in Food. Acs Symposium Series 500. Angelo, Allen J. St. American Chemical Society, Washington, D.C. 1992, 310-321.
Pitotti, A.; Nicoli, M. C.; Sensidoni, A.; Lerici, C. R. Control of enzymatic browning in food: effects of some substances and their mechanism of action. In Engineering and Food; Spiess, W. E. L.; Schubert, H. Ed.; Elsevier Applied Science, London 1990, 671-681.
Poste, M. L.; Deborah, A.M.; Butler, G.; Larmond, E. Laboratory methods for sensory analysis of food. Research Branch Agriculture Canada Publication 1864/E 1991, 29-73.
Rababah, T. M.; Ereifej, K. I.; Howard, L. Effect of ascorbic acid and dehydration on concentrations of total phenolics, antioxidant capacity, anthocyanins, and color in fruits. Journal of Agricultural and Food Chemistry 2005, 53, 4444-4447.
Rahman, M. S.; Labuza, T. P. Water activity and food preservation. In Handbook of food preservation, Rahman, M. S. Ed., Marcel Dekker, New York 1999, 339-382.
Rahman, M. S.; Lamb, J. Air drying behaviour of fresh and osmotically dehydrated pineapple. Journal of Food Process Engineering 1991, 14, 163-171.
Ramesh, M. N.; Wolf, W.; Tevini, D. Jung, G. Studies on inert gas processing of vegetables. Journal of Food Engineering 1999, 40, 199-205.
Ratti, C. Shrinkage during drying of foodstuffs. Journal of Food Engineering 1994, 23, 91-105.
Resnik, S.; Chirife, J. Effect of moisture content and temperature on some aspects of nonenzymatic browning in dehydrated apple. Journal of Food Science 1979, 44, 601-605.
Rocculi, P.; Romani, S.; Dalla Rosa, Marco. Evaluation of physico-chemical parameters of minimally processed apples packed in non-conventional modified atmosphere. Food Research International 2004, 37, 329-335.
Rocha, A. M. C. N.; Morais, A. M. M. B. Characterization of polyphenoloxidase (PPO) extracted from ‘Jonagored’ apple. Food Control 2001, 12, 85-90.
Rocha, A. M. C. N.; Morais, A. M. M. B. Polyphenoloxidase activity and total phenolic content as related to browning of minimally processed ‘Jonagored’ apple. Journal of the Science of Food and Agriculture 2002, 82, 120-126.
Rouet-Mayer, Marie-Aude; Ralambosoa, J.; Philippon, Jean. Roles of o-quinones and their polymers in the enzymic browning of apples. Phytochemistry 1990, 29, 435-440.
Rupasinghe, H. P. Vasantha; Wang, L.; Huber, Gwendolyn M.; Pitts, Nancy L. Effect of baking on dietary fiber and phenolics of muffins incorporated with apple skin powder. Food Chemistry 2008, 107, 1217-1224.
Rupasinghe, H. P. V.; Boulter-Bitzer, J.; Ahn, T.; Odumeru, J. A. Vanillin inhibits pathogenic and spoilage microorganisms in vitro and aerobic microbial growth in fresh-cut apples. Food Research International 2006, 39, 575-580.
Russell, L. F.; Wolfe, L. I.; Ryan, D. A. J. Method development and generation of profiles for selected phenolics from apple cultivars used for processed products. Journal of Food Science 2002, 67, 2819-2826.
Sacchetti, G.; Cocci, E.; Pinnavaia, G.; Mastrocola, D.; Rosa, M. D. Influence of processing and storage on the antioxidant activity of apple derivatives. International Journal of Food Science and Technology 2008, 43, 797-804.
Salvatori, D.; A. Andres; Chiralt, A.; Fito, P. The response of some properties of fruits to vacuum impregnation. Journal of Food Processing and Preservation 1998, 21, 59-73.
Santerre, C. R.; Cash, J. N.; Vannorman, D. J. Ascorbic acid/citric acid combination in the processing of frozen apple slices. Journal of Food Science 1988, 53, 1713-1716.
Sanchez-Rabaneda, F.; Jauregui, O.; Lamuela-Raveentos, R. M.; Viladomat, F.; Bastida, J.; Codina, C. Qualitative analysis of phenolic compounds in apple pomace using liquid chromatography coupled to mass spectrometry in tandem mode. Rapid Communication in Mass Spectrometry 2004, 18, 553-563.
Sapers, G. M. Browning of foods: control by sulfites, antioxidants, and other means. Food Technology 1993, 47, 75-84.
Sapers, G. M.; Garzarella, L.; Pilizota, V. Application of browning inhibitors to cut apple and potato by vacuum and pressure infiltration. Journal of Food Science 1990, 55, 1049-1053.

SAS Institute. SAS User's Guide: Statistics. Version 8. SAS Inst. Cary, N.C., 2003.
Scalzo, J.; Politi, A.; Pellegrini, N.; Mezzetti, B.; Battino, M. Plant genotype affects total antioxidant capacity and phenolic contents in fruit. Nutrition 2005, 21, 207-213.
Sham, P. W. Y.; Scaman, C. H.; Durance, T. D. Texture of vacuum microwave dehydrated apple chips as affected by calcium pretreatment, vacuum level, and apple variety. Journal of Food Science 2001, 66, 1341-1347.
Shi, X. Q.; Fito, P. Vacuum osmotic dehydration of fruits. Drying Technology 1993, 11, 1429-1442.
Shi, X. Q.; Fito, P.; Chiralt, A. Influence of vacuum treatment on mass transfer during the osmotic dehydration of fruits. Food Research International 1995, 28, 445-454.
Shyu, S. L.; Hau, L. B.; Hwang, L. S. Effects of processing conditions on the quality of vacuum-fried carrot chips. Journal of the Science of Food and Agriculture 2005, 85, 1903-1908.
Shyu, S. L.; Hwang, L. S. Effect of processing conditions on the quality of vacuum fried apple chips. Food Research International 2001, 34, 133-142.
Singleton, V. L. Oxygen with phenols and related reactions in musts, wines, and model systems: observations and practical implications. J. Enology and Viticulture 1987, 38, 69-77.
Singleton, V. L.; Orthofer, R.; Lamuela-Raventos, R. Analysis of total phenols and other oxidation substrates and antioxidants by means of Folin-Ciocalteu reagent. Methods in Enzymology 1999, 299, 152-178.
Sjoholm, I.; Gekas, V. Apple shrinkage upon drying. Journal of Food Engineering 1995, 25, 123-130.
Soliva-Fortuny, R. C.; Oms-Oliu, G.; Martin-Belloso, O. Effects of ripeness stages on the storage atmosphere, color, and textural properties of minimally processed apple slices. Journal of Food Science 2002, 67, 1958-1963.
Soliva-Fortuny, R. C.; Ricart-Coll, M.; Martin-Belloso, O. Sensory quality and internal atmosphere of fresh-cut Golden Delicious apples. International Journal of Food Science and Technology 2005, 40, 369-375.
Son, S. M.; Moon, K. D.; Lee, C. Y. Inhibitory effects of various anti-browning agents on apple slices. Food Chemistry 2001, 73, 23-30.
Song, Jae-Yeun; An, Gil-Hwan; Kim, Chul-Jai. Color, texture, nutrient contents, and sensory values of vegetable soybeans [Glycine max (L.) Merrill] as affected by blanching. Food Chemistry 2003, 83, 69-74.
Statistics Canada. Fruit and vegetable production, June 2006. Catalogue no. 22-003-XIB2006001. 2006; (Available online: http://www.statcan.ca/english/freepub/22-003-XIB/22-003-XIB2006001.pdf) (accessed on Jan. 2, 2007).
Statistics Canada. Fruit and vegetable production, June 2008. Catalogue No. 22-003-X 2008; (Available online: http://www.statcan.ca/english/freepub/22-003-XIE/22-003-XIE2008001.pdf) (accessed on Sep. 2, 2008).
Statistics Canada. Production and value of honey and maple products. 2007; (Available online: http://www.statcan.ca/english/freepub/23-221-XIE/23-221-XIE2007000.pdf) (accessed on Jul. 13, 2008).
Stuckel, Jackie G.; Low, Nicholas H. The chemical composition of 80 pure maple syrup samples produced in North America. Food Research International 1996, 29, 373-379.
Sumere, C. van; Geiger, H.; Bral, D.; Fockenier, G.; Vande Casteele, K.; Martens, M.; Hanselaer, R.; Gevaert, L. Freeze-drying and analysis of plant and other biological material. Analytical Biochemistry 1983, 131, 530-532.
Svensson. S. Inactivation of enzymes during thermal processing. In physical, chemical and biological changes in foods caused by thermal processing, Hoyem, T.; Kvale, O., Ed.; Applied Science Publishers, London 1977, 202-217.
Szaefer, H.; Cichocki, M.; Brauze, D.; Baer-Dubowska, W. Alteration in phase I and II enzyme activities and polcylclic aromatic hydrocarbons-DNA adduct formation by plant phenolics in mouse epidermis. Nutrition and Cancer 2004, 48, 70-77.
Taiwo, K. A.; Angersbach, A.; B. I. O., Ade-Omowaye; Knorr, D. Effects of Pretreatments on the Diffusion Kinetics and Some Quality Parameters of Osmotically Dehydrated Apple Slices. Journal of Agricultural and Food Chemistry 2001, 49, 2804-2811, 2001.
Tan, B. K.; Harris, N. D. Maillard reaction products inhibit apple polyphenoloxidase. Food Chemistry 1995, 53, 267-273.
Theriault, M.; Caillet, S.; Kermasha, S.; Lacroix, M. Antioxidant, antiradical and antimutagenic activities of phenolic compounds present in maple products. Food Chemistry 2006, 98, 490-501.
Toivonen, P. M. A. Fresh-cut apples: Challenges and opportunities for multi-disciplinary research. Canadian Journal of Plant Sciences 2006, 86, 1361-1368.
Toor, Ramandeep K.; Savage, Geoffrey P. Effect of semi-drying on the antioxidant components of tomatoes. Food Chemistry 2006, 94, 90-97.
Treidlinger. M. The Canadian Snack Food Industry 2007. Food Value Chain Bureau Agriculture and Agri-Food Canada Ottawa, Ontario 2007; (Available online: http://www4.agr.gc.ca/AAFC-AAC/display-afficher.do?id=1172692863066&lang=e) (accessed on Sep. 2, 2008)
Tsao, R.; Yang, R.; Xie, S.; Sockovie, E.; Khanizadeh, S. Which Polyphenolic Compounds Contribute to the Total Antioxidant Activities of Apple? Journal of Agricultural and Food Chemistry 2005, 53, 4989-4995.
Usman; Hosono A. Antimutagenic activity of Maillard reaction products against mutagenic heated tauco. Italian Journal of Food Science 1997, 4, 268-276.
Vamos-Vigyazo, L. Polyphenol oxidase and peroxidase in fruits and vegetables. Critical Reviews of Food Science and Nutrition 1981, 15, 49-127.
Vardavas, C. I.; Yiannopoulos, S.; Kiriakakis, M.; Poulli, E.; Kafatos, A. Fatty acid and salt contents of snacks in the Cretan and Cypriot market: A child and adolescent dietary habit. Food Chemistry 2007, 101, 924-931.
Vrhovsek, U.; Rigo, A.; Tonon, D.; Mattivi, F. Quantitation of polyphenols in different apple varieties. Journal of Agricultural and Food Chemistry 2004, 52, 6532-6538.
Wang, N.; Brennan, J. G. Changes in structure, density and porosity of potato during dehydration. Journal of Food Engineering 1995, 24, 61-76.
Weemaes, C. A.; Ludikhuyze, L. R.; Broeck, I. van den.; Hendrickx, M. E. Effect of pH on pressure and thermal inactivation of avocado polyphenol oxidase: a kinetic study. Journal of Agricultural and Food Chemistry 1998, 46, 2785-2792.
Wu, J.; Gao, H.; Zhao, L.; Liao, X.; Chen, F.; Wang, Z.; Hu, X. Chemical compositional characterization of some apple cultivars. Food Chemistry 2007, 103, 88-93.
Xie, J.; Zhao, Y. Nutritional enrichment of fresh apple (Royal Gala) by vacuum impregnation. International Journal of Food Sciences and Nutrition 2003, 54, 387-398.
Xie, L. P.; Chen, Q. X.; Huang, H.; Wang, H. Z.; Zhang, R. Q. Inhibitory effects of some flavonoids on the activity of mushroom tyrosinase. Biochemistry 2003, 68, 487-491.
Yemenicioglu, A.; Ozkan, M.; Cemroglu, B. Heat inactivation kinetics of apple polyphenoloxidase and activation of its latent form. Journal of Food Science 1997, 62, 508-510.
Yen, G. C.; Tsai, L. C. Antimutagenicity of partially Fractionated Maillard Reaction Products. Food Chemistry 1993, 47, 11-15.
Zandstra, E. H.; Graaf, C. D.; Staveren, W. A. V. Influence of health and taste attitudes on consumption of low- and high-fat foods. Food Quality and Preference 2001, 12, 75-82.
Zhao, Y.; Xie, J. Practical applications of vacuum impregnation in fruit and vegetable processing. Trends in Food Science and Technology 2004, 15, 434-451.

1. A non-fried apple food product comprising the following characteristics:
(a) oil free;
(b) nutrient enriched; and
(c) crispy texture.

2. The non-fried apple product of claim 1, wherein the apple product is in the form of a slice or a wedge with or without skin.

3. The non-fried apple product of claim 2, wherein the slice or wedge is about 1 mm to about 3 mm.

4. The non-fried apple product of claim 1, wherein the apple product possesses a moisture content of about 1% to about 5% and a water activity of about 0.1 to about 0.2 and better hygroscopic properties than conventionally dehydrated apple slices.

5. The non-fried apple product of claim 1, wherein the apple product is rich in phenolic acids and flavonoids.

6. The non-fried apple product of claim 1, having a total antioxidant capacity, measured by a ferric reducing antioxidant power (FRAP) assay greater than that of deep-fried apple chips and about 20-fold higher than potato chips.

7. The non-fried apple product of claim 1, wherein the apple product comprises about 0.5% to about 5% of total fat.

8. A process for preparing a non-fried apple food product comprising:
(a) obtaining apple portions of a suitable size and shape;
(b) treating the apple portions under vacuum impregnation (VI) conditions in the presence of one or more sensory attribute-improving substances; and
(c) vacuum drying the apple portions from (b).

9. The process of claim 8, wherein the suitable shape is a slice or wedge.

10. The process of claim 8, wherein the apple portion has a thickness of about 2 mm to about 3 mm.

11. The process of claim 8, wherein the one or more sensory attribute-improving substances are selected from one or more of color enhancers, health-promoting bioactives, taste enhancers, texture enhancers and other suitable value-added substances.

12. The process of claim 8, wherein at least one of the sensory attribute-improving substances is a color enhancer.

13. The process of claim 12, wherein the color enhancer is an inhibitor of post-enzymatic browning or a natural colorant.

14. The process of claim 13, wherein the inhibitor of post-enzymatic browning is CaCl₂ or a commercially available antibrowning agent.

15. The process of claim 14, wherein the inhibitor of post-enzymatic browning is CaCl₂ and the CaCl₂ is used as a solution comprising about 1% (w/v) to about 2% (w/v) of CaCl₂.

16. The process of claim 8, wherein the one or more sensory attribute-improving substances are taste and/or texture improving substances selected from one or more of fruit juices, salt, sugars and syrups.

17. The process of claim 16, wherein the syrup is maple syrup used in an amount of about 1% (v/v) to about 40%.

18. The process of claim 8, wherein the VI conditions comprise a vacuum pressure of about 5.5 in. Hg to about 8.5 in. Hg, an application time of about 1.7 min to about 15.8 min, and a relaxation time of about 12.6 min to about 33.7 min.

19. The process of claim 8, wherein the apple portions are treated prior to VI under conditions to reduce post-cut enzymatic browning.

20. The process of claim 19, wherein the conditions to reduce post-cut enzymatic browning are selected from LTLT (Low Temperature Long Time) blanching treatment, HTST (High Temperature Short Time) blanching treatment, CaCl₂ dipping, the application of a commercial anti-browning agent and/or fruit and/or vegetable juice or beverage.

21. The process of claim 20, wherein the LTLT blanching conditions comprise immersion in water at a temperature of about 75° C. to about 80° C. for about 20 min to about 30 min.

22. The process of claim 20, wherein the HTST blanching conditions comprise immersion in water at a temperature of about 85° C. to about 95° C. for about 10 sec to about 30 sec.

23. The process of claim 20, wherein the CaCl₂ dipping conditions comprise immersion in solution comprising about 1% (w/v) to about 2% (w/v) CaCl₂ in water for about 8 to about 10 minutes.

24. The process of claim 8, wherein, the apple portions are vacuum dried at a temperature of about 25° C. to about 40° C. under a vacuum of about 10⁻³ Torr for about 12 hours to about 24 hours.

25. A non-fried apple food product prepared using the method of claim 8.
